(19) United States
(12) Patent Application Publication
(10) Pub. No.: US 2010/0159226 A1
(43) Pub. Date: Jun. 24, 2010

(54) THERMALLY STABLE NANO-SIZED ALPHA ALUMINA (CORUNCUM) MATERIALS AND METHOD OF PREPARING THEREOF

(75) Inventors: Wojciech L. Suchanek, Solon, OH (US); Juan M. Garcés, Midland, MI (US)

Correspondence Address: PEARNE & GORDON LLP, 1801 EAST 9TH STREET, SUITE 1200, CLEVELAND, OH, 44114-3108, US

(73) Assignee: Sawyer Technical Materials LLC, Eastlake, OH (US)

(21) Appl. No.: 12/643,680

(22) Filed: Dec. 21, 2009

Related U.S. Application Data
(60) Provisional application No. 61/139,140, filed on Dec. 19, 2008.
(60) Provisional application No. 61/166,365, filed on Apr. 3, 2009.
(60) Provisional application No. 61/258,273, filed on Nov. 5, 2009.

(51) Int. Cl. C04B 35/10; C01F 7/02; C04B 35/50; B32B 3/26; B32B 18/00

(52) U.S. Cl. 428/220; 423/625; 423/626; 501/153; 501/152; 428/401; 977/775; 977/755

(57) ABSTRACT

A hydrothermal process for making Alpha Alumina (α-Al₂O₃) crystalline nano-sized powders in the form of at least one of nano-sheets and nano-fibers, the process includes making the Alpha Alumina with an aspect ratio of diameter to thickness ratio of at least two, and with at least one dimension of diameter or thickness being less than 100 nm. A composition in accordance with the process. A porous ceramic that includes the composition.

### RELATED APPLICATIONS

The present application claims benefit of priority from U.S. Provisional Patent Application No. 61/139,140 and from U.S. Provisional Patent Application No. 61/166,365 and from U.S. Provisional Patent Application No. 61/258,273, all of which are incorporated herein by reference.

### BACKGROUND

Alpha alumina (α-Al₂O₃, corundum, denoted hereafter as AA) is one of the most widely utilized ceramic materials due to a favorable combination of such properties as high mechanical strength and hardness, good wear resistance, low electric conductivity, high refractoriness, and high corrosion resistance in a broad range of chemical environments. Applications of AA in form of powders and/or ceramics include abrasive materials, electric insulators (spark plugs, electronic circuits substrates, packaging, etc.), structural ceramics (wear resistant parts, bearings, nozzles, seats, cutting tools, medical/dental implants, grinding media, ceramic armor, etc.), vacuum tube envelopes, refractory bricks, liners, and sleeves used in metallurgical applications, kiln furnaces, etc., laboratory ware, catalytic supports, etc.

Due to enormous progress in chemistry, materials science, and nanotechnology during the recent years, nano-sized AA materials became attractive for a variety of applications. In catalysis, nano-sized AA with high surface area and high pore volumes are being sought as thermally stable supplement/replacement for widely used transition aluminas, which undergo transformation into the corundum phase during their high temperature use, which is associated with significant surface area loss. Catalytic reactions occurring at high temperatures and in very corrosive environments would benefit from high surface area, high pore volume pure AA phase supports. Similar problem of thermal instability occurs in alumina filtration membranes, which could be solved by employing thermally stable nano-sized AA. Another use of nano-sized AA is in various abrasive applications, including chemical-mechanical planarization (CMP), where small abrasive particles with uniform size distributions and controlled morphologies can be successfully used. Nano-sized particles of hard corundum phase can be incorporated in surface finishes, paints, varnishes, coatings, etc. in order to increase scratch and/or corrosion resistance. High-strength dense AA ceramics can be prepared from nano-sized AA powders at reduced temperatures without sintering additives. There exist many other applications for nano-sized AA-based powders, ceramics, and organic-inorganic hybrids in electronics, optics, biomaterials, catalysis, etc.

In all applications mentioned above, precise control of the chemical composition of the nano-sized AA materials is of great importance. Presence of chemical dopants, which form solid solutions with the AA phase or adsorb on the surface, modifies the surface properties, which has impact on its performance in all applications. The chemical dopants can provide active centers for catalysis, modify acid/base properties of the catalytic supports, change the surface energy, or electric charge (zeta potential). Such modifications may be essential in catalytic application, dispersability of the nano-materials, interactions with polymers, etc. The chemical dopants can also modify morphology of the nano-sized AA crystallites during growth, modify thermal stability and/or sinterability of the AA powders in high-temperature applications. These changes may have pronounced impact on the porosity, pore volume distribution and surface area of the resulting powders and products made from them, resulting in novel catalytic, adsorption, mechanical, and other properties.

It is of great interest to develop methods of large-volume, inexpensive, and environmentally friendly synthesis of nano-sized AA powders with precisely controlled morphology and chemical composition. It would be even more advantageous to synthesize thermally stable nano-sized AA powders, which is of great interest in a variety of applications. In the present invention we provide for the first time a hydrothermal method to synthesize AA nano-sized powders in forms of nano-sheets and nano-fibers.

It is also of substantial interest to produce porous and nano-porous AA ceramics with enhanced thermal stability, high porosity, controllable surface area, and high strength. It would be even more advantageous to fabricate the porous AA ceramics with very high purity, which is of great interest in a variety of applications. In the present invention we provide for the first time a method to fabricate phase-pure high-porosity nano-structured AA ceramics with high thermal stability.

Nano-sized AA powders can be synthesized by several high-temperature methods, such as calcination of precursor gels at 800-1,000° C., pyrolysis of complex compounds above 1,000° C., emulsion processing followed by calcinations above 1,000° C. One of the most interesting and relatively low-temperature methods involves calcinations of diaspore (α-AlOOH) at 500° C. However, there is very limited morphology control of nano-sized AA powders, which are formed as pseudo-morphs of diaspore. Another low-temperature approach to nano-sized AA is calcinations of gels also at about 500° C. That approach involves use of toxic alkoxides, thus is expensive and not environmentally friendly. All methods described above produced typically nano-sized AA powders with equiaxed morphology and high level of agglomeration. It is worth mentioning, that AA nano-needles were synthesized by the sol-gel method at 1,000° C. and AA nano-belts were prepared by the CVD method at 1,150° C. However, apparently, no AA nano-sheets of any type have ever been synthesized by any method.

Hydrothermal synthesis of AA is a low-temperature, environmentally friendly alternative to the methods described above. Hydrothermal synthesis processes crystallize materials directly from aqueous media at low temperatures under moderate to high pressures. Under hydrothermal conditions, particularly in the vicinity of the critical point, changes of dielectric constant, viscosity, diffusion coefficients, and density of aqueous solutions, allow accelerating kinetics of chemical reactions, enhancing transport, and stimulating nucleation and growth of the crystallites at significantly lower temperatures compared with other techniques using gas-phase or solid-state reactions.

Size and morphology of the AA synthesized hydrothermally can be controlled by various additives introduced into the crystallization environment. Presence of 0.05-0.1M-H₂SO₄ aqueous solution results in formation of submicron corundum crystals. Use of CrCl₃ or KMnO₄ in order to introduce doping elements of Cr and Mn in concentrations of 0.01%, and 0.05%, respectively, did not result in any modifications of the AA crystals size or morphology. However, no additives have ever been reported to yield AA nano-fibers or nano-sheets during hydrothermal synthesis.

Porous AA ceramics can be prepared by various methods. Typical approach involves the use of AA powders, which are formed in the presence of additives using extrusion, molding, or pressing, and subsequently sintered at high temperatures to generate mechanical strength. Usually, high porosity can be obtained by the use of fillers with various shapes (spherical, fibers, etc.) and burn-out materials, which evaporate during processing leaving voids, with controlled size and distribution. In some cases, reinforcements, such as ceramic fibers or platelets, which may or may not be AA, are used to reinforce the porous ceramics. Porous AA ceramics can be also made by sol-gel methods. The main problem with nano-structured, i.e. high surface area porous AA ceramics is related to their high temperature behavior, which manifest itself as significant surface area loss.

### SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a hydrothermal process for making Alpha Alumina (AA) crystalline nano-sized powders in the form of at least one of nano-sheets and nano-fibers, the process includes making the Alpha Alumina with an aspect ratio of diameter to thickness ratio of at least two, and with at least one dimension of diameter or thickness being less than 100 nm.

In accordance with another aspect, the present invention provides a composition of Alpha Alumina (AA) crystalline nano-sized powders in the form of at least one of nano-sheets and nano-fibers, wherein an aspect ratio of diameter to thickness ratio of at least two, and with at least one dimension of diameter or thickness being less than 100 nm.

In accordance with another aspect, the present invention provides a porous ceramic that includes a composition of Alpha Alumina (AA) crystalline nano-sized powders in the form of at least one of nano-sheets and nano-fibers, wherein an aspect ratio of diameter to thickness ratio of at least two, and with at least one dimension of diameter or thickness being less than 100 nm.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a schematic diagram of an autoclave assembly used in hydrothermal synthesis of AA nano-sheets, nano-fibers, and porous ceramics;

FIG. 2 is an example, typical heating ramps of the hydrothermal synthesis of AA nano-sheets, nano-fibers, and porous ceramics;

FIGS. 3A-3E are SEM photographs of AA nano-sheets synthesized hydrothermally in the presence of morphology modifiers, revealing morphological details of the AA nano-sheets, with the following concentrations and types of the morphology modifiers: (A) 0% (reference), (B) 1% SiO₂, (C) 3% SiO₂, (D) 5% SiO₂, and (E) 10% SiO₂ with magnifications being the same in all cases;

FIGS. 4A-4B are SEM photographs of AA nano-sheets synthesized hydrothermally, revealing: (A) large spherical agglomerates; (B) dispersed nano-sheets;

FIG. 5 are plots of XRD patterns of AA nano-sheets synthesized hydrothermally at 450° C. for 10 days under 1,700 psi pressure, in the presence of morphology modifiers and 10 wt % of commercial 1 μm AA seeds (equiaxed) with concentrations and types of the morphology modifiers indicated and each pattern showing pure-phase AA (corundum), except for the composition with 10% SiO₂, which is a mixture of corundum and boehmite (peaks are marked with γ);

FIG. 6 Full widths at half maximum (FWHM) values for (113) and (110) XRD peaks of the AA nano-sheets, as shown in FIG. 5. With increasing concentration of the morphology modifiers, which corresponds to increasing aspect ratio and thickness reduction of the nano-sheets, FWHM of the (113) peaks significantly increased, while FWHM of the (110) peaks was almost constant, indicating different crystallite sizes in different crystallographic directions. This is another indication of the single-crystal nature of AA nano-sheets, consistent with the SEM and TEM characterization;

FIGS. 7A and 7B are HRTEM photographs of AA nano-particles synthesized hydrothermally, with the follow aspects: (A) c-faceted AA nano-sheet (see lower insert) revealing hexagonal symmetry of atom arrangements, as confirmed by corresponding electron diffraction patterns (calculated, see upper insert); (B) c-axis elongated AA nano-needles (insert) with electron diffraction pattern confirming the orientation shown in the insert and mesocrystals nature;

FIG. 8 are plots of XPS spectra of the AA nano-sheets in accordance with aspects of the present invention, synthesized hydrothermally at 450° C. for 10 days under ˜2,000 psi pressure, in the presence of 5% SiO₂ morphology modifier, 10 wt % of commercial 1 μm AA seeds (equiaxed), and 3 wt % ZrOCl₂ to introduce Zr dopant. (a) as-synthesized surface of undoped AA nano-sheets, (b) 6 nm subsurface of undoped AA nano-sheets, note in (a) higher intensity of the Si-derived bands, particularly Si2s; (c) as-synthesized surface of 0.4 at. % Zr-doped AA nano-sheets, (d) 6 nm subsurface of 0.4 at. % Zr-doped AA nano-sheets: note the same intensity of all Zr-derived bands in (c) and (d) and higher intensity of the Si-derived bands in (c). Argon-derived peaks were due to ion etching and the presence of a weak S2p band is ascribed to the sulphate crystallization environment;

FIG. 9 is a chart showing thermal stability of Type II and Type IV AA nano-sheets vs. equiaxed AA powders during calcination in air at 1000° C. for 12 hours. All powders were synthesized hydrothermally, with the equiaxed powders exhibiting substantial BET surface area loss while both types of the nano-sheets have thermally stable BET surface area;

FIGS. 10A-10C are SEM photographs of AA nano-fibers synthesized hydrothermally in the presence of morphology modifiers, with concentrations and types of the morphology modifiers marked; (B) is a higher magnification of the AA materials shown in (A).

FIGS. 11A-11E are SEM photographs of AA nano-sheets in accordance with aspects of the present invention, synthesized hydrothermally in the presence of 5% SiO₂ with morphology modifier and various dopants as follows: (A) AA nano-sheets without dopants, (B) AA nano-sheets with Y dopant; (C) AA nano-sheets with 0.4 at. % Co dopant; (D) AA nano-sheets with 0.40 at. % Mg dopant; and (E) reference AA powder synthesized in the absence of morphology modifiers and without dopants, and with magnifications are the same in all cases;

FIG. 12A is a plot for XRD patterns of AA nano-sheets in accordance with aspects of the present invention, synthesized hydrothermally at 450° C. for 10 days under ˜2,000 psi pressure, in the presence of 5% SiO₂ morphology modifier, 10 wt % of commercial 1 μm AA seeds (equiaxed), and various dopants, with marked concentrations and types of the dopants, as measured in the AA lattice, and with each pattern showing pure-phase AA (corundum).

FIG. 12B is a plot for XRD patterns of AA nano-sheets in accordance with aspects of the present invention, synthesized hydrothermally at 450° C. for 10 days under ˜2,000 psi pressure, in the presence of 5% SiO₂ morphology modifier, 10 wt % of commercial 1 μm AA seeds (equiaxed), and various dopants. Concentrations and types of the dopants, as measured in the AA lattice are marked, with each pattern showing pure-phase AA (corundum), except for the composition with Ti and V, which are mixtures of AA and boehmite (marked γ);

FIG. 13 is a plot of XPS spectra of AA nano-sheets in accordance with aspects of the present invention, synthesized hydrothermally at 450° C. for 10 days under ˜2,000 psi pressure, in the presence of 5% SiO₂ morphology modifier, 10 wt % of commercial 1 μm AA seeds (equiaxed), and 3 wt % CrCl₃ to introduce Cr dopant with the follow aspects: (A) as-synthesized surface of undoped AA nano-sheets and having an absence of any Cr-derived bands, (B) 6 nm subsurface of undoped AA nano-sheets and also having an absence of any Cr-derived bands, (C) as-synthesized surface of 0.27 at. % Cr-doped AA nano-sheets, (D) 6 nm subsurface of 0.27 at. % Cr-doped AA nano-sheets; (E) 12 nm subsurface of 0.27 at. % Cr-doped AA, and showing a same intensity of the Cr2p bands in (C) through (E), with the spectra being charge-corrected with respect to the carbon C1s peak at 284.5 eV, and with arrows indicate the positions of Cr(6+)-derived bands, if any;

FIG. 14 is a plot of XPS spectra of AA nano-sheets in accordance with aspects of the present invention, synthesized hydrothermally at 450° C. for 10 days under ˜2,000 psi pressure, in the presence of 5% SiO₂ morphology modifier, 10 wt % of commercial 1 μm AAseeds (equiaxed), and 3 wt % Ti₂(SO₄)₃ to introduce Ti dopant with the following aspects: (a) as-synthesized surface of undoped AA nano-sheets and having an absence of any Ti-derived bands, (b) 6 nm subsurface of undoped AA nano-sheets and having an absence of any Ti-derived bands; (c) as-synthesized surface of 0.34 at. % Ti-doped AA nano-sheets, (d) 6 nm subsurface of 0.34 at. % Ti-doped AA nano-sheets, with the same intensity of the Ti2p bands being in (c) and (d), and with the spectra being charge-corrected with respect to the carbon C1s peak at 284.5 eV;

FIG. 15 is a plot of XPS spectra of AA nano-sheets in accordance with aspects of the present invention, synthesized hydrothermally at 450° C. for 10 days under ˜2,000 psi pressure, in the presence of 5% SiO₂ morphology modifier, 10 wt % of commercial 1 μm AA seeds (equiaxed), and 3 wt % MgCl₂ to introduce Mg dopant, with the following aspects: (a) as-synthesized surface of 0.4 at. % Mg-doped AA nano-sheets, (b) 6 nm subsurface of 0.4 at. % Mg-doped AA nano-sheets, with similar intensity of the Mg1s band in (a) and (b), with the Mg concentration being 0.49 at % on the surface and 0.38 at % in the subsurface region, and with the spectra being charge-corrected with respect to the carbon C1s peak at 284.5 eV.

FIG. 16 is a plot of XRD patterns of AA nano-sheets, with the following attributes (a) as-synthesized AA nano-sheets (porous aerogel); (b) porous AA ceramics made from hydrothermally synthesized AA nano-sheets and sintered in air at 1,000° C. (24 hours), and (c) porous AA ceramics made from hydrothermally synthesized AA nano-sheets and sintered in air at 1,400° C. (12 hours);

FIGS. 17A-17F are charts showing pore size distributions of AA nano-sheets, with the following aspects: (A) as-synthesized AA nano-sheets (porous aerogel); (B)-(F) porous AA ceramics made from the hydrothermally synthesized AA nano-sheets and sintered in air at (B) 1,000° C. (24 hours), (C) 1,200° C. (24 hours), (D) 1,350° C. (24 hours), (E) 1,400° C. (12 hours), and (F) 1,600° C. (24 hours);

FIG. 18 is a chart of pore size distributions of porous AA ceramics made from hydrothermally synthesized AA equiaxed powders and sintered in air at 1,450° C. (8 hours) as a comparative example [as disclosed in US Published Application No. 2007/0280877 A1];

FIGS. 19A-19F are charts showing cumulative pore volumes of AA nano-sheets, with the following attributes: (A) as-synthesized AA nano-sheets (porous aerogel); (B)-(F) porous AA ceramics made from the hydrothermally synthesized AA nano-sheets and sintered in air at (B) 1,000° C. (24 hours), (C) 1,200° C. (24 hours), (D) 1,350° C. (24 hours), (E) 1,400° C. (12 hours), and (F) 1,600° C. (24 hours);

FIGS. 20A-20F are photographs of microstructures of porous AA ceramics made from hydrothermally synthesized AA nano-sheets, extruded, and sintered in air at 1,350° C. (24 hours), with the following magnifications: (A) 100×, (B) 1,000×, (C) 3,000×, (D) 10,000×, (E) 8,000× and (F) 8,000×;

FIGS. 21A-21E are photographs of microstructures of porous AA ceramics made from hydrothermally synthesized AA nano-sheets, extruded, and sintered in air at 1,450° C. (12 hours), with the following magnifications: (A) 100×, (B) 1,000×, (C) 3,000× (D) 5,000×, and (E) is an expanded view of the dashed region in (D); and

FIGS. 22A-22C are SEM photographs revealing microstructures of porous AA ceramics made from hydrothermally synthesized AA equiaxed powders, extruded, and sintered in air at 1,450° C. (8 hours), with the following magnifications: (A) 300×, (B) 1,000×, and (C) 3,000×, as a comparative example [as disclosed in US Published Application No. 2007/0280877 A1].

### DESCRIPTION OF EXAMPLE EMBODIMENTS

Apparently, no nano-sheets of AA have ever been synthesized by the hydrothermal method or by any related technique. It would be advantageous to use the hydrothermal synthesis to prepare AA nano-fibers or nano-sheets, with high aspect ratios, which could be then used for a variety of applications. Unique elongated and/or platy morphology of nano-sized crystals combined with high phase and chemical purity and unique defect structure of hydrothermally synthesized AA could be very attractive features in a variety of applications. It would be also advantageous to use the hydrothermal synthesis to prepare AA nano-fibers or nano-sheets, with controlled chemical compositions, including incorporation of dopants, which could be then used for a variety of applications. Such properties could be achieved because of the use of the hydrothermal synthesis technique of this invention. The present invention provides for these features and advantages.

The present invention provides for the first time a hydrothermal method to synthesize AAnano-sized powders in forms of nano-sheets and nano-needles with a wide range of sizes (10 nm and up), aspect ratios and metal dopants, such as Zr, Ti, V, Co, Ni, Cu, Fe, Mn, etc. In another aspect of the present invention, we introduce for the first time pure and doped AA nano-sheets, which have never been synthesized before by any known method. The dopants were present in the concentrations up to about 0.5 atom % and thorough analysis indicated incorporation of the dopants in the AA lattice.

It would be advantageous to use hydrothermally synthesized nano-sized AA powders to fabricate thermally stable, high surface area porous AA ceramics for a variety of applications including catalyst supports, porous membranes/filters, thermal insulation, etc. It would also be advantageous to use the hydrothermal method to directly obtain porous AA ceramics in the autoclave during the hydrothermal synthesis. The use of hydrothermally synthesized AA materials offers here several advantages, such as high chemical purity of AA, precise control of AA crystallite size and morphology resulting in precise and unique microstructure control (including unique pore size distributions), as well as possibly different chemical defect structures of AA due to the presence of dopants and/or unique features of process described in the present invention. The present invention provides for these features and advantages.

The present invention provides for the first time a method to fabricate phase-pure high-porosity nano-structured AA ceramics with high thermal stability. The AA ceramics is fabricated either directly under hydrothermal conditions or by forming and subsequent sintering of hydrothermally-synthesized AA nano-sized powders.

### Starting Materials for the Hydrothermal Synthesis of AA Nano-Crystals

The selection of appropriate precursors, seeds, morphology modifiers and chemical additives for the hydrothermal synthesis of AA nano-sheets and nano-fibers of the present invention is part of the process to obtain products with desired properties, such as chemical composition (overall purity, type of doping element), crystallite morphology, crystal size, aggregation level, porosity, pore size distribution, specific surface area, etc.

Aluminum oxide-hydroxide, i.e. boehmite (chemical formula γ-AlOOH), is a preferred precursor powder in hydrothermal synthesis of AA nano-sheets and nano-fibers of the present invention. Available typical properties of the precursor powder (Precursor Type A) are summarized in Table I. Other grades or types of boehmites, as well as aluminum tri-hydroxide (trihydrate) powders, such as gibbsite or hydrargillite (chemical formula Al(OH)₃), bayerite (Al(OH)₃), nordstrandite (Al(OH)₃), or other oxide-hydroxides, such as diaspore (AlOOH), pseudoboehmite, transition aluminas, or even amorphous phases can be also used as precursors in hydrothermal synthesis of AA nano-sheets and nano-fibers of the present invention.

TABLE I
Physicochemical properties of the precursor powder for
hydrothermal synthesis of AA nano-sheets and nano-fibers.

| | Precursor |
|---|---|
| Property | Type A |
| Chemical Compound | Boehmite |
| | [γ-AlOOH] |
| Al₂O₃ (%) | 77.0 |
| Total Na (ppm) | 150 |
| Fe (ppm) | 55 |
| Si (ppm) | 75 |
| Free Moisture (%) | — |
| Specific Gravity (g/cm³) | 3.01 |
| Median Particle Size (μm) | 25 |
| Specific Surface Area (m²/g) | 180 |

An alternative to solid aluminum oxide-hydroxides or tri-hydroxides precursors are aqueous solutions of aluminum salts, such as Al(NO₃)₃, AlCl₃, Al₂(SO₄)₃, etc., which can form AA during hydrothermal synthesis under either basic or acidic conditions, preferably in the presence of AA seeds, and/or other additives.

Seeds can be advantageously used to control the size, composition and rate of crystallization of oxides under hydrothermal conditions. The relationship between the seeds used as starting materials and the final AA products is a complex function of seed type (AA, other materials), quantity (weight/volume fraction of seeds with respect to the precursor), particle size and aggregation level, as well as type of precursor, conditions of the hydrothermal synthesis, and method of mixing the seeds with the precursor. This complex relationship has to be established experimentally in each case. Both hydrothermally synthesized and commercial seeds can be used, with submicron or nano-sized AA powders being preferred seeds in the present invention.

Crystal habits can be significantly changed by various morphology modifiers, which are species that can adsorb on preferred facets of the growing crystals, blocking their growth in certain directions or build into the lattice and modify growth rates of particular crystal facets. Other mechanisms are possible as well. A variety of species (metals, cations, anions, inorganic or organic) have been reported to adsorb on AA crystals with or without determining specific adsorption facets. Such adsorbing species can be used as morphology modifiers during the hydrothermal synthesis of AA nano-sized powders. It is presumed that any type of chemicals can be used, providing that they do not introduce unwanted impurities, which could result in undesired properties of the AA materials. Some example sources of morphology modifiers are their aqueous solutions or dispersions. Some example morphology modifier for the hydrothermal synthesis of the AA nano-sheets in accordance with an aspect of the present invention is colloidal aqueous dispersion of nano-sized silica, which results in the formation of (100) faceting in AA nano-crystals. Some example morphology modifier for the hydrothermal synthesis of the AA nano-fibers is boric acid (H₃BO₃), which results in the formation of c-axis elongated AA nano-crystals (needles, fibers) in accordance with an aspect of the present invention. The morphology modifiers can also be used to dope the corundum crystals with a variety of desired elements, or to change the crystal size, aggregation level, and size distributions.

Chemical additives are used to introduce the doping elements (dopants) primarily into the lattice of the AA nano-sized powders but also to deposit them on the surfaces of the AA nano-sized powders. Chemical additives are typically introduced in form of aqueous dispersions or water-soluble salts of the doping elements, such as chlorides, sulphates, nitrates, etc. They could be in form of acids or bases as well. Other compounds, such as oxides of the doping element, could also be used. Essentially any element from the periodic table could be used as a dopant in the AA nano-sheets. In accordance with an aspect of the present invention, metal salts are used to dope the corresponding elements into the AA nano-sheets. As examples, YCl₃ can be used to dope Y into AA nano-sheets, ZrOCl₂ can be used for Zr, ZnCl₂ for Zn, LaCl₃ for La, CuSO₄ for Cu, CoCl₂ for Co, NiCl₂ for Ni, CrCl₃ for Cr, FeCl₃ for Fe, SnCl₂ for Sn, Ti₂(SO₄)₃ for Ti, Bi(NO₃)₃ for Bi, NbCl₅ for Nb, TaCl₅ for Ta, V₂O₅ for V, CeCl₃ for Ce, MoCl₅ for Mo, SbCl₅ for Sb, KMnO₄ for Mn, AgNO₃ for Ag, MgCl₂ for Mg, LiOH for Li, CsOH for Cs, NaCl for Na, KCl for K, BaCl₂ for Ba, SrCl₂ for Sr, CaCl₂ for Ca. Although a broad range of concentrations of the dopants can be used, one specific concentration of the chemical additives in accordance with an aspect of the present invention ranged between 0.3 and 3.0 wt % with respect to the weight of the precursor.

Hydrothermal Synthesis of AA Nano-Sheets and Nano-Fibers

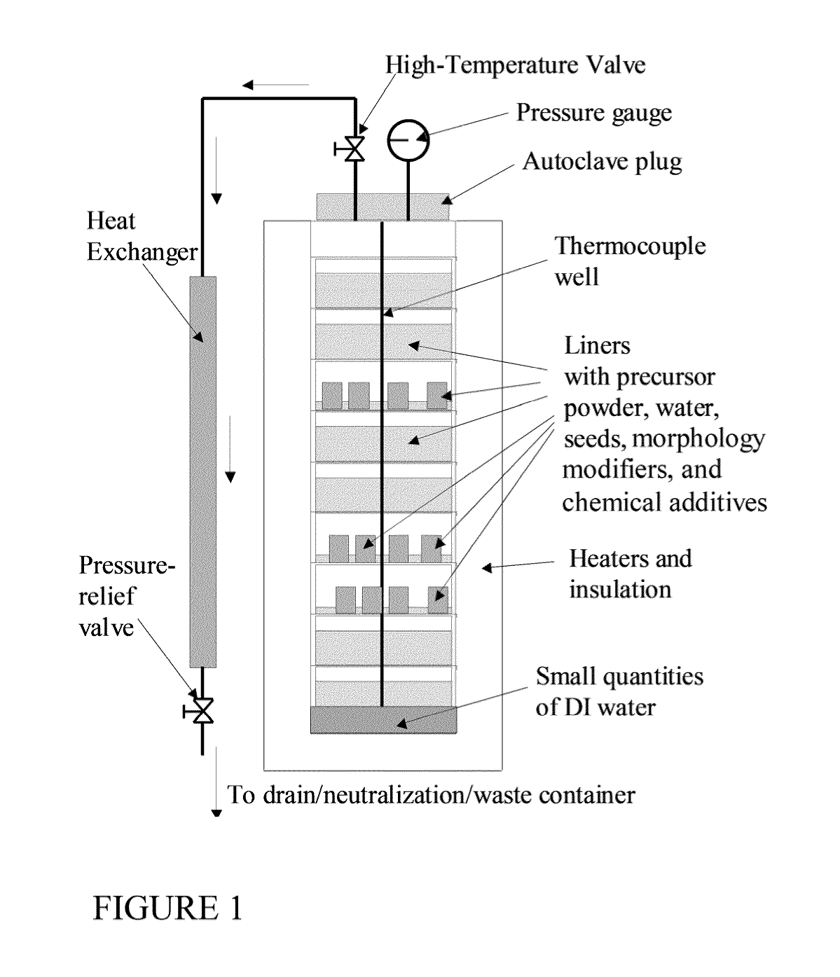

The hydrothermal synthesis of AA nano-sheets takes place in a hermetically closed autoclave (pressure vessel, reactor), with at least one thermocouple, temperature controller(s), at least one pressure gauge, with a pressure relief system designed to vent excess pressure during synthesis (FIG. 1). Materials of construction of the autoclave can be any materials, which can withstand operating temperatures and pressure in multiple cycles of corundum synthesis.

In an aspect of the present invention, the autoclave is filled with several liners, stacked one on another (FIG. 1). The liners may be used to control contamination of the products and/or protect the autoclave from chemical attack. The liners have a central opening allowing inserting thermocouples for temperature measurements and/or control. The material of the liners can by of any type, providing that it does not introduce impurities (chemical, particulate), which can deteriorate the properties of the AA powders and porous AA ceramics. In some cases, however, the liner material can also be used to modify the properties of the AA nano-materials (chemical composition, size, morphology, aggregation level, size distribution). One useful material for the liner is pure titanium metal, specifically Grade 2 titanium. The liner can be formed by molding and/or welding of metal sheets and/or pipes. Both the interior and the exterior of each liner, including new liners, should be cleaned to avoid incorporation of any undesired impurities in the corundum product. The load in each liner can be the same or can be different than in the other liners. This allows for synthesis of various types of AA powders and porous AA ceramics in the liners within the same high-pressure reactor all made under the same T and P and heating and cooling routines.

One example procedure to fill each liner in accordance with the present invention is as follows: (1) adding DI water to each Ti metal liner to reach desired weight or volume; (2) adding desired weight/volume of chemical additive(s) and stirring thoroughly in order to obtain homogeneous solution/suspension; (3) adding appropriate weight of the precursor powder followed by stirring the container to obtain uniform slurry (if uniform slurry cannot be obtained, more water is added); (4) adding the seeds and stirring the container for several minutes in order to disperse the seeds uniformly in the slurry; (5) adding desired amount of morphology modifier followed by stirring, and (6) covering the liner with a lid and positioning in the autoclave. Loading of the liners into the autoclave is preceded with cleaning the autoclave to remove any visible contaminants, followed by thorough rinsing with DI water. The liners are positioned on special supports, which allow simultaneous loading/unloading of 1-5 liners at the same time. The bottom of the autoclave is filled with DI water (below the liners), to generate initial pressure in the autoclave during the hydrothermal synthesis. The amounts of water vary and depend upon total water content in the autoclave (calculated as a sum of water in the liners and water from decomposition of the precursors). It should be minimized so during heating up level of water in the bottom does not increase due to expansion to fill the containers (see FIG. 1). The time lag between completing loading the liners and starting the heat treatment in the hermetically closed autoclave is several hours. The heat treatment of the hydrothermal synthesis is selected by those skilled in the art from phase diagrams in the Al₂O₃—H₂O system. See US Published Patent Application No. 2007/0280877, which is incorporated herein by reference.

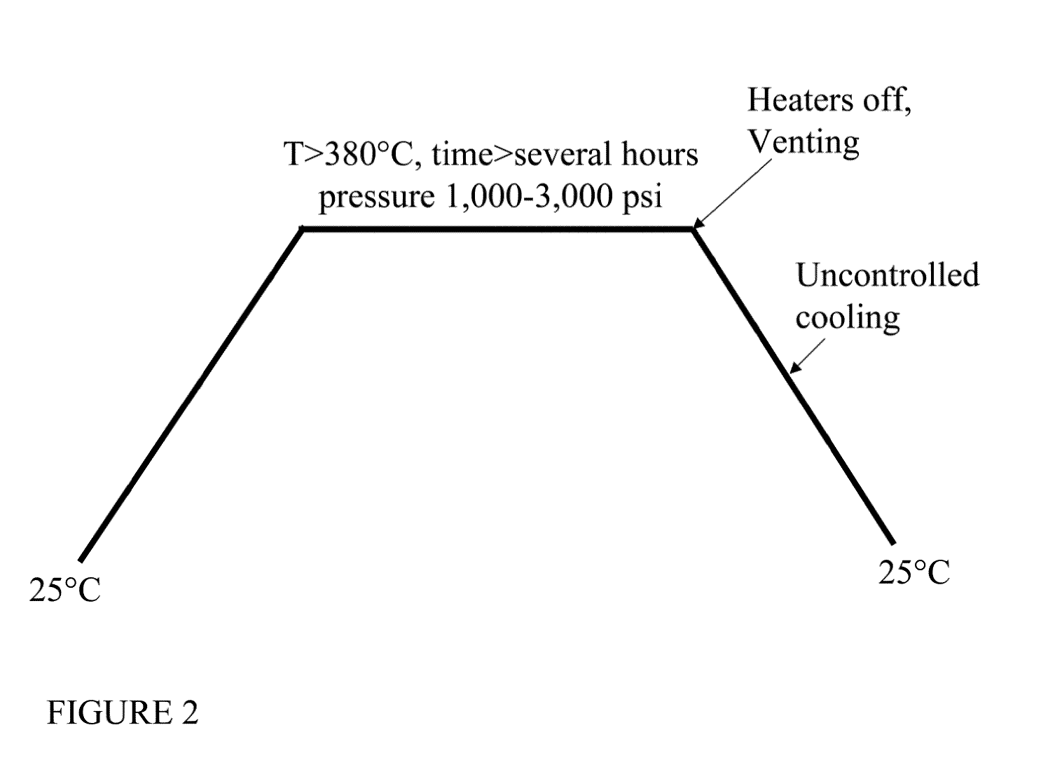

In one embodiment in accordance with the present invention, the ramp of the hydrothermal heat treatment in synthesis of doped AA nano-sheets is as follows: from room temperature to Maximum Temperature with a heating rate of 9.0-23.3° C./hr, followed by holding at Maximum Temperature for 1 hour-14 days, with temperature stability of a few ° C., with pressure not exceeding about 3,000 psi. The Maximum Temperature is between 380° C. and 500° C., more specifically between 430° C. and 450° C. (FIG. 2). Such ramp selection enables synthesis of doped AA nano-sheets. Selection of other ramps is possible to synthesize corundum, as described elsewhere (see US Published Application No. 2007/0280877 A1). A phase boundary for AA is present at 380° C.

In all cases of AA synthesis, during the hydrothermal heat treatment, when the autoclave is ramping up towards the Maximum Temperature, when the temperature increases above 300° C. (saturated vapor pressure of water is 1246 psi at 300° C.), the pressure relief procedure is initiated in order to keep the pressure at levels enabling corundum synthesis per the Al₂O₃—H₂O phase diagram. The high-temperature valve is open so the steam can be vented through the heat exchanger (FIG. 1). Pressure is controlled using the pressure-relief valve located at the end of the venting system, which prevents excessive reduction of pressure in the autoclave (re-sealing pressure above 1,000 psi). The heat exchanger can use any cooling medium provided that it can cool steam from temperatures between 300° C. and above 430° C., to well below the boiling point of water, preferably to the room temperature.

After completing the hydrothermal synthesis of doped AA nano-sheets (one of the indications of completing the reaction is stable pressure at constant temperature), the autoclave can be either naturally cooled down to room temperature, with subsequent drying of the synthesized powders in an oven above 100° C. or the autoclave can be vented while still at high temperature. The venting involves opening the high-temperature valve and bypassing the pressure-relief valve. The entire water present the autoclave at the end of the hydrothermal synthesis is vented either directly to the drain or to the neutralization tank. If toxic additives are present, the entire content of the autoclave is collected in a drum and subsequently disposed according to local/state/government regulations.

When the autoclave cools down to a temperature close to room temperature, it can be opened. If venting was applied, the powders are usually dry. After opening and unloading the liners with the synthesized doped AA nano-sheets inside, the autoclave is cleaned from any residues. In each liner, top layer of powder with a thickness of at least ¼″ is removed and discarded. The very top part of the powder tends to accumulate impurities, particularly sodium, iron, and silica. The remaining content of each liner can be collected in a fiber drum (or pail) as good material, however at least ¼″ of material attached to the walls and to the bottom of the container is left in the container and subsequently discarded. This part of the powder tends to accumulate impurities as well, particularly sodium, iron, and silica. An alternative way to avoid materials removal is to use improved liner design, which includes a double bottom and a top screen, which can collect the top and bottom impurities.

The as-synthesized doped AA nano-materials may form a strong porous ceramics (aerogels) in the autoclave, with porosity of 90% and pore volume of 1.5 cm³/g. Such hydrothermally formed porous ceramics may be used as-synthesized after being removed from the liner. The porous ceramics can be also crushed and ground into powder. Depending upon the final application, the nano-materials are ground into particles of different sizes. In some cases, use of dispersing tools may be necessary to separate the aggregates into discrete nano-particles.

Preparation of Porous AA Ceramics by Extruding and Sintering

As-synthesized (i.e. aggregated) AA nano-sheets or AA nano-sheets/boehmite mixtures, prepared under hydrothermal conditions, can be used as starting materials in preparation of porous AA ceramics. The porous AA ceramics can be made by simple sieving or compaction of powders containing the AA nano-sheets with or without sintering additives, with or without binders with or without subsequent heat treatments. Preferentially, the porous AA ceramics are made by forming extrudates which are subjected to subsequent heat treatments used to generate desirable mechanical strengths.

Extrudates containing AA nano-sheets or their mixtures with boehmite or equiaxed AA powders can be formed by adaptation of processes, known in the open literature. See for example EP 0900128 B1; U.S. Pat. No. 6,846,774 B2; U.S. Pat. No. 5,380,697 and US Patent Application No. 2007/0280877 A1, with the US patent documents being incorporated herein by reference.

In one embodiment in accordance with the present invention, the extrudates are made without any binders (e.g., sintering additives), by mixing hydrothermally synthesized AA nano-sheets or AA nano-sheets/boehmite powders preferably with water or a sufficient amount of burnout material (e.g., petroleum jelly, polyvinyl alcohol, etc.) using a blender, mixer, or mill, etc. and forming the extrudate using an extruding apparatus.

In another embodiment in accordance with the present invention, the extrudates are made by mixing hydrothermally synthesized AA nano-sheets or AA nano-sheets/boehmite powders with sufficient amount of Cs salts (e.g., carbonate, hydroxide, aluminate, sulfate, etc.) used as binders (e.g., sintering additives), and sufficient amounts of burnout material(s) (e.g., water, petroleum jelly, polyvinyl alcohol, etc.) using a blender, mixer, or mill, etc. and forming the extrudate using an extruding apparatus.

In another embodiment in accordance with the present invention, the extrudates are made by mixing hydrothermally synthesized AA nano-sheets or AA nano-sheets/boehmite powders with sufficient amount of binders (e.g., sintering additives), such as TiO₂, ZrO₂, SiO₂, Mg Silicate, CaSilicate or their mixtures, and sufficient amounts of burnout material(s) (e.g., petroleum jelly, polyvinyl alcohol, etc.) using a blender, mixer, or mill, etc. and forming the extrudate using an extruding apparatus. The sintering-enhancing elements used in binders, such as Ti, Zr, Si, Mg, Ca, etc., or their mixtures, can be also incorporated in AA nano-sheets during the hydrothermal synthesis by doping.

In another embodiment in accordance with the present invention, the extrudates are made by mixing hydrothermally synthesized AA nano-sheets or AA nano-sheets/boehmite powders with sufficient amount of boehmite used as binder (i.e. sintering additive), and sufficient amounts of burnout material(s) (f. e. water, petroleum jelly, etc.) using a blender, mixer, or mill, etc. and forming the extrudate using an extruding apparatus.

An appropriate extruding apparatus can be used to prepare the extrudate. For instance extruders manufactured by The Bonnot Company, Uniontown, Ohio may be used. The diameter of the extrudate can be as small as 1/32″, the applied pressure can range between 100 and 3,000 psi or so. The conditions of forming the extrudate, as well as amounts and types of the binders and burnout materials, are determined experimentally for each type of AA nano-sheets or AA nano-sheets/boehmite powders, in order to yield optimum properties of the AA porous ceramics after subsequent heat treatment.

The heat treatment of the extrudates involves slow removal of water and other volatile matter between the room temperature and 200° C., removal of burnout materials, if any, up to 500° C., and finally building the strength of the porous support at temperatures up to 1,600° C., preferentially up to 1,450° C., together with transformation of boehmite, if any, into AA phase above 1,100° C. The heat ramp(s), including temperatures, durations, and heating rates during the extrudate heat treatment are selected to obtain desired mechanical strength and microstructure of the support, and are developed experimentally in each particular case. The porous AA ceramics obtained by the heat treatment of AA nano-sheets, or AA nano-sheets/boehmite extrudates with or without additives described above, can be used for a variety of applications.

Materials Characterization

Phase composition of precursor powders and AA materials after the hydrothermal synthesis, and sintered porous AA ceramics (after crushing it and grinding into powder) was characterized by X-ray diffraction using Advanced Diffraction System X1 diffractometer (one example: XRD, Scintag Inc.) using Cu K_{α} radiation, in the 2Θ range between 10-70° with a 0.05° step size and 0.3-1.0 s count time. The chemical identity of the materials was determined by comparing the experimental XRD patterns to standards compiled by the Joint Committee on Powder Diffraction and Standards (JCPDS), i.e. card # 10-0173 for AA (corundum) and #03-0066 for γ-AlOOH (boehmite).

The morphology and phase purity of the synthesized AA nano-sheets and nano-needles as well as microstructures and fracture surfaces of porous AA ceramics, were examined using scanning electron microscope (SEM, Model S-4500, Hitachi, Japan) at 5 kV accelerating voltage. Prior to the SEM examination, the materials were attached to aluminum holders using conductive carbon tape and subsequently sputtered with thin conductive layers of palladium.

High-resolution transmission electron microscopy (HRTEM) and electron diffraction were performed using field-emission gun energy-filtering high-resolution analytical scanning transmission electron microscope Tecnai F30 (one example from FEI Company, Hillsboro, Oreg.) with the acceleration voltage of 300 kV. Prior to the HRTEM examination, the materials were dispersed in isopropanol, ultrasonicated for 5 min., subsequently transferred onto Cu grids and dried under IR heat lamp.

Chemical compositions in the AA nano-sheets and porous AA ceramics were determined using DC Arc and ICP-MS methods (one example at NSL Analytical, Cleveland, Ohio). The nano-sheets were analyzed for the following elements (detection limits in brackets): Na (10 ppm), Si (10 ppm), Ca (10 ppm), Mg (10 ppm), Ti (50 ppm) and Fe (10 ppm),

Chemical moieties present on the surface of the doped AA nano-sheets and nano-needles were determined using X-ray photoelectron spectroscopy (XPS) using the Phi 5600 ESCA system. The AA nano-powders were attached to the holders using conductive carbon tape. The XPS spectra were acquired from the surface spots with diameters of approximately 0.3 mm on each sample. Only one spot on each sample was analyzed by this technique. In a typical XPS measurement, a 20-60 min. overview scans were performed in the binding energy range of 0-1,100 eV (0-1,400 eV in Mg-doped samples). Sizes, i.e. diameters, lengths, and aspect ratios of the doped AA nano-sheets and nano-needles were measured from the SEM photographs.

Specific surface areas (BET) of selected AA nano-sheets and nano-fibers were measured from 40-point BET nitrogen adsorption isotherm (one example at Micromeritics Analytical Services, Norcross, Ga.) or from 5-point BET nitrogen adsorption isotherm in the range of relative pressures (p/pₒ) between 0.07 and 0.24 using Nova 1200e equipment (Quantachrome Inst., FL).

Pore volumes and pore size distributions of the AA nano-sheets (as synthesized agglomerates) and sintered porous AA ceramics were measured using mercury intrusion porosimeter (one example: Model Poremaster 60, Quantachrome Inst., FL, pore sizes range of 3 nm-200 μm).

Porosities and pore volumes of the porous AA ceramics were measured from water absorption data and corresponding masses at room temperature, assuming absence of closed (i.e. impenetrable) pores. The water absorption tests of porous corundum ceramics were performed by slowly immersing the corundum ceramics of a known weight in DI water, heating the water close to the boiling point for 1 hour in order to remove any air entrapped in the pores, and finally measuring the weight of the wet corundum ceramics after the water has cooled down to the room temperature. Comparison of the mass of the carriers in dry and wet state allowed calculations of the open porosity (volume % units) pore volume (cm³/g units) and water absorption (% units).

Crush strength of the porous AA ceramics was measured using a hydraulic press attached to a calibrated heavy-duty electronic balance. In each measurement, AA ceramics was placed on a flat surface of the electronic balance and was slowly pressed by a steel plate mounted to a hand-operated hydraulic press. The symmetry axis of the porous AA ceramics was always parallel to the metal surfaces, i.e. the load was applied in the direction perpendicular to the symmetry axis of the ceramic extrudate. The load under which the support has cracked was recorded and used for calculations of the crush strength. At least 8 pieces with the same size were crushed that way, in order to calculate the average and minimum crush strength for each type of porous AA supports.

Control of Morphology and Chemical Composition of Hydrothermally Synthesized AA Nano-Particles

Properties of Hydrothermally Synthesized AA Nano-Sheets and Nano-Fibers

Typical physicochemical properties of AA nano-sheets and nano-fibers synthesized by the hydrothermal method, such as lengths/thicknesses, diameters, aspect ratios, morphologies, chemical and phase purities, and BET specific surface areas are summarized in Table II. For comparison, properties of an equiaxed corundum powder synthesized under similar conditions are also shown in Table II. The AAnano-sheets and nano-fibers exhibit a combination of high phase and chemical purity with unique morphology, which make them nano-materials of choice for a variety of applications.

TABLE II
Typical properties of AA nano-sheets and nano-needles synthesized by the hydrothermal method in the present invention.

| | Equiaxed | | | | | | |
|---|---|---|---|---|---|---|---|
| | Powder | Nano-sheets | Nano-sheets | | Nano-sheets | Nano-sheets | |
| Property | (reference) | Type I | Type II | | Type III | Type IV | “Nano-needles” |
| Morphology | None | 1 wt % SiO₂ | 3-5 wt % SiO₂ | | 5 wt % SiO₂ | 10 wt % SiO₂ | 10 wt % H₃BO₃ |
| Modifier | | | | | | | |
| (concentration) | | | | | | | |
| Aspect Ratio (—) | 1 | 7-100 | 15-200 | | 50-200 | 50-200 | 2-10 |
| Width/Length (μm) | N/A | 0.5-3.0 | 0.5-2.0 | | 0.5-2.0 | 0.5-2.0 | 0.2-1.0 |
| Thickness/ | 100-300 | 30-75 | 10-35 | | 10-20 | 10 | 35-100 |
| Diameter (nm) | | | | | | | |
| Morphology | Equiaxed | Randomly | Randomly | | Randomly | Randomly | Nano-needles |
| | crystals, form | aggregated | aggregated | | aggregated | aggregated | only, heavily |
| | elongated | nano-sheets | nano-sheets | | nano-sheets | nano-sheets + | aggregated, |
| | aggregates | | | | | equiaxed nano- | various types of |
| | (mesocrystals) | | | | | crystals | aggregation |
| Crystal form | 100% AA | 100% AA | 100% | AA | AA + γ-AlOOH | AA + γ-AlOOH | 100% AA |
| Chemical purity | >99.8 | >99 | 98 | | N/D | N/D | N/D |
| (%) | | | | | | | |
| Surface area, BET | 9-27 | 10 | 15-25 | | 31 | 43 | N/D |
| (m²/g) | | | | | | | |
| Impurities | | | | | | | |
| Si | 160 ppm | — | 2 | at % | — | — | — |
| Na | 120 ppm | — | <<0.1 | at % | — | — | — |
| Fe | 20 ppm | — | <<0.1 | at % | — | — | — |
| Mg | 50 ppm | — | <<0.1 | at % | — | — | — |
| Ca | N/D | — | <<0.1 | at % | — | — | — |
| S | N/D | — | 0.1 | at % | — | — | — |

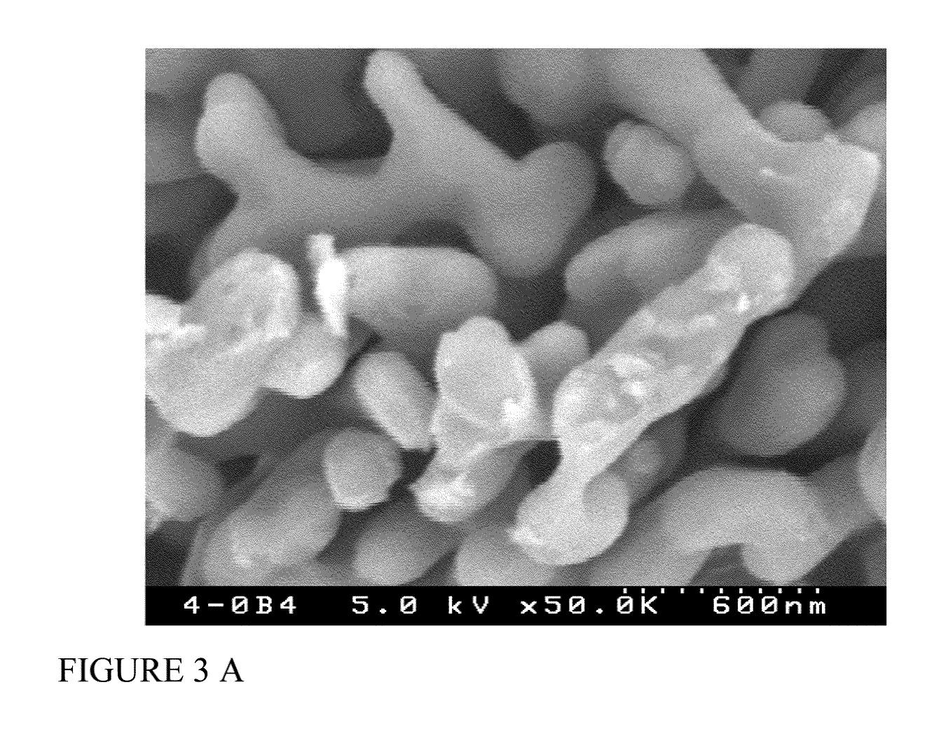

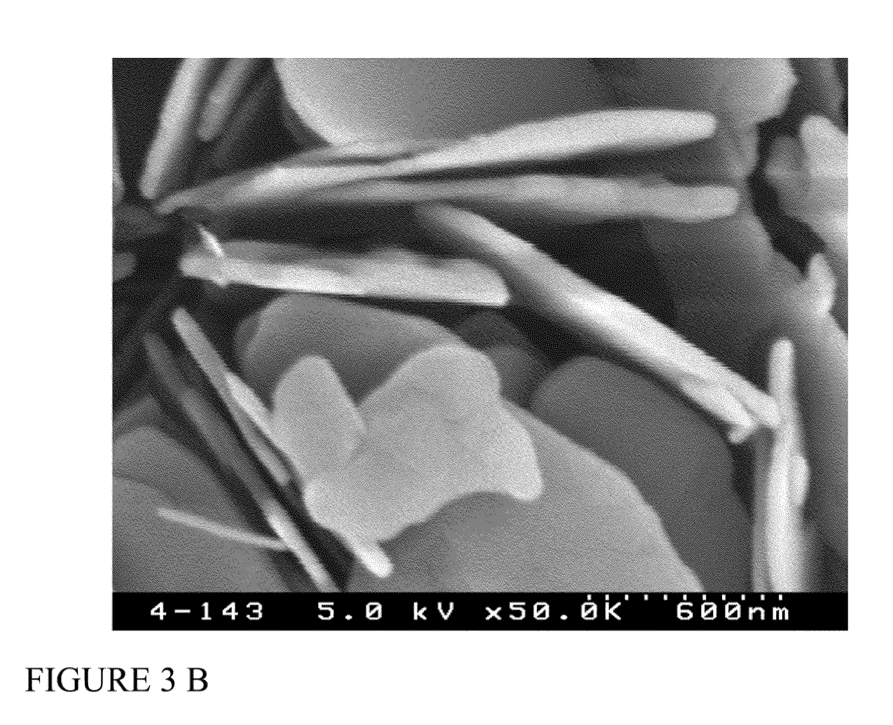

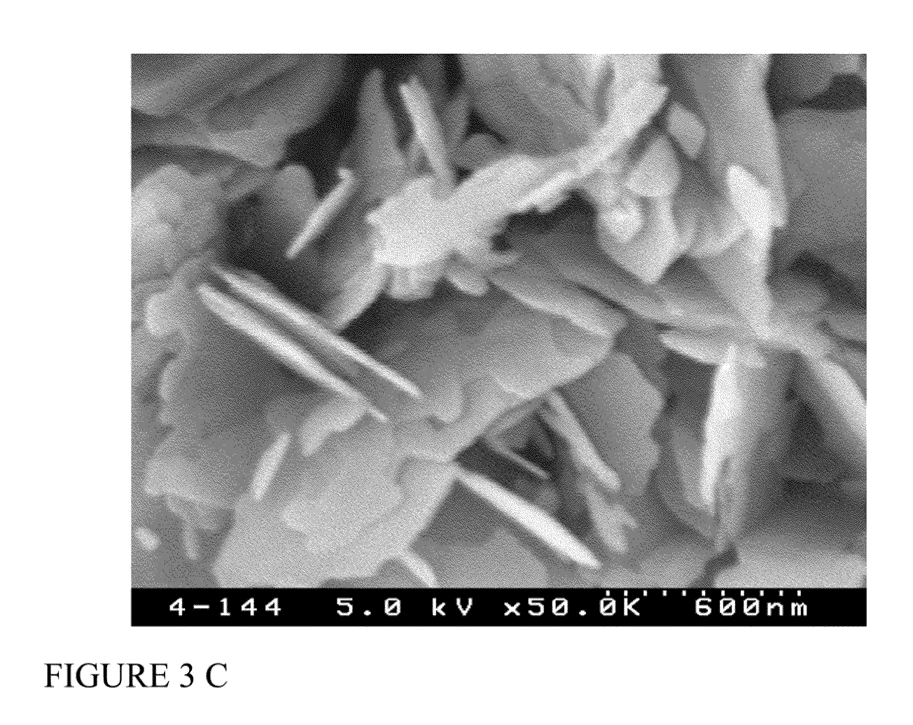

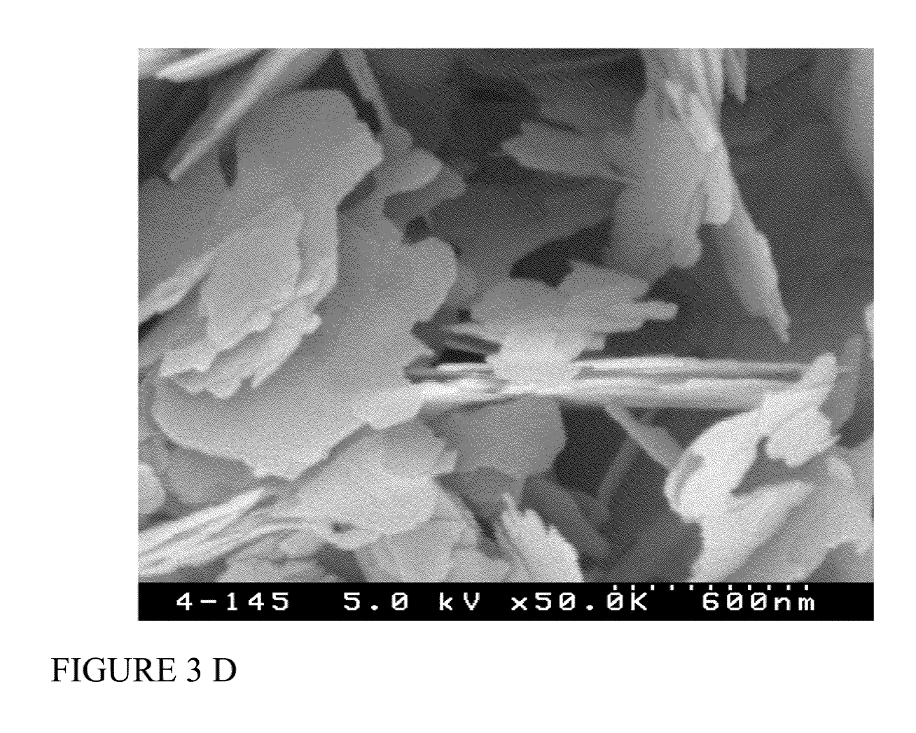

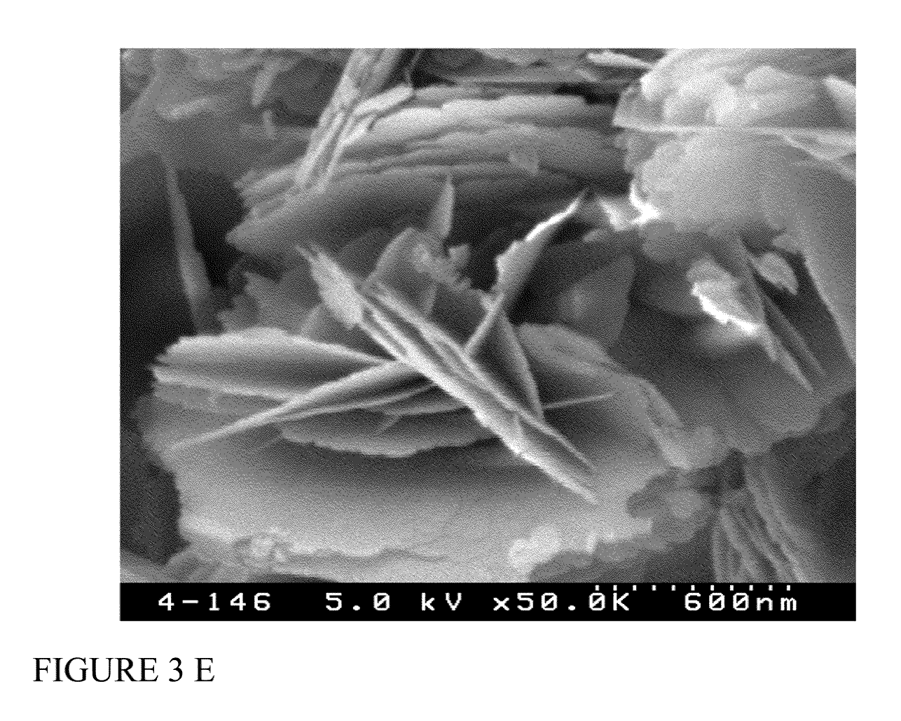

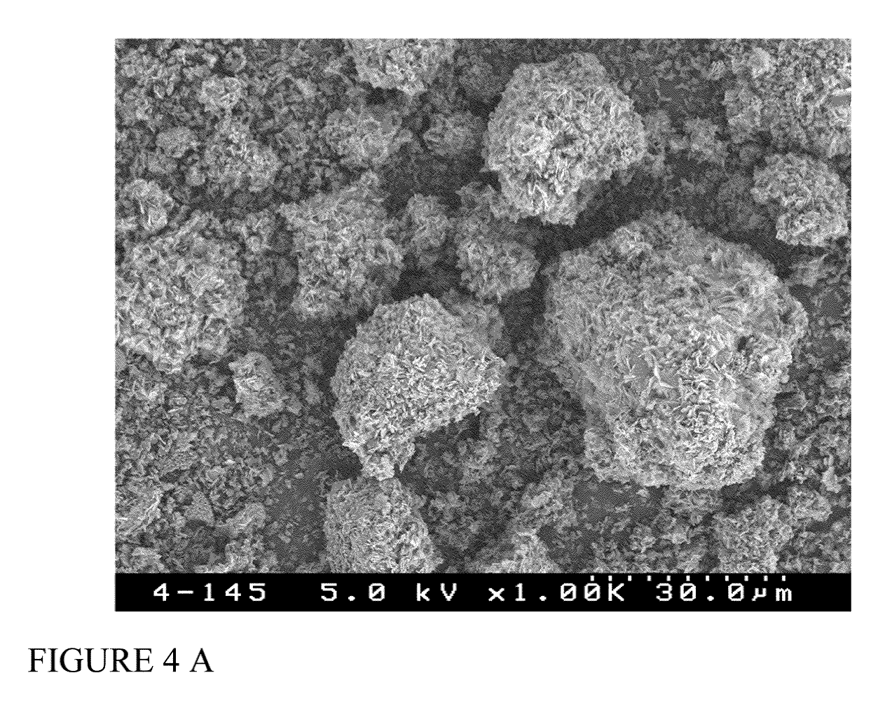

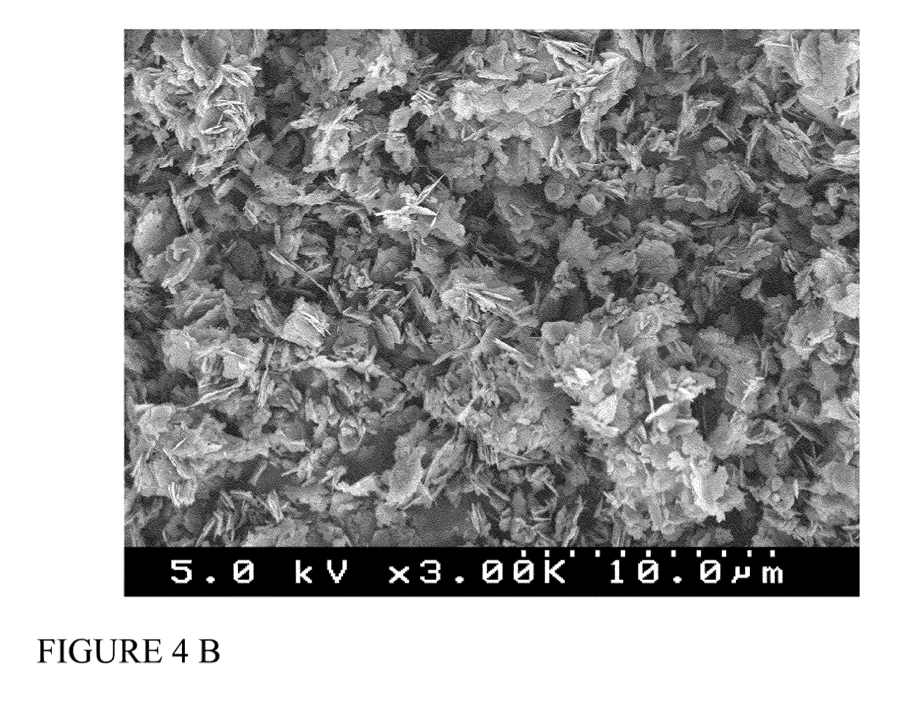

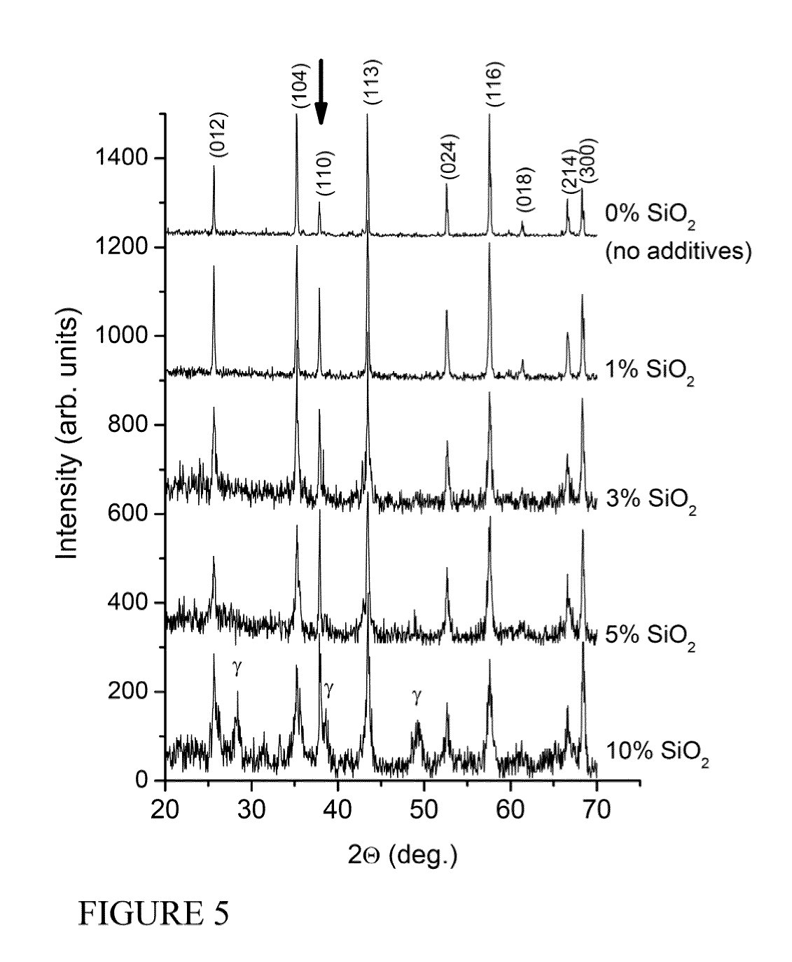

SEM photographs shown in FIGS. 3A-3E reveal typical morphologies of the AA nano-sheets. The individual crystallites exhibit comparable levels of aggregation, irrespectively of the nano-sheet type. The nano-sheets can form large spherical particles with diameters in excess of 30 μm (FIG. 4A) or be relatively well dispersed, as shown in FIG. 4B. Although the nano-sheets do not look like well-defined single crystals of the corundum phase with well-developed crystal facets, both XRD and HRTEM analysis confirms their single-crystal nature, as will be described later. Aspect ratio of the AA nano-sheets range between 7 and 200, their thicknesses are between 10 nm and 75 nm, and widths are between 0.5 μm and 3 μm (Table II, FIGS. 3A-3E). Nano-sheets of Type III, and Type IV (FIGS. 3A-3E, FIG. 5, Table II) contain various fractions of nano-sized boehmite crystals in addition to the AA. An interesting aggregation was observed in all types of the AAnano-sheets (FIGS. 3A-3E), where dozens of individual nano-sheets were stacked together and connected using their large facets, creating unique pore size distribution.

BET specific surface area of the AA nano-sheets is at least 10 m²/g and can be in excess of 40 m²/g, depending upon the nano-sheets thickness and agglomeration type, and as summarized in Table II. Agglomerates of the AA nano-sheets exhibited pore volume of micropores over 0.2 mL/g and had unique pore size distributions, as compared to the equiaxed materials.

Chemical purity of the AA nano-sheets is comparable to the chemical purity of the equiaxed corundum powders, except for the content of silica, which was used as morphology modifier (Table II). Phase purity of the AA nano-sheets is 100% in most cases. As shown in FIG. 5, no XRD peaks other than those derived from the AA (corundum) phase were observed in most types of the nano-sheets. However, composite powders with boehmite could also be synthesized, depending upon processing conditions (FIG. 5, Table II). The boehmite could be in form of individual crystallites forming agglomerates independently of the nano-sheets and/or in form of coatings on the AA nano-sheets.

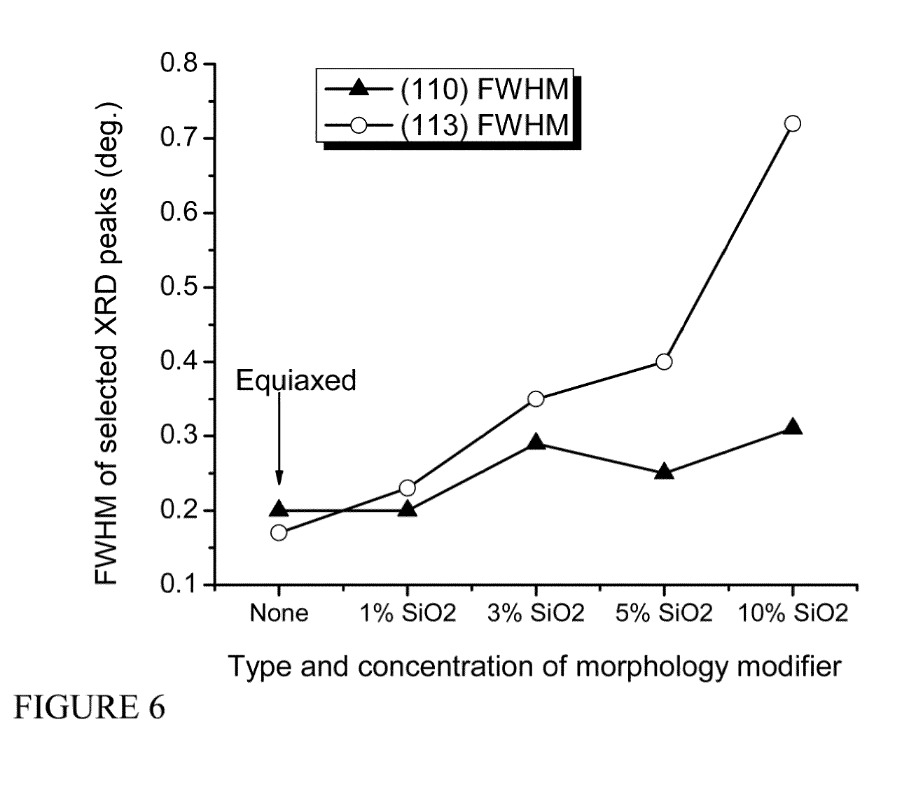

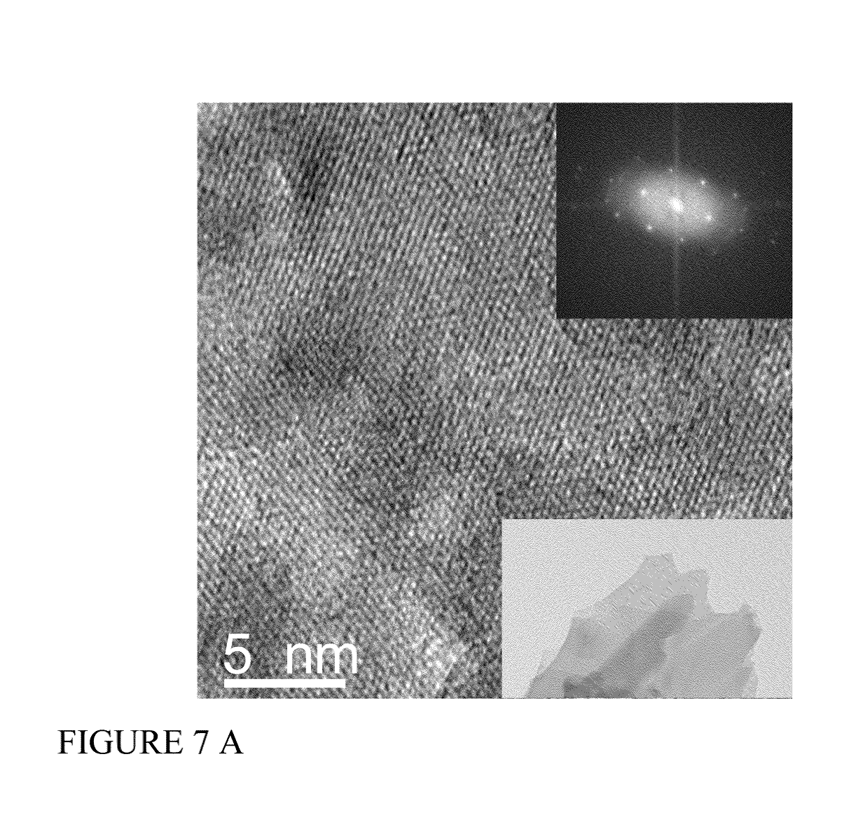

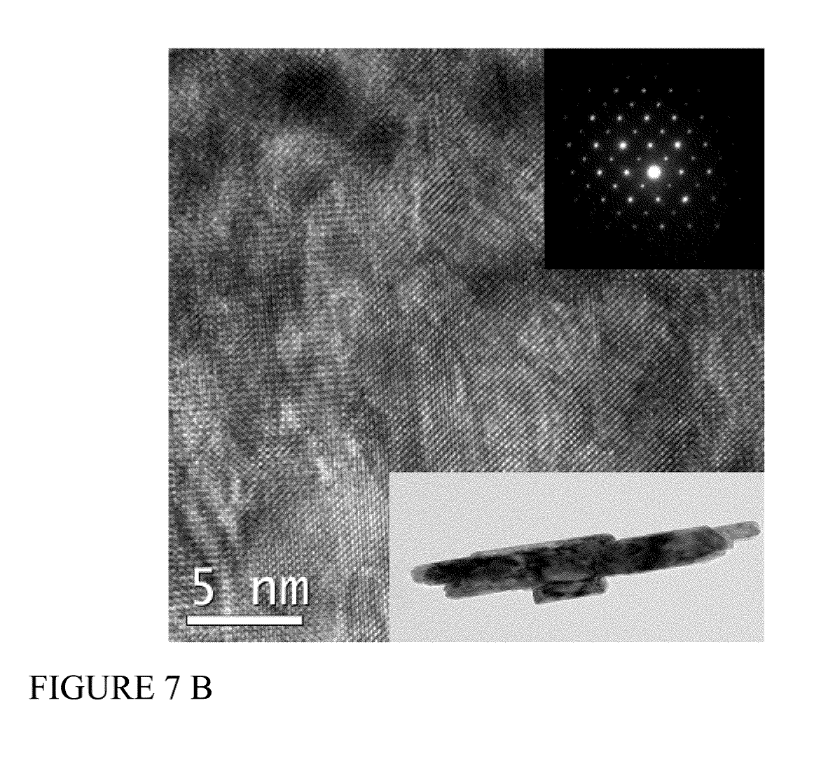

Increase of relative intensities of the XRD (300) peaks with increasing aspect ratio of the AA nano-sheets caused by texturing under pressure suggests c-faceting of individual crystallites (FIG. 5). Full-width at half maximum (FWHM) measurements of the XRD peaks revealed significant increase of the peak widths with increasing content of the morphology modifier, which can be associated with decreasing size/thickness of the AA nano-sheets and/or increasing lattice disorder (FIG. 6). The exceptions here were only the (110) peaks, which remained very narrow in all cases (FIG. 6, marked by arrow in FIG. 5). This effect can be explained again by c-faceting of the AA nano-sheets, which have widths in the order of microns in the <110> direction. High-resolution transmission electron microscopy (HRTEM) revealed hexagonal symmetry of atom arrangements and the lack of any grain boundaries, as confirmed by corresponding electron diffraction patterns (FIG. 7A). This confirms single-crystal nature and strong c-faceting faceting of the AA nano-sheets, thus is consistent with the XRD analysis.

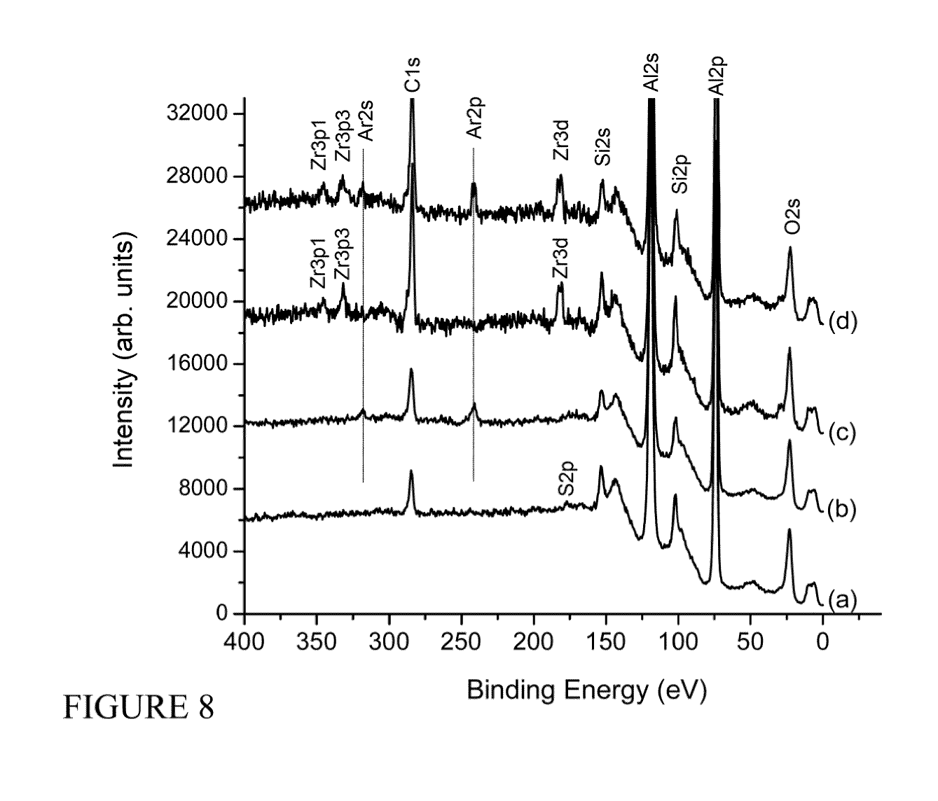

XPS spectra of the AA nano-sheets prepared in the presence of 5 wt % SiO₂ morphology modifier (FIG. 8A-8B) revealed presence of SiO₂-derived silicon on the surface of the as-synthesized nano-sheets. In the subsurface region, approximately 6 nm deep, as obtained by sputtering argon ions, reduced silicon concentration was observed. The only contamination detected in the nano-sheets in the entire range of binding energies of 0-1,100 eV, were traces of sulfur, derived from H₂SO₄ used in their hydrothermal synthesis.

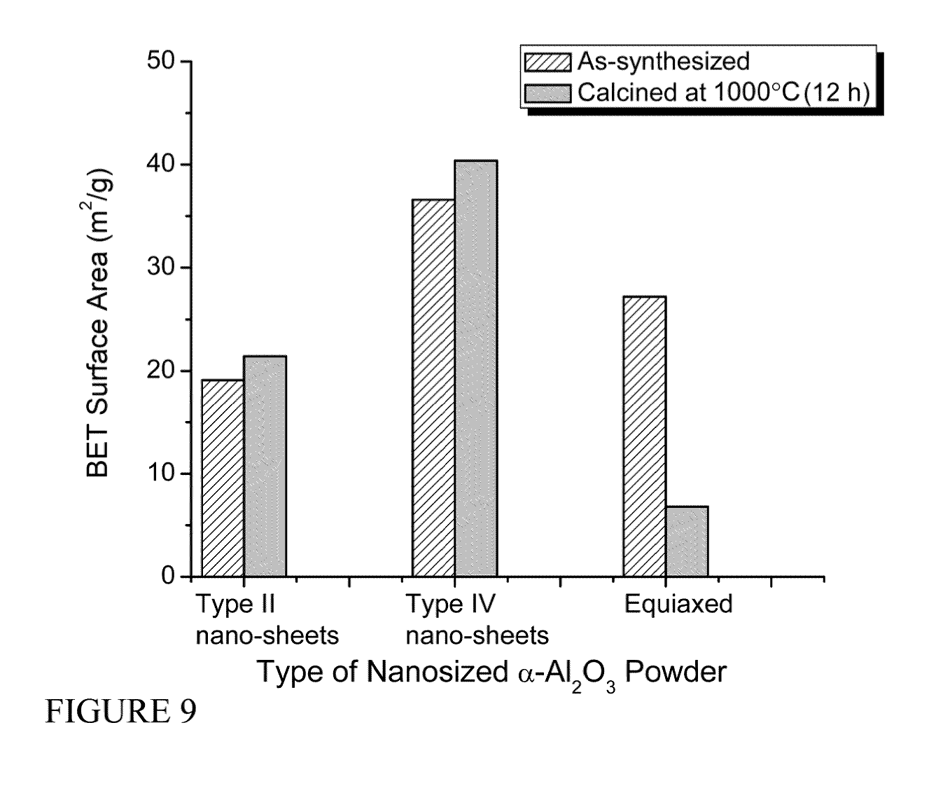

In one example embodiment of the present invention, the synthesized AA nano-sheets exhibited high temperature stability. Their morphology and BET surface area does not significantly change upon calcination at 1,000° C. for 12 hours, while nano-sized AA powder synthesized hydrothermally but with equiaxed morphology, exhibited fourfold decrease of their surface area due to the sintering effects occurring between round AA crystallites (FIG. 9).

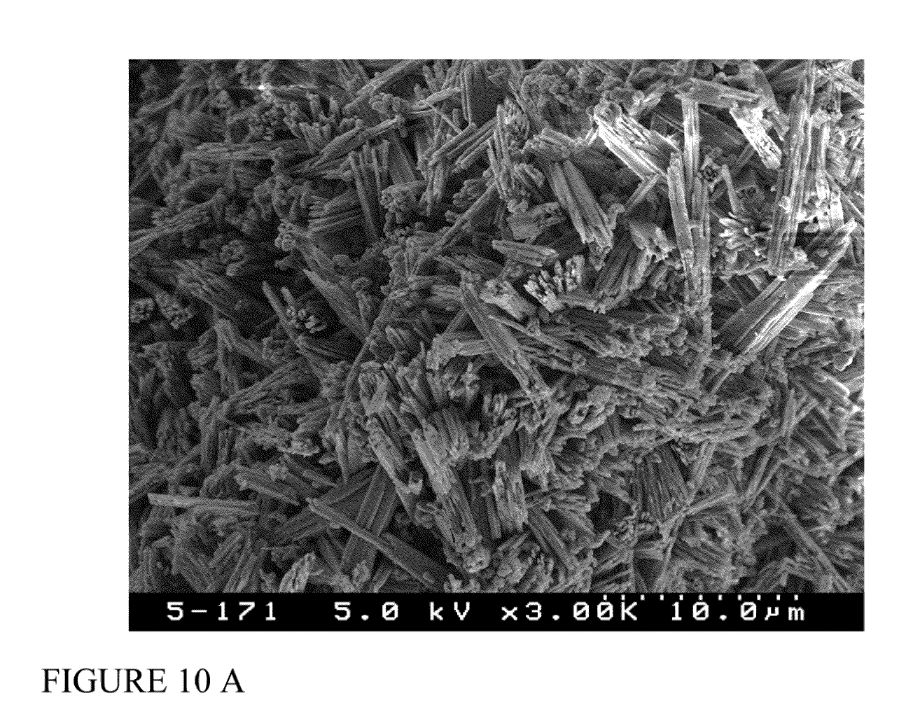

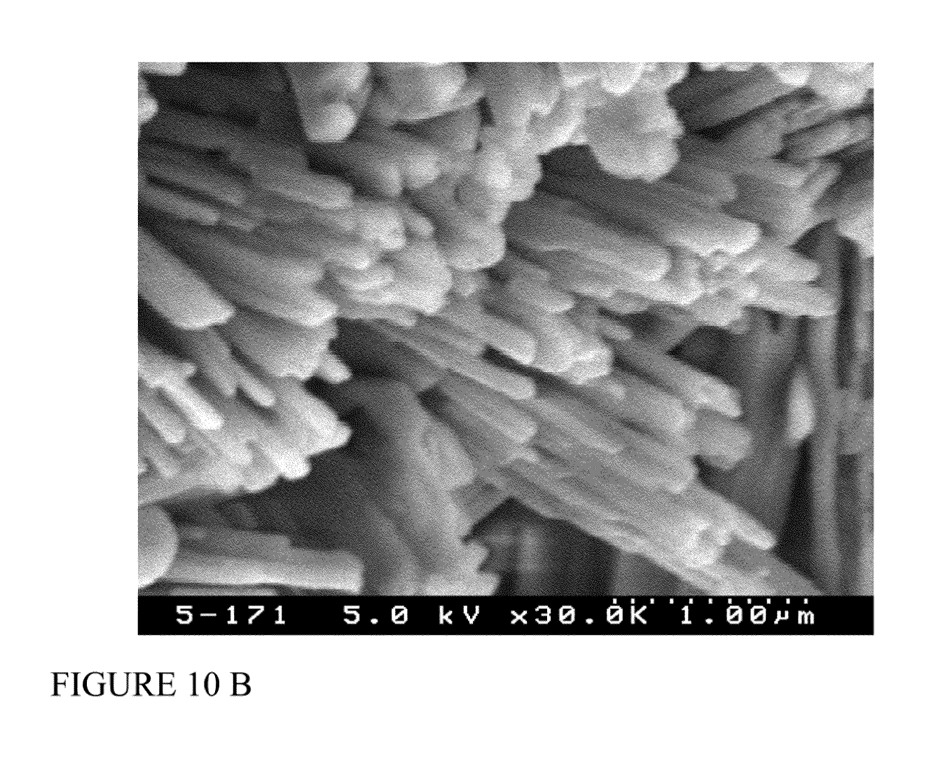

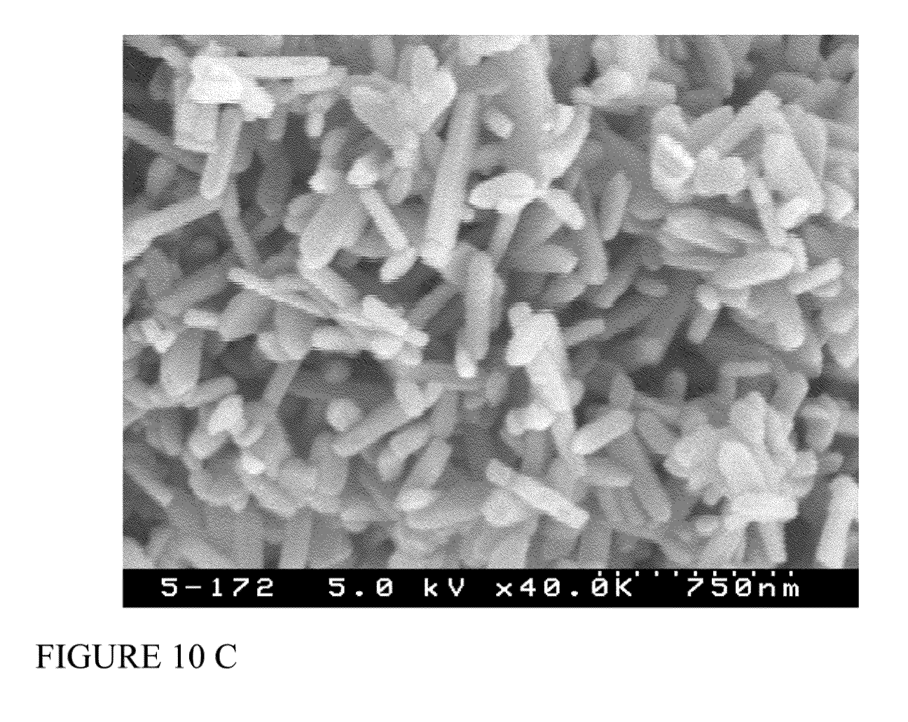

AA nano-needles were also synthesized in the present invention (see Table II and FIGS. 10A-10C). The nano-fibers exhibit diameters of 35-100 nm and aspect ratios up to 10, with either random or relatively high level of oriented aggregation. The nano-needles were single crystals elongated along the c-axis, as confirmed by electron diffraction (FIG. 7B). The oriented aggregation exhibited mesocrystal features, because there was no crystallographic misfit between individual elements of the aggregates.

Effects of the Hydrothermal Process Parameters on the Synthesis of AA Nano-Sheets and Nano-Fibers

Some effects of parameters of the hydrothermal synthesis of AA, such as the synthesis temperature, time, pressure, heating rate, ramp durations, seed concentration, etc., have been described in US Published Application No. 2007/0280877 A1. Some of these effects are summarized below. It is believed that the relationships established in the previous work on equiaxed powders synthesis can be applied in nano-sized corundum synthesis.

In the hydrothermal process in accordance with an aspect of the present invention, no AA phase is observed to form when the synthesis temperature is lower than 380° C. even in the presence of large fraction of seeds. It is believed that a stability region of corundum extends to at least 500° C. Increasing temperature reduces time necessary to full conversion of the precursor into corundum. Powders, which did not achieve 100% conversion into AA, consisted of unique mixtures of AA and γ-AlOOH (boehmite). In the hydrothermal process of our invention, in order to synthesize the AA nano-sheets and nano-fibers, temperature of 430° C. was applied to make powders consisting of AA and γ-AlOOH and 450° C. to synthesize 100% phase-pure AA.

In the hydrothermal process according to one aspect of the present invention, with increasing time of the hydrothermal synthesis, conversion to AA is more complete. Presence of seeds reduced the synthesis time and affected powder morphology by increasing the nucleation rate. No effects of the synthesis time on sizes of the AA crystals were observed. Typical pressure range for the hydrothermal synthesis of corundum is 1,000-2,000 psi. The minimum and maximum measured pressures, which allowed AA synthesis, were ˜500 psi and ˜3,000 psi, respectively.

In the hydrothermal process according to one aspect of the present invention, the conversion to the AA phase can be complete or limited. Several factors, such as lower temperature, shorter synthesis time, etc., can be used to make unique AA nano-sheets or nano-fibers in combination with various quantities of γ-AlOOH (boehmite) attached to the corundum surface or as discrete particles. Content of boehmite could vary from 0.01% to 100% (completely unreacted). These special conditions can be applied to produce very unique mixtures of boehmite and AAnano-sheets or nano-fibers of different morphologies and different mass ratios of corundum/boehmite. Examples of such mixture are Type III-IV nano-sheets, per Table II. Other examples of hydrothermally synthesized corundum/boehmite equiaxed powder mixtures were shown in US Published Patent Application No. 2007/0280877 A1.

The corundum seeds are believed to be very important in hydrothermal synthesis of AAnano-sheets and nano-fibers. Two types of seeds with equiaxed morphologies were used: 5 wt % of nano-sized commercial AA and 10 wt % of 1 μm commercial AA. Under otherwise identical conditions, the results were similar.

### Effects of the Morphology Modifiers

The morphology modifier used in the present invention to yield AA nano-sheets is colloidal silica in concentration 1-10 wt %, whereas morphology modifier for the AA nano-fibers is boric acid (H₃BO₃) in concentration of 10 wt %. AA crystals synthesized hydrothermally in the absence of the morphology modifiers but under otherwise identical conditions, were equiaxed (FIG. 3A). Addition of 1 wt % of silica in form of nano-sized colloidal dispersion resulted in the formation of flat corundum crystals (AA nano-sheets) with the aspect ratio of about 7-100 and thickness 30-75 nm. Further increasing the silica concentration to 3, 5, and 10 wt % resulted in increase of the aspect ratio of the AA nano-sheets to 200, reduction of their diameter, and thickness to 10 nm (FIGS. 3B-3E). Effects of boric acid concentration were not studied. However, a concentration of at least approximately 10 ppm of boron (B) atoms with respect to Aluminum (Al) atoms appears to be useful. The boric acid, with the boron, acts as a morphology modifier yielding elongated AAnano-crystals.

In an example embodiment of the present invention, boric acid (H₃BO₃) and colloidal silica (SiO₂) were found in this work to be efficient morphology modifiers, probably by adsorbing on crystal surfaces parallel and perpendicular to the c-axis, respectively. The modifiers were probably blocking growth in particular crystallographic directions, yielding nano-sheets or nano-fibers. Use of these morphology modifiers was essential to synthesize AA nano-sheets and nano-fibers under hydrothermal conditions. It is worth noting that the use of silica (SiO₂), with concentration of at least 10 ppm of Si atoms with respect to Al atoms, can act as a morphology modifier yielding flat AA nano-sheets. As another example, a concentration of at least 10 ppm of Si atoms with respect to Al atoms can act as a morphology modifier yielding flat AA nano-sheets.

In order to validate the hypothesis of morphology modification by preferred surface adsorption, XPS spectra were acquired on the surface and subsurface regions of selected AA nano-sheets. Results of the XPS analysis are summarized in FIG. 8. It is clearly seen that silicon peaks derived from silica are present on the surfaces of the as-synthesized nano-sheets, which were hydrothermally synthesized in the presence of 5 wt % SiO₂. This morphology modifier was present on the nano-sheets surfaces despite the fact that the autoclave was vented after the hydrothermal synthesis, removing all water vapor and impurities. It is thus an indication of the existence of strong adsorption phenomena. After removing the surface layer from the AA nano-sheets to the depth of approximately 6 nm, XPS spectra were acquired again and reduction of Si intensity was observed. These results seem to confirm the adsorption mechanism hypothesis, but partial lattice incorporation of Si in AA nano-sheets is quite possible as well. Thus either of these processes or their combination resulted in morphology modification of the AA materials. Similar effect was observed in the case of borate adsorption on the AA nano-needles.

The adsorbed species on the surfaces of the AA nano-sheets and nano-fibers could be removed, if necessary, by treatments using either acids or bases, or their combinations, or even by thermal treatments. Such treatments could also result in etching of the AA nano-sheets and nano-fibers surface, thus increasing their roughness, which may be desirable in certain applications, for example in catalytic applications by better nesting particles of the catalysts. More specifically, corundum is essentially insoluble in acids and bases whereas silica is soluble in acid and has little solubility in bases. Borates are soluble in bases thus can be easily removed by caustic extraction. Any alkali left in the solid can be removed by acid wash with nitric acid after the alkaline extraction.

### Properties of Doped AA Nano-Sheets

Typical properties of doped AA nano-sheets synthesized by the hydrothermal method are summarized in Table III. The doped AA nano-sheets exhibit a combination of unique morphology, high BET surface area, controlled chemical composition, and stability at high temperatures, which make them nano-materials of choice for a variety of applications.

TABLE III
Properties of the doped AA nano-sheets synthesized by the hydrothermal method in the present invention.^{@}

| | | | | | BET surface area (m²/g) | |
|---|---|---|---|---|---|---|
| | | Measured dopant | | | | After |
| | Chemical additives | concentration | Uniformity of | | | calcination at |
| Example | (concentration in | by XPS | dopant | | | 1,200° C. for |
| No. | weight %)^{#} | (atom %) | concentration | Phase composition | As-synthesized | 24 hrs |
| 2 | None (Reference) | N/A | N/A | 100% AA | 19.1* | 21.4* |
| 6 | 3.0 wt % ZrOCl₂ | 0.40 | very uniform | 100% AA | 28.4 | 21.2 |
| 7 | 3.0 wt % CrCl₃ | 0.27 | very uniform | 100% AA | 23.1 | 19.3 |
| 8 | 3.0 wt % Ti₂(SO₄)₃ | 0.34 | uniform | AA + γ-AlOOH (<) | 26.7 | 16.2 |
| 9 | 3.0 wt % MgCl₂ | 0.4 | gradient | 100% AA | 15.7 | 10.2 |
| 10 | 3.0 wt % FeCl₃ | 0.10 | very uniform | 100% AA | 22.6 | 21.2 |
| 11 | 0.3 wt % YCl₃ | — | — | AA + tr. impurities | — | — |
| 12 | 3.0 wt % ZnCl₂ | — | — | AA + tr. impurities | — | — |
| 13 | 3.0 wt % LaCl₃ | — | — | AA + tr. impurities | — | — |
| 14 | 0.3 wt % CuSO₄ | 0.03 | uniform | 100% AA | 22.3 | 15.7 |
| 15 | 3.0 wt % CoCl₂ | 0.4^{$} | uniform | AA + tr. impurities | 10.9 | 9.7 |
| 16 | 3.0 wt % NiCl₂ | 0.15 | uniform | AA + tr. impurities | 11.7 | 15.2 |
| 17 | 3.0 wt % SnCl₂ | — | — | AA + γ-AlOOH (<) | — | — |
| 18 | 0.3 wt % Bi(NO₃)₃ | — | — | 100% AA | — | — |
| 19 | 0.3 wt % NbCl₅ | 0.02 | uniform | 100% AA | 23.2 | 20.2 |
| 20 | 3.0 wt % TaCl₅ | — | — | 100% AA | — | — |
| 21 | 3.0 wt % V₂O₅ | — | — | AA + γ-AlOOH (<) | 25.4 | 2.7 |
| 22 | 3.0 wt % CeCl₃ | — | — | AA + γ-AlOOH (<) | — | — |
| 23 | 3.0 wt % KMnO₄ | — | — | 100% AA | — | — |
| 24 | 0.3 wt % MoCl5 | 0.03 | uniform | AA + γ-AlOOH (<) | — | — |
| 25 | 3.0 wt % MoCl5 | 0.35 | uniform | 100% AA | — | — |
| 26 | 0.3 wt % SbCl5 | 0.08 | gradient | 100% AA | — | — |
| 27 | 3.0 wt % SbCl5 | 0.25 | gradient | 100% AA | — | — |
| 28 | 0.3 wt % LiOH | below detection | — | 100% AA | 19.7 | 13.6 |
| | | limit | | | | |
| 29 | 3.0 wt % CsOH | below detection | — | 100% AA | 21.9 | 20.6 |
| | | limit | | | | |
| 30 | 3.0 wt % NaCl | — | — | AA + tr. impurities | | |
| 31 | 3.0 wt % KCl | — | — | AA + γ-AlOOH (tr.) | | |
| 32 | 3.0 wt % BaCl2 | — | — | 100% AA | | |
| 33 | 3.0 wt % SrCl2 | — | — | 100% AA | | |
| 34 | 3.0 wt % CaCl2 | — | — | 100% AA | 23.6 | — |

*measured after calcination at 1,000° C. for 12 hours
^{#}in some cases, hydrated forms of the salts listed were used
^{$}measured by Auger electron spectroscopy (AES).
^{@}All nano-sheets were synthesized under the same hydrothermal conditions, i.e. at 450° C., under ~2,000 psi pressure for 10 days. Presence of the nano-sheets was confirmed by SEM and/or XRD analysis

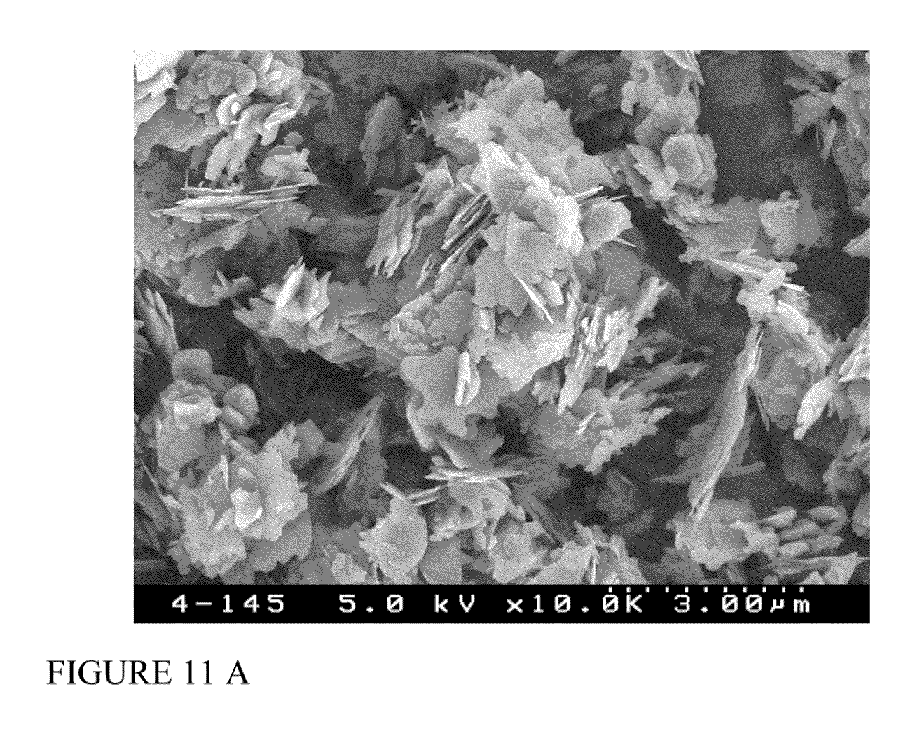

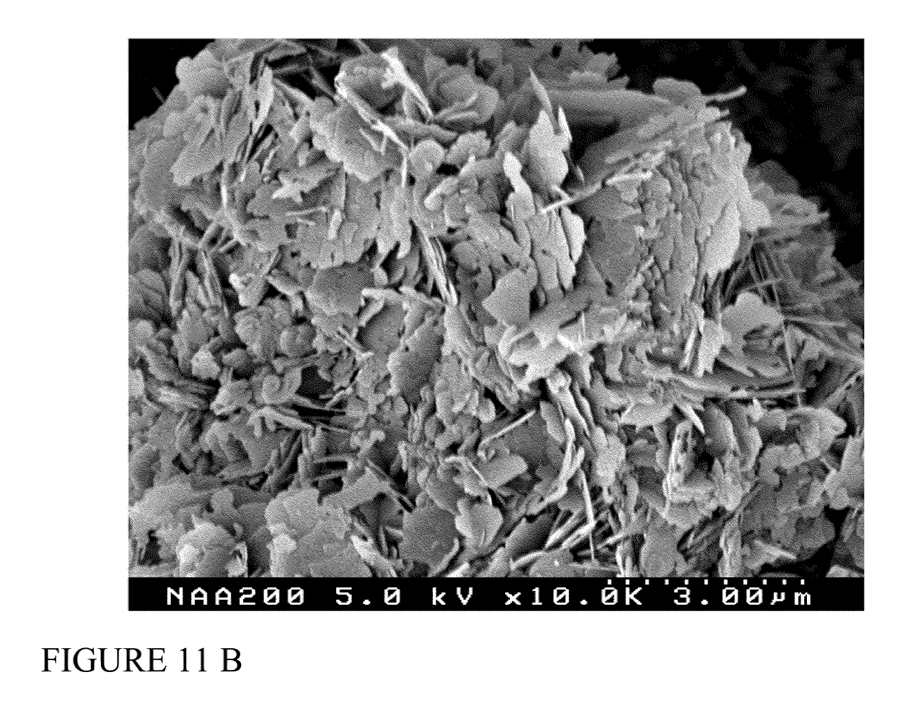

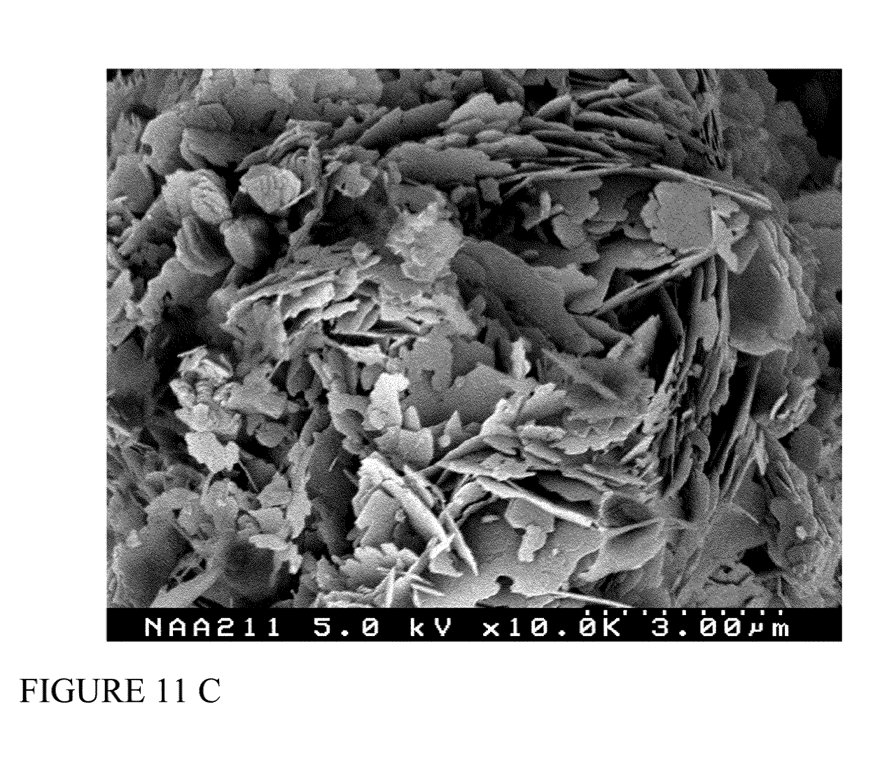

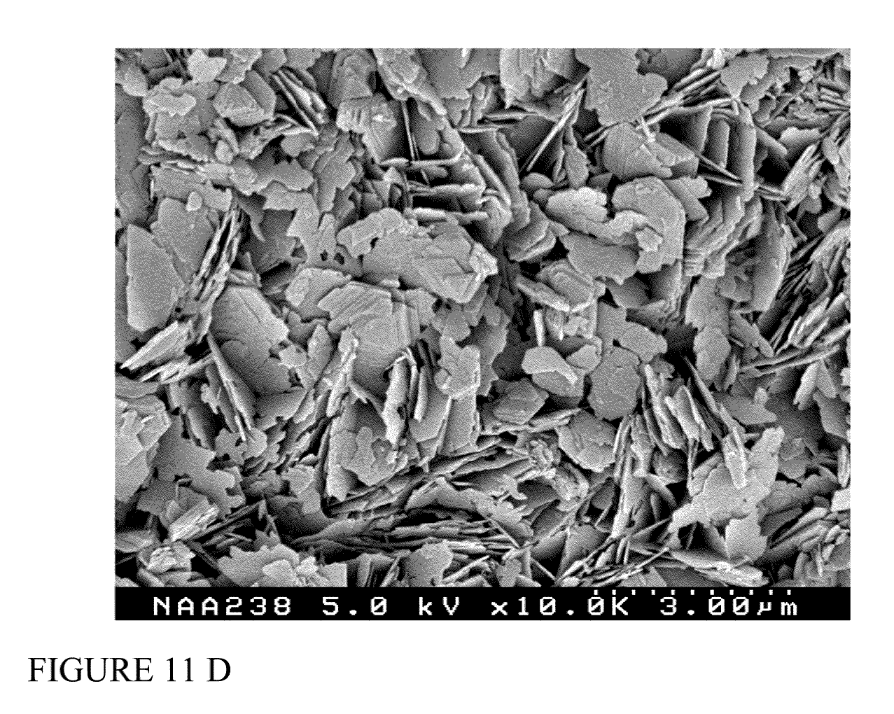

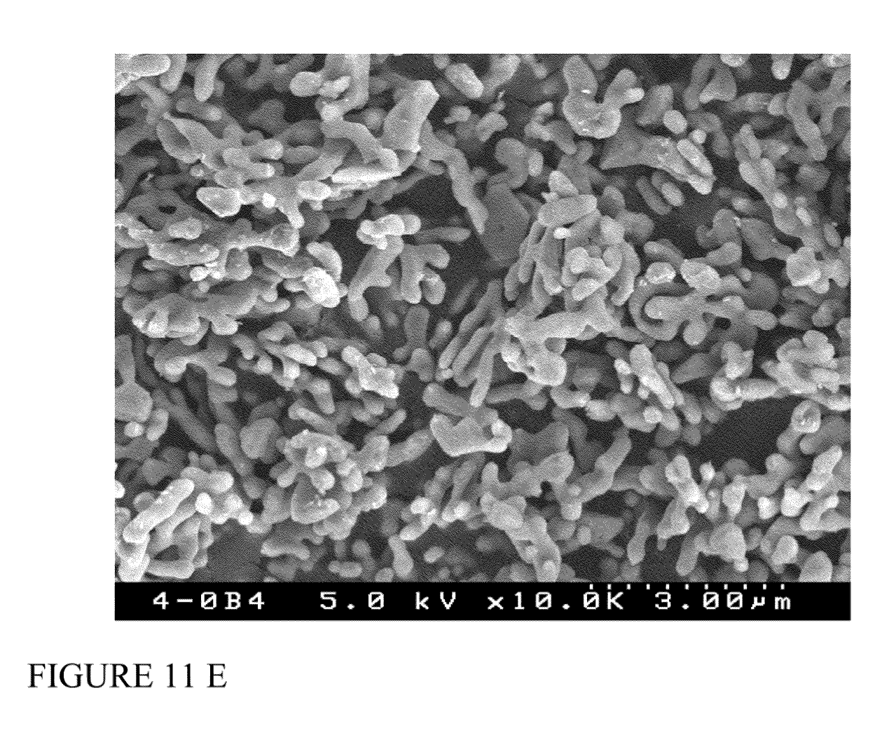

SEM photographs shown in FIGS. 11B-11D reveal typical morphologies of the doped AA nano-sheets. For comparison, properties of undoped AA nano-sheets, synthesized under the same conditions are also shown in FIG. 11A, and reference AA powder, synthesized under the same hydrothermal conditions in the absence of morphology modifier and dopants is shown in FIG. 11E. In the doped AA nano-sheets, the individual crystallites exhibit comparable morphologies and levels of aggregation to the undoped nano-sheets, irrespectively upon the chemical composition. The nano-sheets can agglomerate to form large spherical particles with diameters in excess of 30 μm or be relatively well dispersed. The doped nano-sheets may form agglomerates in which individual crystallites are either randomly connected or are stacked together and connected by large facets, creating materials with unique pore size distributions (FIGS. 11B-11D). Aspect ratio of the doped AA nano-sheets ranges between 7 and 200, their thicknesses are between 10 nm and 75 nm, and widths are between 0.5 μm and 3 μm (FIGS. 11B-11D).

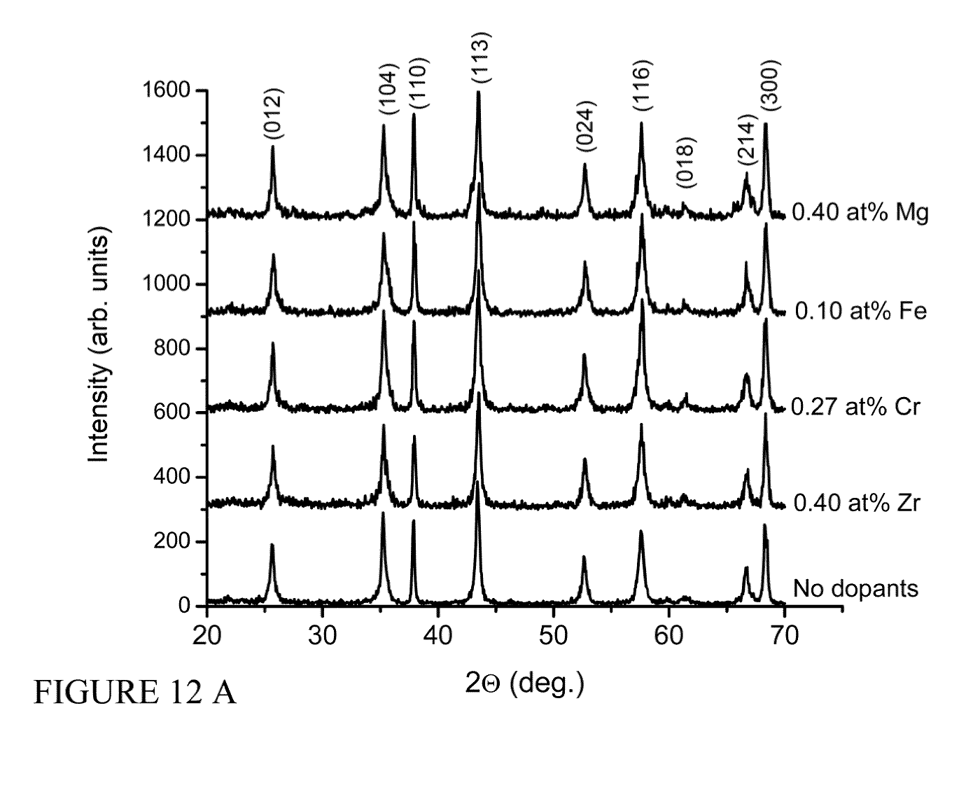

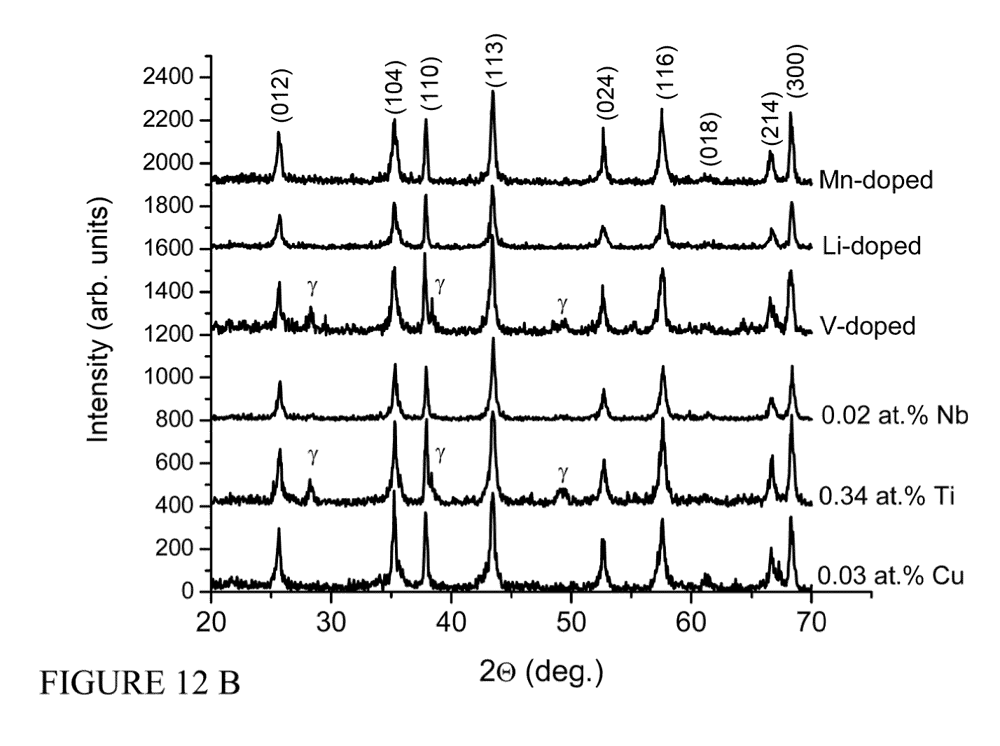

Powder X-ray diffraction analysis (XRD) of the doped nano-sheets revealed the presence of pure-phase AA in most cases (FIGS. 12A-12B, see also Table III). High relative intensities of the XRD (300) peaks of the doped AA nano-sheets, caused by texturing under pressure, suggest c-faceting of individual crystallites (FIGS. 12A-12B). Full-width at half maximum (FWHM) measurements of the XRD peaks revealed significant increase of the peak widths as compared to the equiaxed AA, which can be associated with small size/thickness of the AA nano-sheets and/or increasing lattice disorder. The exceptions here were only the (110) peaks, which remained very narrow in all cases. This effect can be explained again by c-faceting of the doped AA nano-sheets, which have widths in the order of microns in the <110> direction.

Phase purity of the doped AA nano-sheets is 100% in most cases (Table III). As shown in FIGS. 12A-12B, no XRD peaks other than those derived from the AA (corundum) phase are observed in most types of the nano-sheets. However, composite powders with boehmite were also synthesized, depending upon type of dopant used (FIG. 12B, Table III). The boehmite can be in form of individual crystallites forming agglomerates independently of the nano-sheets and/or in form of coatings on the AA nano-sheets. In a few cases, traces of not identified impurities are observed (Table III).

BET specific surface area of the doped AA nano-sheets is at least 10 m²/g and can be as high as 30 m²/g, depending upon the type of dopant, as summarized in Table III. Certain reduction of the BET surface area is observed after calcination in air under extreme conditions, i.e. at 1,200° C. for 24 hours, yet most nano-sheets are thermally stable (Examples 2, 6, 7, 10, 15, 19, 29). The thermal behavior of the doped AA nano-sheets confirms generally high thermal stability of the AA nano-sheets and strong effect of certain dopants on acceleration of the diffusion processes, as manifested by their enhanced sinterability and surface area reduction. Among the investigated materials of the present invention, only V-doped AA nano-sheets exhibited substantial surface area loss at high temperatures (Example 21).

Chemical purity of the doped AA nano-sheets is comparable to the chemical purity of the undoped nano-sheets, except for the content of dopants, which were intentionally added. In the present invention, the AA nano-sheets were hydrothermally synthesized with such dopants as Y, Zr, Zn, La, Cu, Co, Ni, Cr, Fe, Sn, Ti, Bi, Nb, Ta, V, Mo, Sb, Ce, Mn, Mg, Li, Cs, Na, K, Ba, Sr, Ca, etc. Doping did not change morphology of the nano-sheets but modified their chemical composition by introducing lattice defects, which could form active sites on their surface and in the bulk. The dopants were present in the measured concentrations ranging from ˜0.01 at % to ˜0.5 at. % (Table III). In all cases, XPS analysis revealed practically the same metal concentrations both on the surface and in the bulk, at about 6-12 nm deep (FIGS. 8c-d, 13, 14, and 15); strongly suggesting incorporation of the dopants in the AA lattice. The XPS spectra of the AA nano-sheets, which were synthesized in the presence of 5 wt % SiO₂ morphology modifier, also revealed presence of SiO₂-derived silicon on the surface of the as-synthesized nano-sheets (FIG. 8). In the subsurface region, approximately 6 nm deep, as obtained by sputtering argon ions, reduced silicon concentration was observed. The only contamination detected in the nano-sheets in the entire range of binding energies of 0-1,100 eV (0-1,400 eV for Mg-doped materials), were traces of sulfur, derived from H₂SO₄ used in their hydrothermal synthesis.

### Applications of AA Nano-Sheets and Nano-Fibers

The doped and undoped AA nano-sheets and nano-fibers in accordance with aspects of the present invention are well suited for a variety of demanding applications, such as use as high-surface area catalytic supports or porous membranes, as unique nano-reinforcements in porous or dense ceramic-matrix or polymer-matrix composites, as abrasive materials in CMP, for the fabrication of textured AA ceramics, fibrous-porous ceramics, refractory thermal insulations, reinforcements of in metal-matrix composites, etc.

More specifically, c-faceted, AA nano-sheets may have tremendous additional advantage in catalytic applications, which use preferentially c-facets, because in the AA nano-sheets surfaces associated with other facets are negligible. Controlled faceting and pore geometry can have an impact on catalyst selectivity. Presence of active sites introduced by dopants, unique pore size distributions and pore geometries, not possible with equiaxed particles can be of interest by having impact on catalyst selectivity, and other properties. Hypothetically, the synthesized AA nano-particles with strong c-faceting could exhibit effective surface areas of >100 m²/g in c-facet-sensitive reactions. Moreover, catalytic reactions occurring at high temperatures and/or in corrosive environments could benefit from high surface area, thermally stable AA supports or catalysts with or without dopants. AA nano-sheets based materials may supplement or replace currently used transition aluminas that suffer substantial surface area loss at elevated temperatures. Dopants can modify surface properties of the AA nano-sheets, such as concentration and strength of acid sites or basic sites, which is very important in catalytic applications of these materials. More important, hydrothermally made doped AA may incorporate dopants that are not incorporated in the lattice by other methods, resulting in special advantages in catalysis. Moreover, the dopants incorporated by this hydrothermal methods may be more stable under catalytic conditions as compared with dopants added by other methods. The AA nano-sheets based materials may supplement currently used transition aluminas that suffer substantial surface area loss at high temperatures.

The incorporation of SiO₂ into the AA nano-sheets will create strong acid sites of critical importance in catalytic applications of these materials in acid-base catalyzed reactions. The presence of SiO₂ in AA may also have significant impact on the metal-support interactions, critical to the catalytic performance of Ag supported on AA carriers in reactions such as oxidation of ethylene to ethylene oxide or propylene to propylene oxide. Thermally stable carriers such as SiO₂ doped AA are also important in the design of catalysts for control of automotive emissions. In general we foresee new possibilities for our SiO₂ doped AA as thermally and chemically stable high surface area supports useful to replace transitional alumina in numerous catalytic applications.

In CMP applications, use of the AA nano-sheets with high hardness combined with flat surfaces could result in increased materials removal rate and simultaneous decreased roughness and scratches, as compared to equiaxed alumina particles. Dopants can modify surface properties of the AA nano-sheets, such as the surface charge and zeta potential, which is very important in preparation of stable dispersions of these nano-materials.

Fabrication of Porous AA Ceramics from AA Nano-Particles

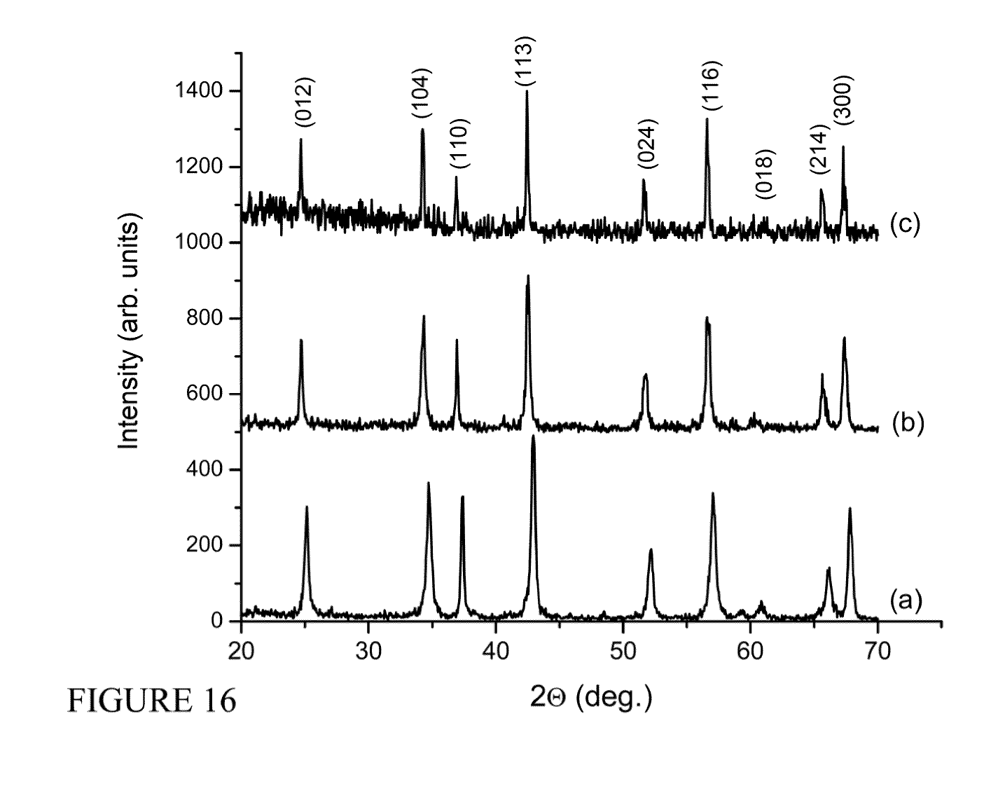

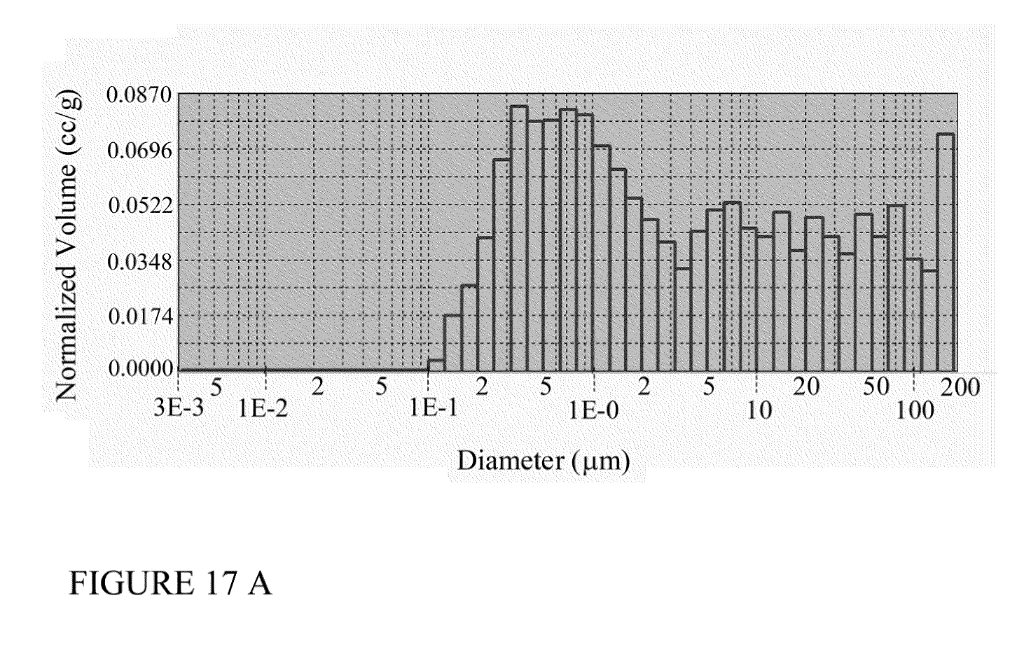

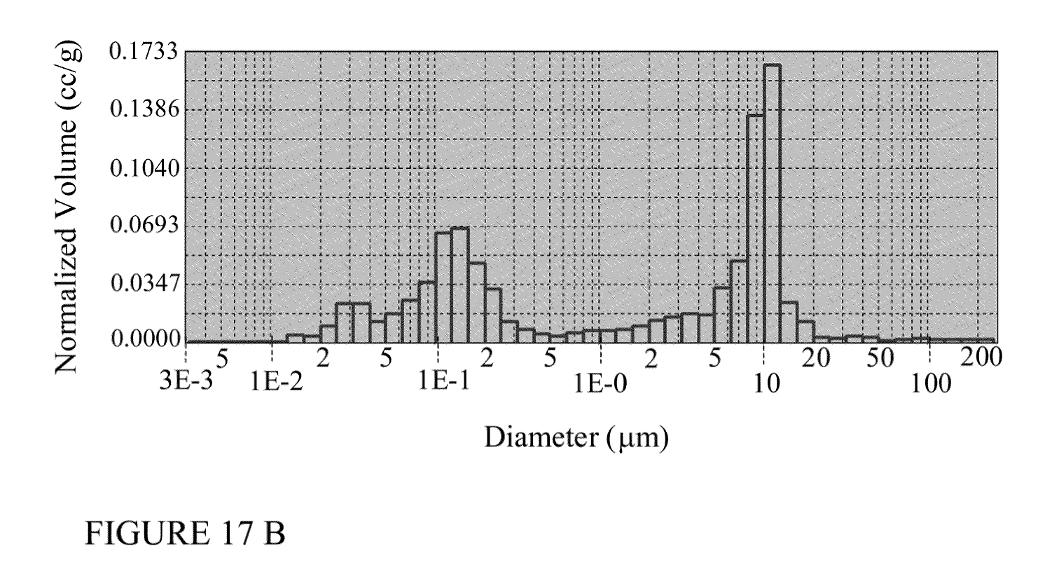

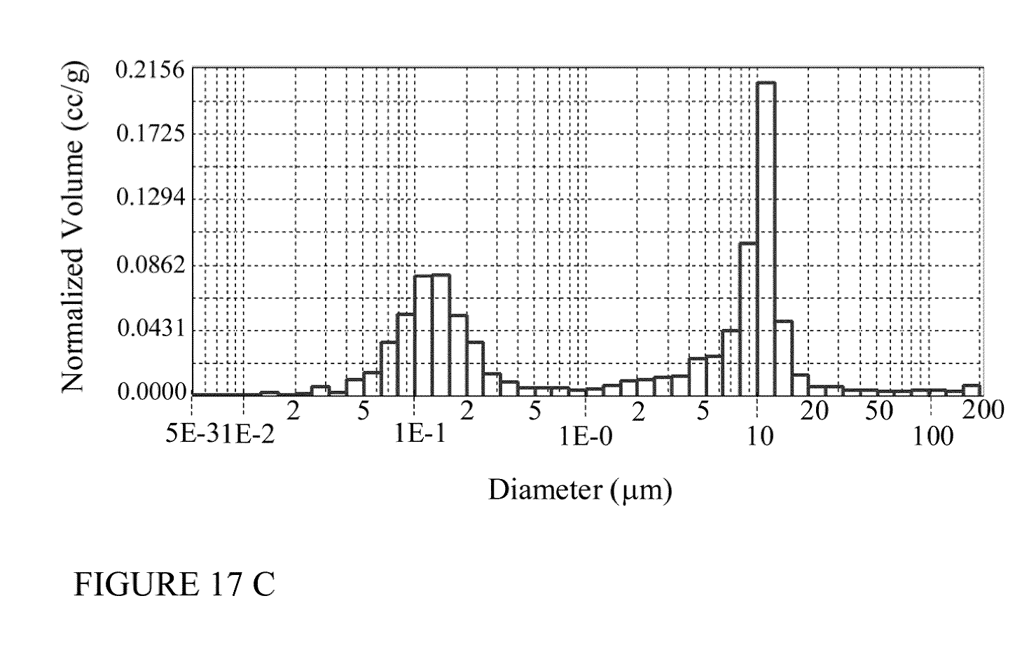

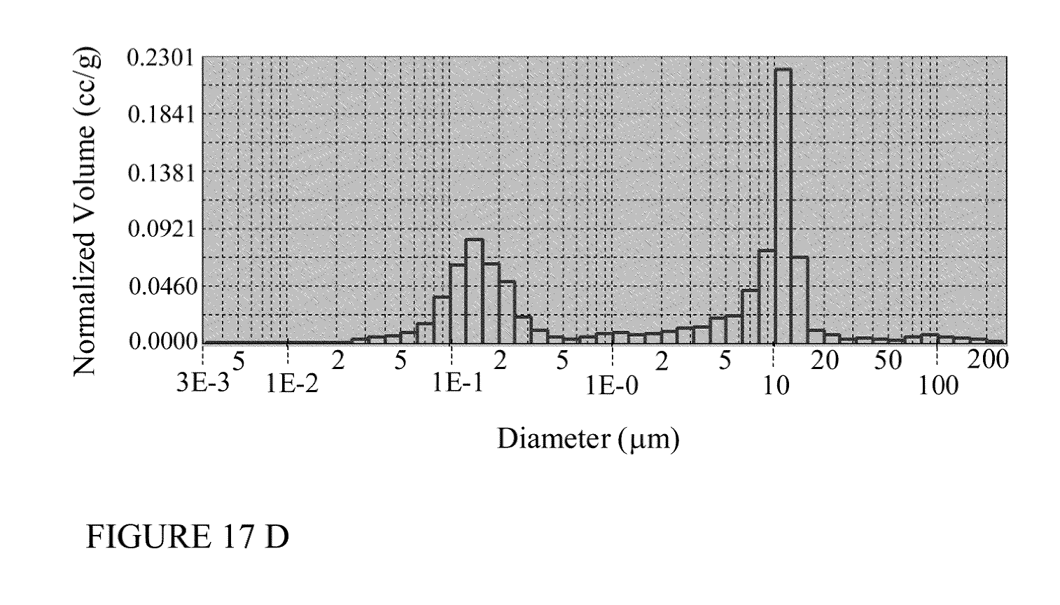

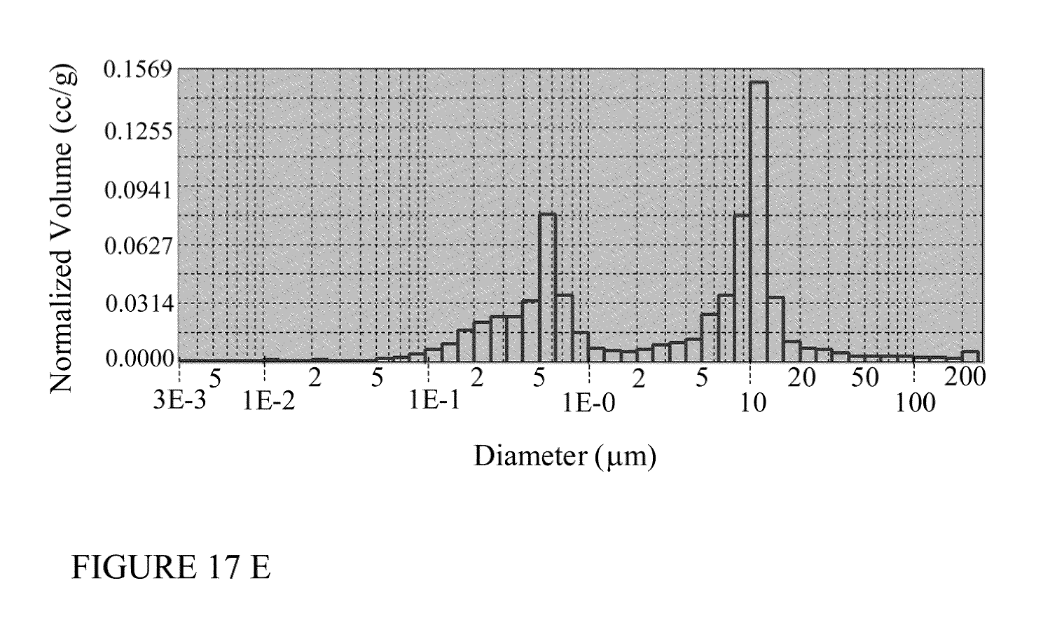

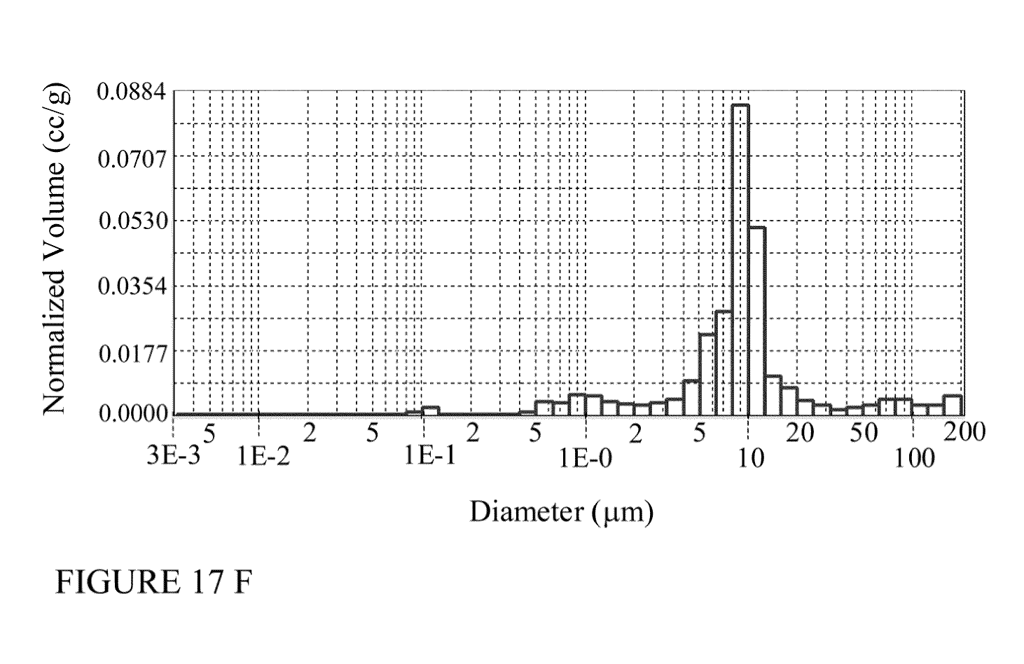

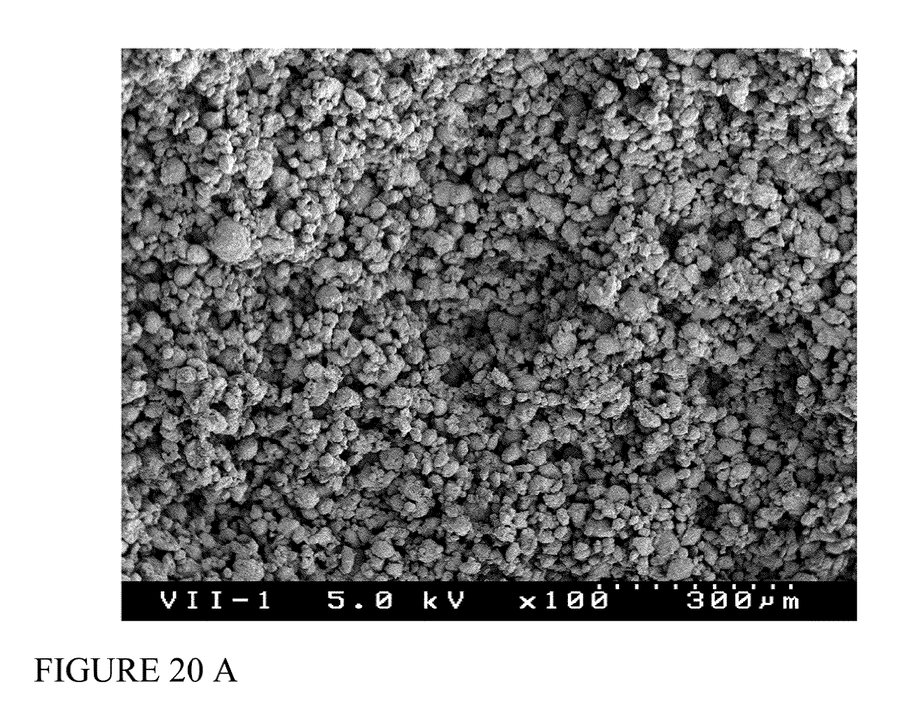

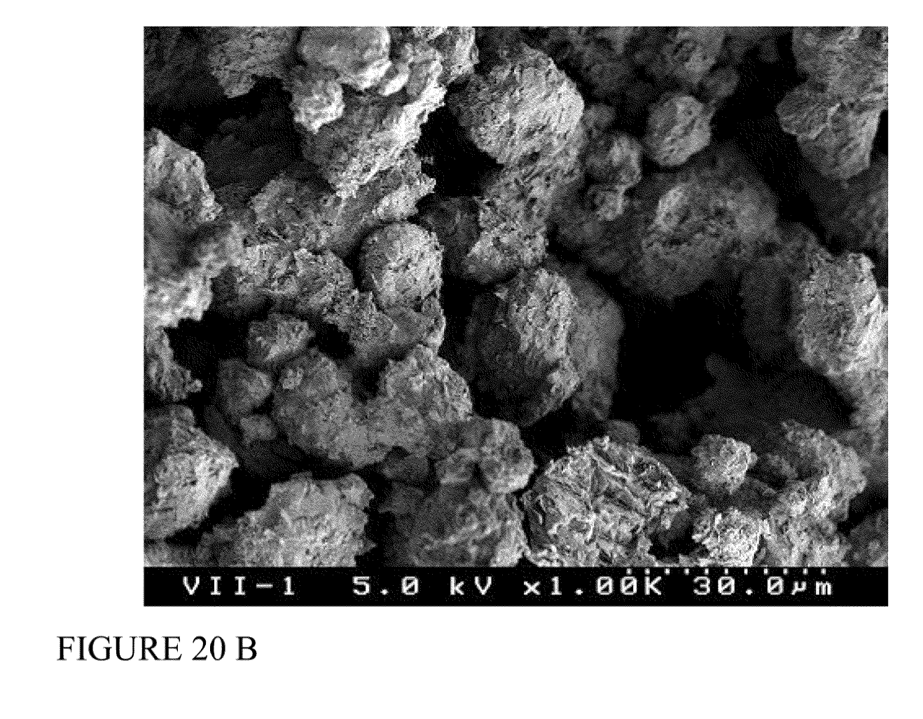

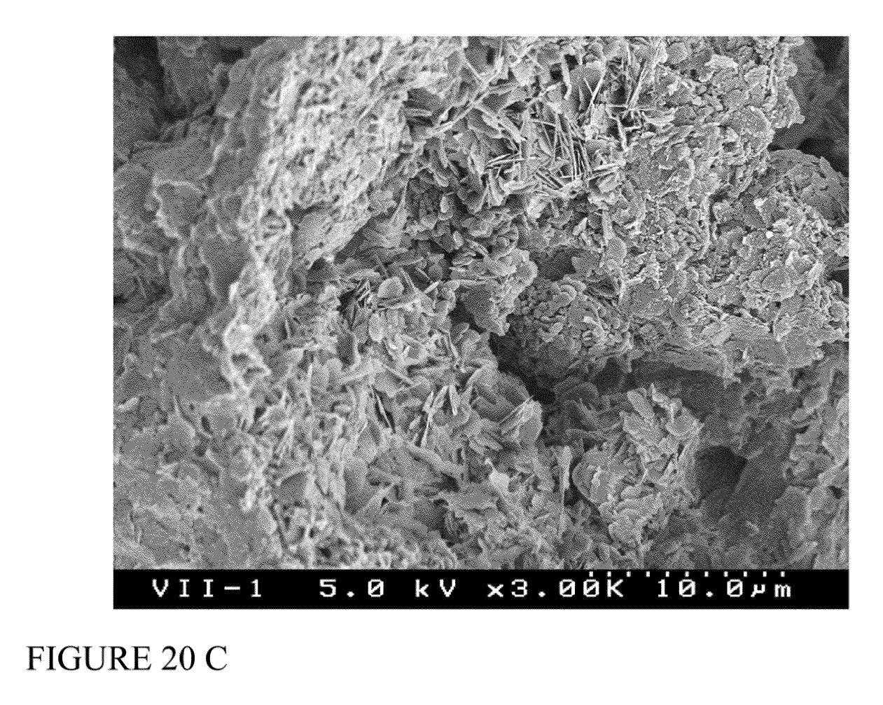

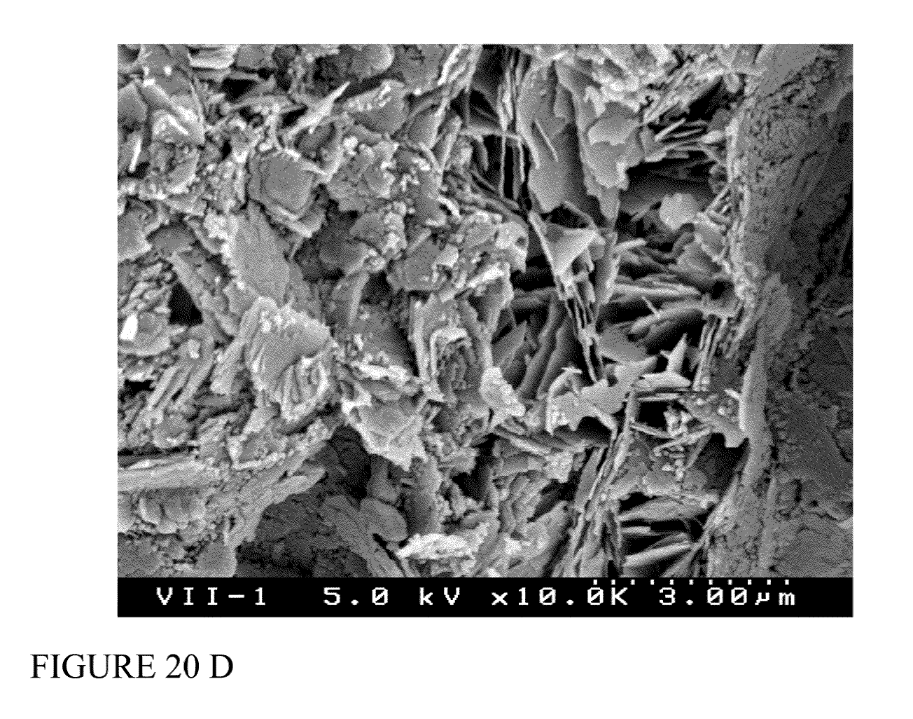

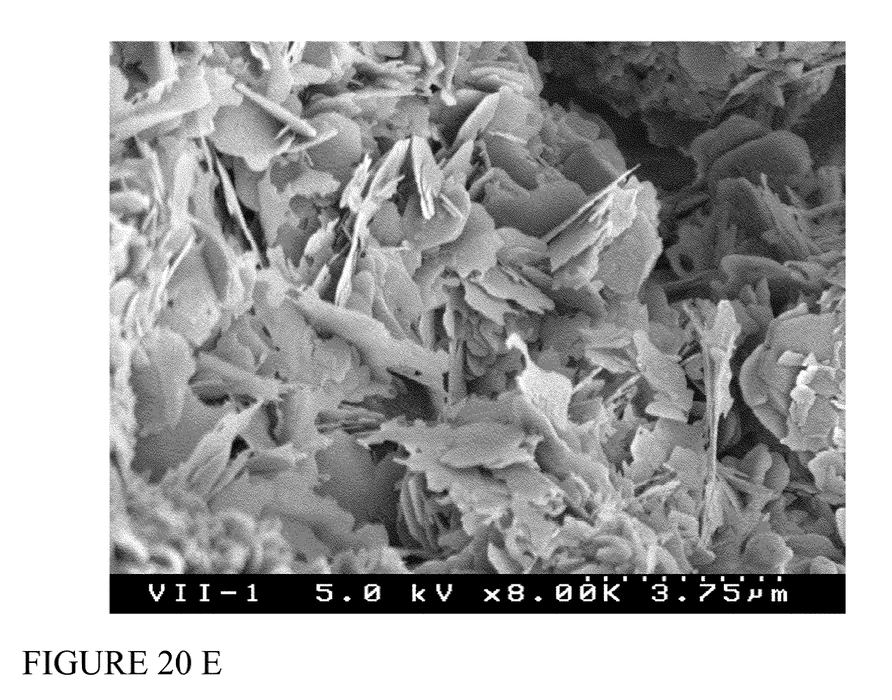

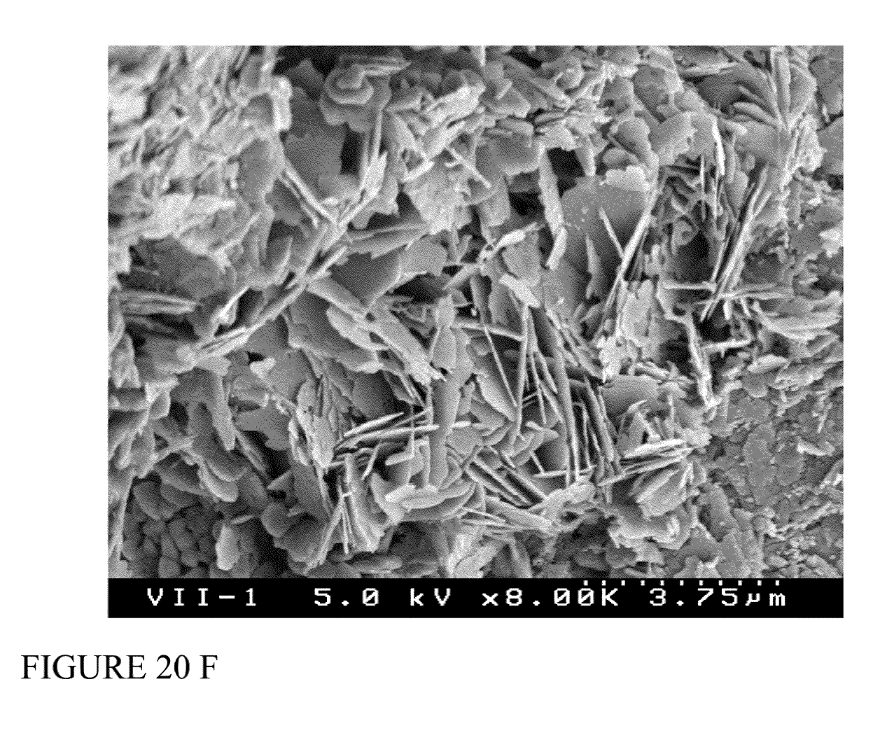

In accordance with an aspect of the present invention, Type II and Type IV AA nano-sheets (see Table II), both undoped and thermally stable (FIG. 9), can be used to fabricate porous AA ceramics. Porosities, pore volumes, pore size distributions, and BET surface areas of several different porous AA ceramics, sintered in a wide range of conditions, are summarized in Table IV and in FIGS. 17A-17F, 18, 19A-19F. Their mechanical properties are revealed in Table IV. Phase and chemical compositions of the porous AA ceramics are summarized in FIG. 16. Microstructures of the porous AA ceramics are shown in FIGS. 20A-20F, 21A-21E and 22A-22C. Based upon the analysis of all these data, several effects were observed. They are being discussed in the following sections.

TABLE IV
Properties of porous AA ceramics made from hydrothermally synthesized AA nano-sheets,
formed by extruding, and sintered in air at 1,000-1,600° C. (12-24 hrs).

| | | | BET Surface | | | |
|---|---|---|---|---|---|---|
| | | | Area (m²/g) | Total | Average | |
| Composition of | | | [micro-pore | Pore | (minimum) | |
| porous AA | Sintering | Porosity (%); [Median | surface area | Volume | Crush Strength | |
| ceramics* | Conditions | Pore Diameter (μm)] | (m²/g)] | (cm³/g)^{@} | (pounds) | |
| VII-1: Phase- | 1,000° C. (24 hrs) | 80.5% | 19.62 | 1.03/0.94 | 1.5 | (0.8) |
| pure AA | | [30 nm/150 nm/10 μm] | | | | |
| nanosheets + | 1,200° C. (24 hrs) | 80.4% | 14.63 | 1.03/0.97 | 2.2 | (1.6) |
| 59.0% W + | | [100 nm/10 μm] | | | | |
| 21.4% B + | 1,350° C. (24 hrs) | 79.3% | 9.64 | 0.96/0.95 | 4.9 | (4.5) |
| 1.2% N + | | [150 nm/10 μm] | | | | |
| 54.5% V | 1,400° C. (12 hrs) | 75.1% | 5.07 | 0.75/0.71 | 6.9 | (5.5) |
| | | [600 nm/10 μm] | | | | |
| | 1,400° C. (24 hrs) | 76.1% | 6.06 | 0.80/0.75 | 6.4 | (4.3) |
| | | [600 nm/10 μm] | | | | |
| | 1,450° C. (12 hrs) | 74.7% | 4.02 | 0.74/0.64 | 9.1 | (7.9) |
| | | [600 nm/10 μm] | | | | |
| | 1,600° C. (24 hrs) | 55.1% | 0.30 | 0.31/0.28 | 18.1 | (12.8) |
| | | [10 μm] | | | | |
| V-11: 3 μm AA | 1,400° C. (12 hrs) | 66.8% | — | 0.50 | 9.5 | (8.9) |
| equiaxed | | [—] | | | | |
| powders (as- | 1,400° C. (24 hrs) | 66.4% | 0.7 | 0.50 | 10.3 | (9.3) |
| synth.) + | | [3 μm/14 μm] | | | | |
| 25.7% W + | 1,450° C. (8 hrs) | 65.6% | 0.67 | 0.48 | 12.4 | (11.7) |
| 9.3% B + | | [3 μm/14 μm] | | | | |
| 0.5% N + | | | | | | |
| 23.7% V | | | | | | |
| Comparative | | | | | | |
| example, as- | | | | | | |
| disclosed in | | | | | | |
| [US 2007/ | | | | | | |
| 0280877 A1] | | | | | | |

*W denotes deionized H₂O, B denotes nano-sized boehmite, N denotes 70% HNO₃, V denotes petroleum jelly. All concentrations are in weight % calculated with respect to the total AA mass in the starting extruding paste.
^{@}First number as-measured by water absorption; second number was measured by mercury intrusion porosimetry.

Effects of the AA Nano-Sheets Vs. AA Equiaxed Crystals as Starting Materials for Porous AA Ceramics

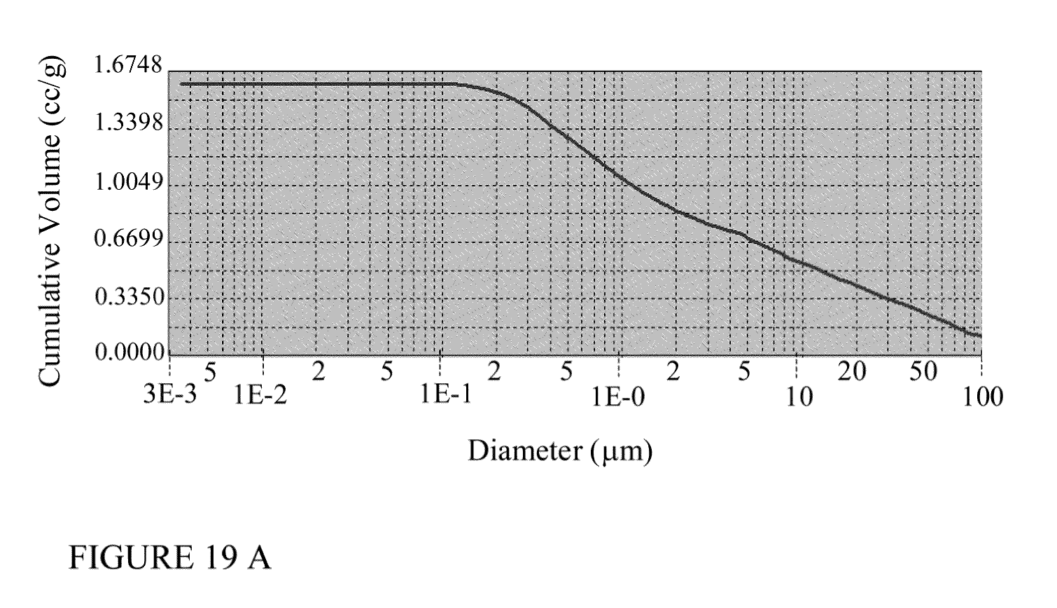

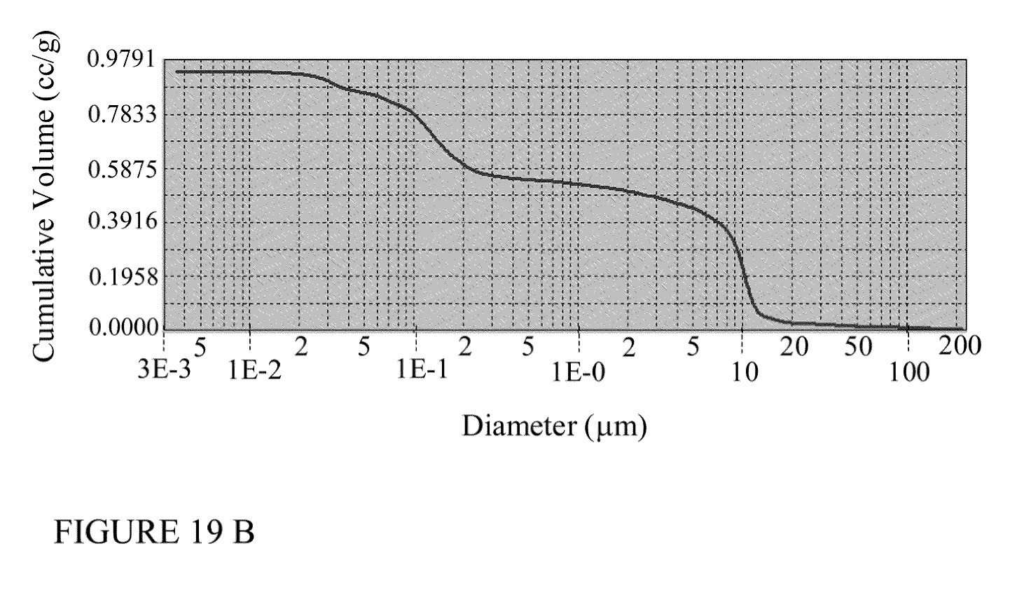

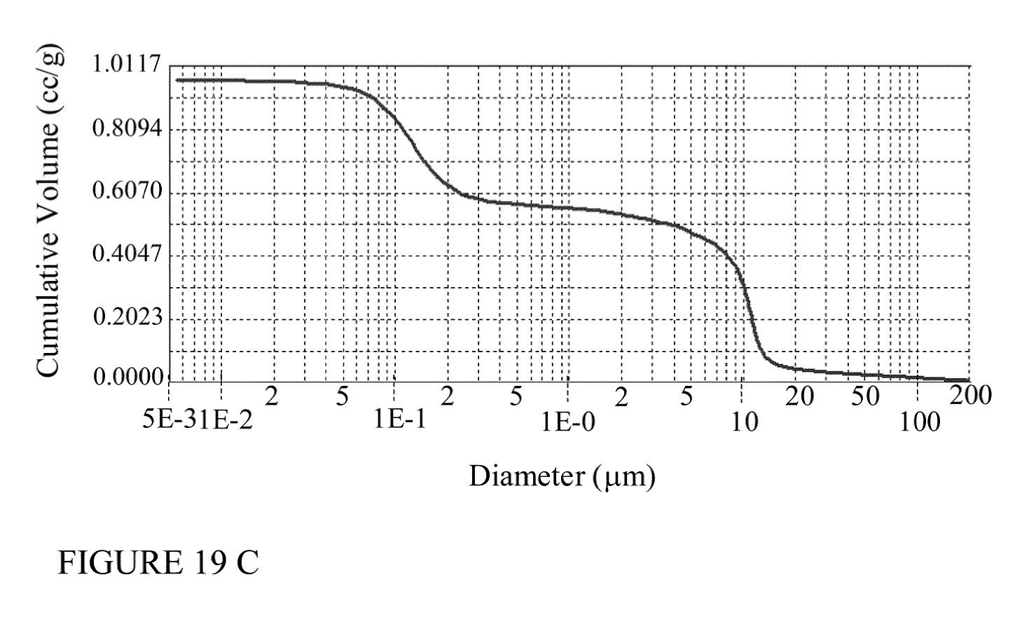

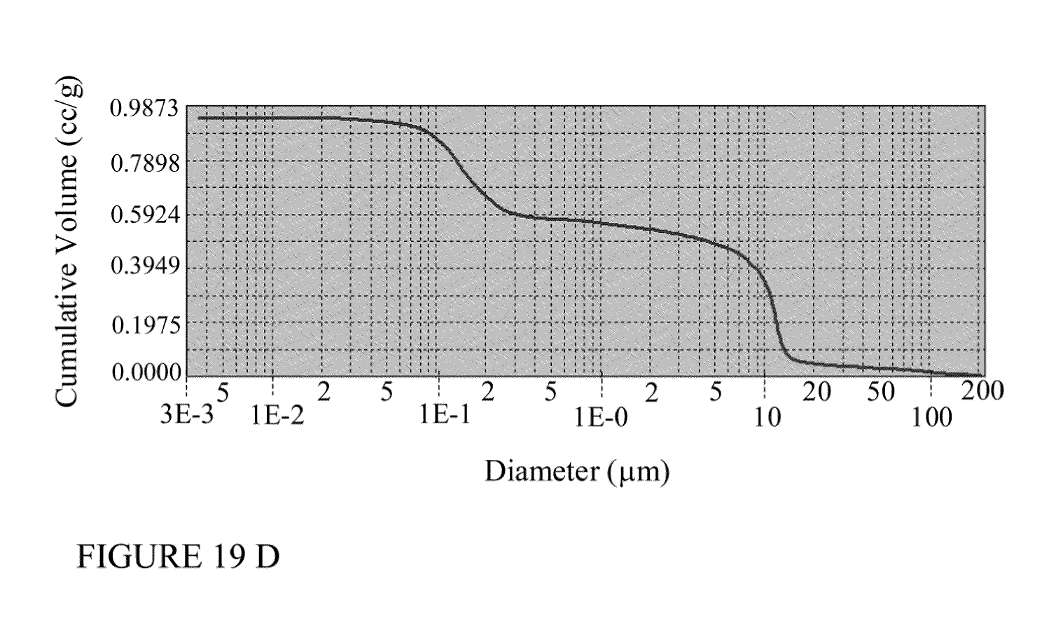

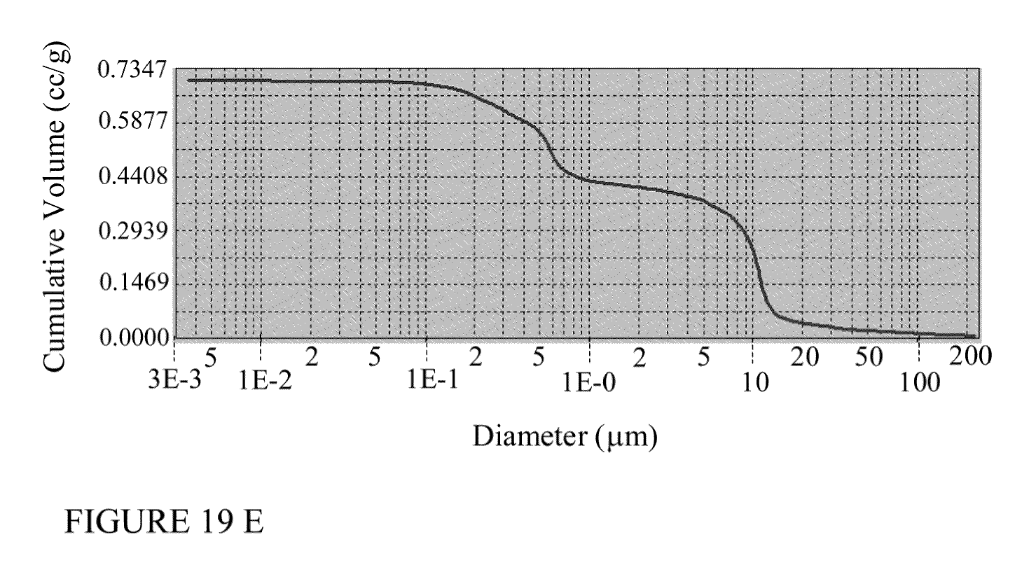

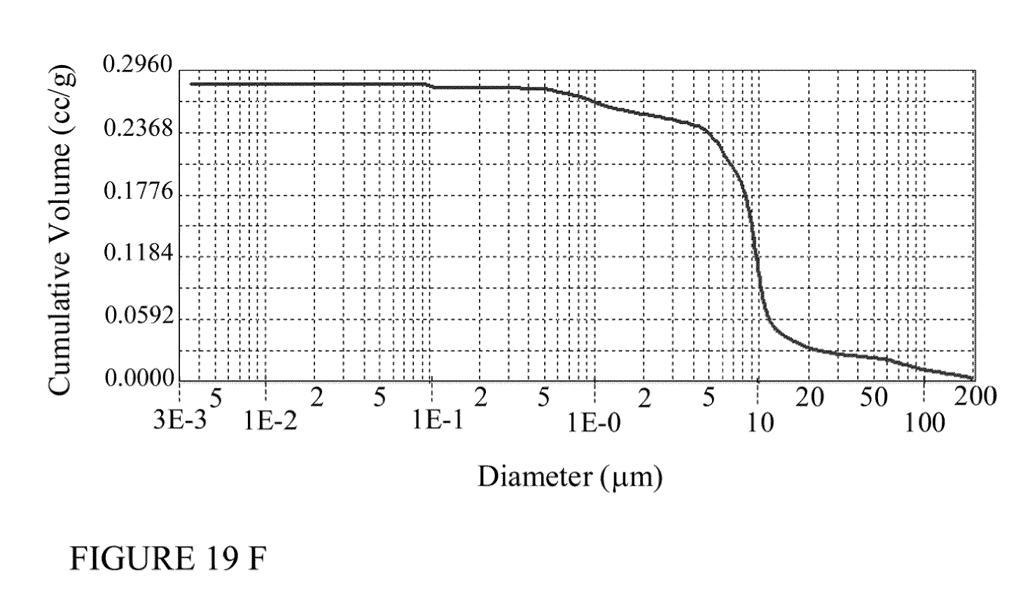

AA nano-sheets in accordance with an aspect of the present invention, in as-synthesized form, may be porous materials. SEM photographs of the AA nano-sheets are shown in FIG. 4A-4B. The AA nano-sheets are thin c-faceted sheets of the AA phase, which form large porous bodies. The way the AA nano-sheets are agglomerated, results in high porosity up to 90%, unique pore geometry and pore size distributions (FIG. 17A) as well as high pore volumes up to 1.5 cm³/g (FIG. 19A). Phase purity of the AA nano-sheets is confirmed by XRD, as shown in FIG. 16A. Most importantly, thermal stability of the AA nano-sheets is high, as already discussed (FIG. 9). In a key embodiment of the present invention, combination of unique morphology, phase purity, temperature stability, and agglomeration of the AA nano-sheets results in the formation of unique porous thermally stable, high surface area AA ceramics, synthesized hydrothermally.

The AA nano-sheets of the present invention were also extruded and sintered at temperatures in excess of 1000° C. in order to obtain porous AA ceramics. No other phases except for the AA (corundum) phase were observed in the sintered AA ceramics, as shown in FIG. 16. The porosities, pore volumes, and strength of the porous AA supports can be significantly and simultaneously increased by the use of AA nano-sheets instead of the AA equiaxed particles, as starting materials in making porous AA ceramics. As revealed in Table IV, porosities and pore volumes of porous AA ceramics made from the AA nano-sheets are in most cases in excess of 70% (up to 80.5%) and 0.70 cm³/g (up to 1.03 cm³/g), respectively, as compared to the porous AA ceramics made by the same method but from equiaxed AA powders (about 66% and 0.48-0.50 cm³/g, respectively). At the same time, the crush strength of the porous AA ceramics made from the AA nano-sheets is comparable or even higher than the crush strength of the porous AA ceramics made from equiaxed AA powders, taking into considerations effects of the porosity.

BET surface areas of the porous AA ceramics from the AA nano-sheets are in the range of 0.3-19.6 m²/g, which is much higher than the 0.7 m²/g for the ceramics made from equiaxed AA powders. Obtaining such high surface area of the sintered AA ceramics is possible due to the high thermal stability of the AA nano-sheets.

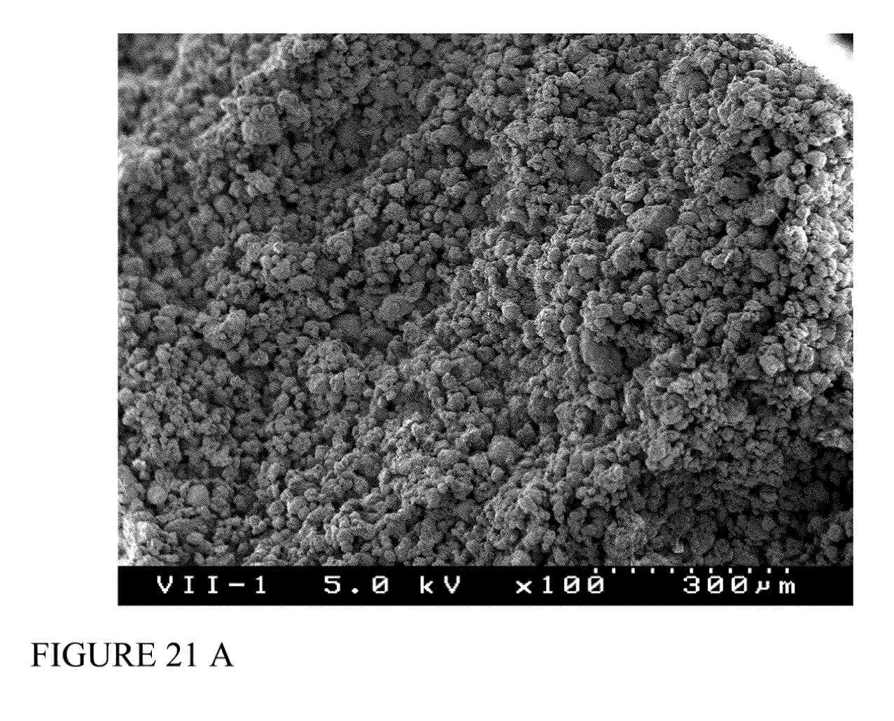

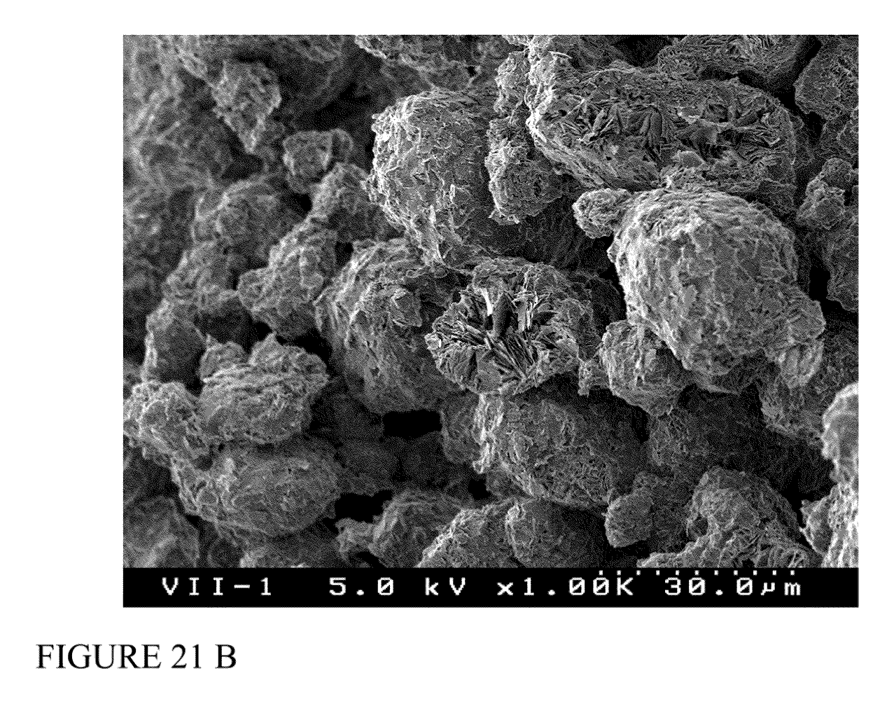

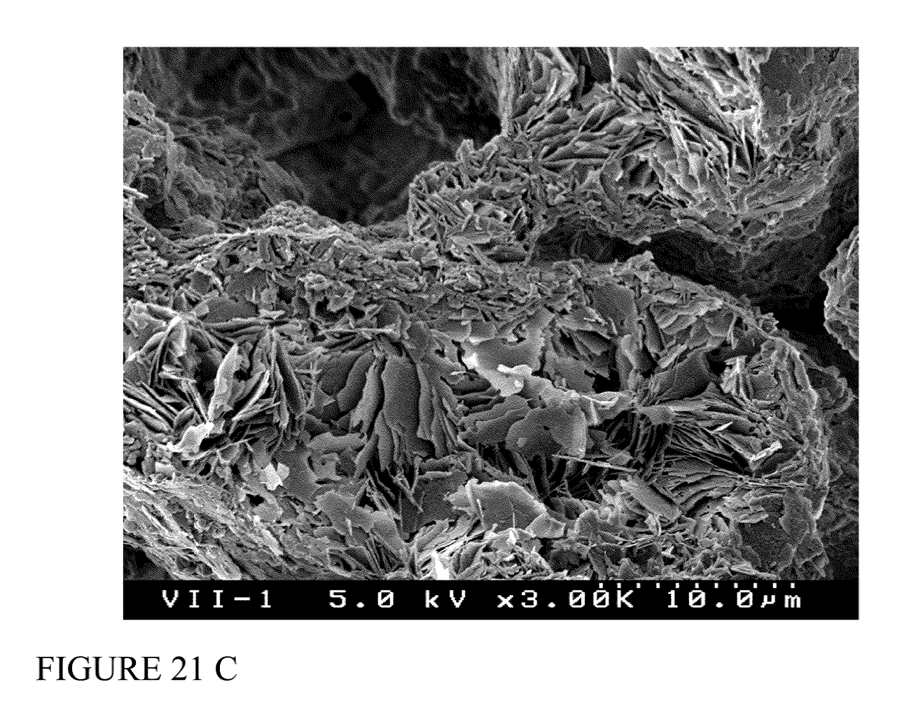

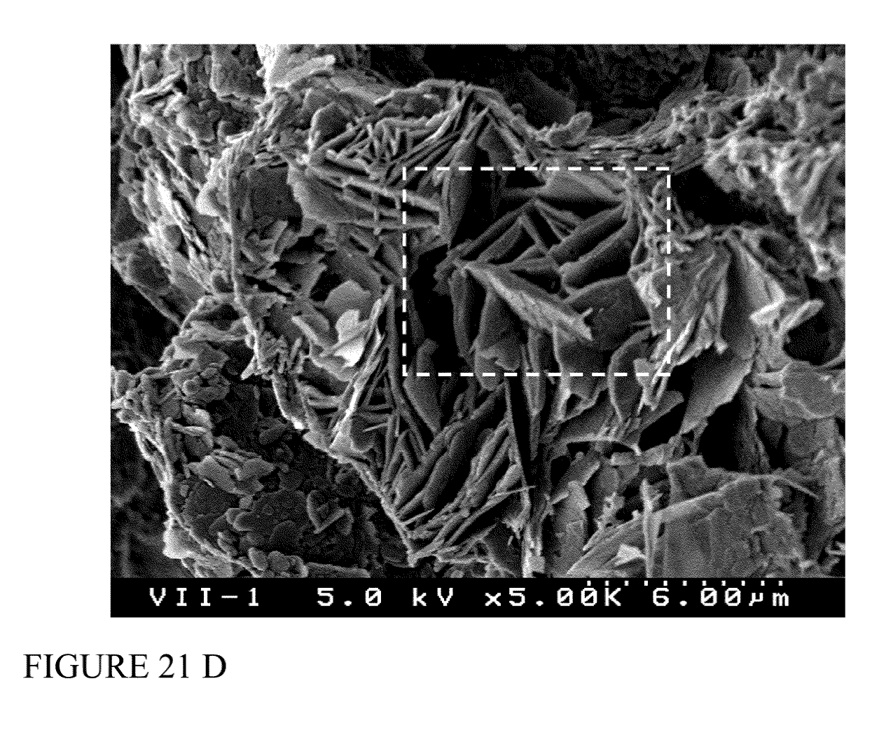

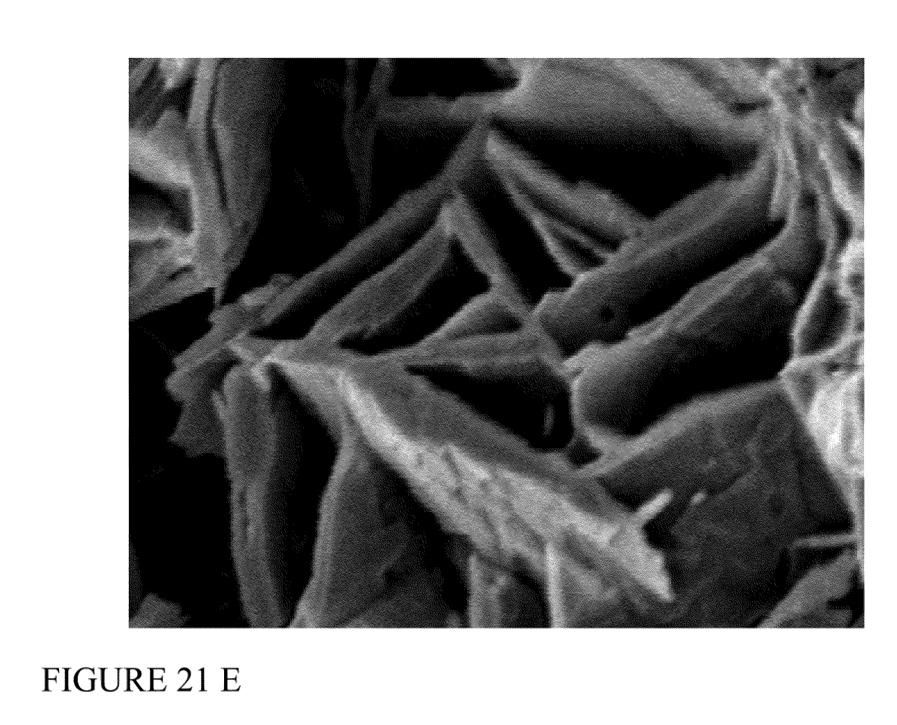

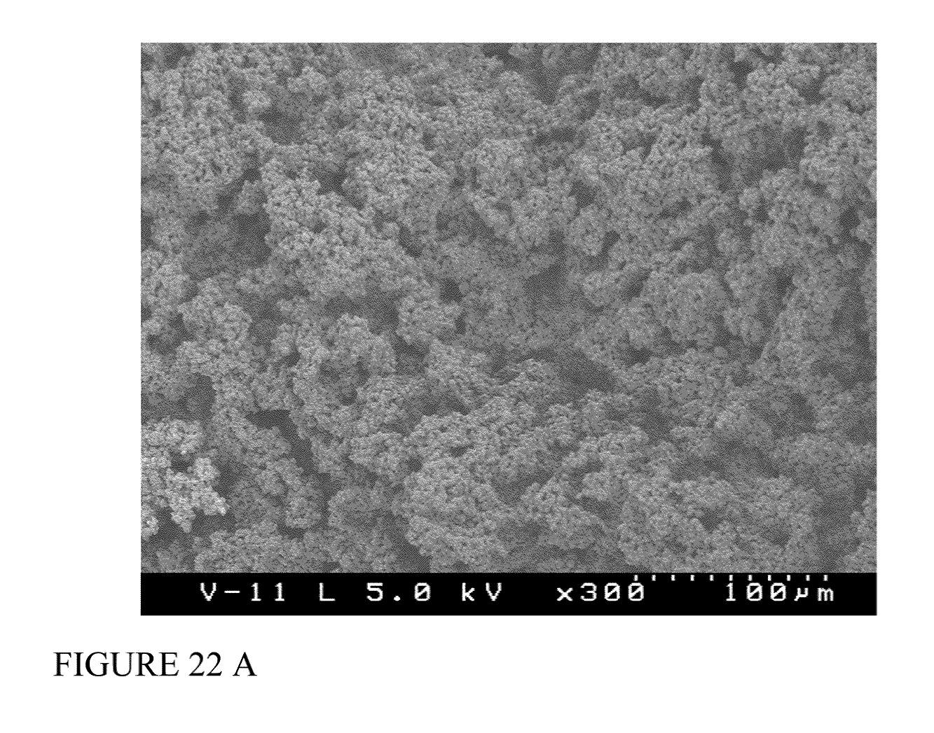

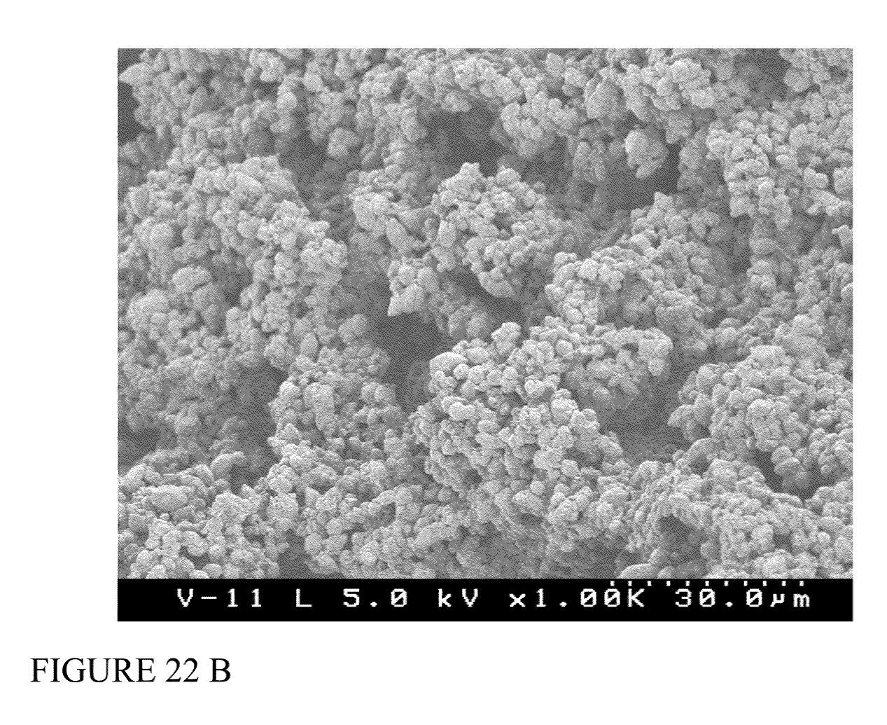

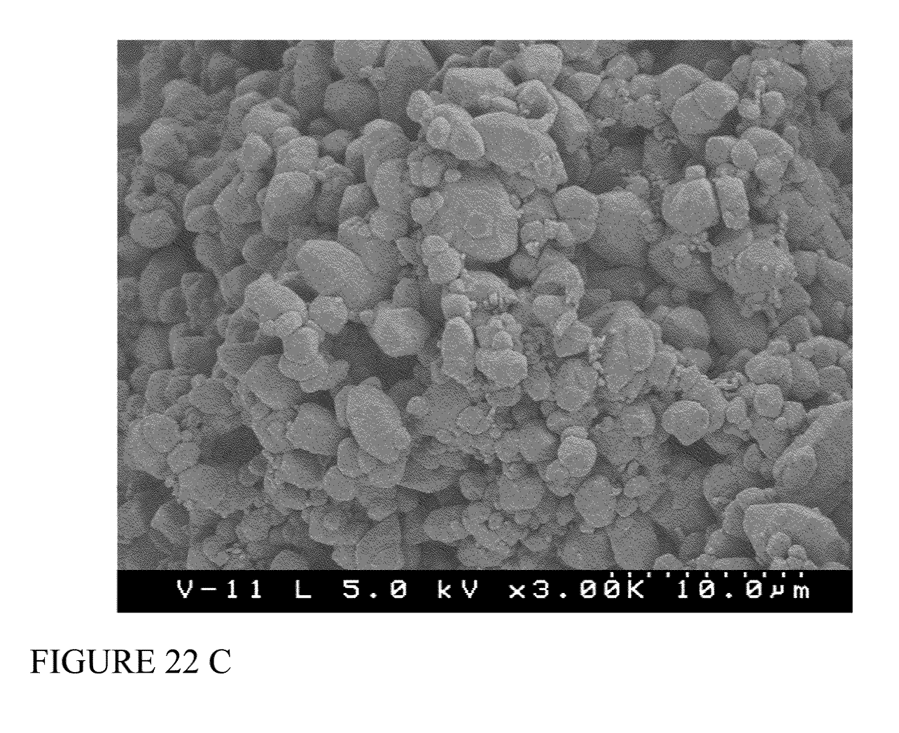

The SEM analysis confirmed the uniformity of the microstructures of the porous AA ceramics; i.e. very uniform grain size and multi-modal pore size distributions in all cases (see FIGS. 20A-20F, 21A-21E, 22A-22C). The SEM revealed also that the microstructure of the ceramics made from the AA nano-sheets consists of platy grains in almost all cases. In porous AA ceramics sintered at 1,000-1,400° C., the AA nano-sheets are clearly visible, and they do not appear to significantly change during sintering (FIGS. 20A-20F). The changes, which occurred in this temperature range, were mostly thickening of the connections between individual nano-sheets, which resulted in lowering of the surface area, reduction of pore volume and porosity, and strength increase. In the porous AA ceramics sintered at 1,450° C. (FIGS. 21A-21E), the AA nano-sheets are still visible, but their thickness significantly increased (FIG. 21E). The sintering effects, AA nano-sheets thickening effects result in unique microstructures and pore size distributions. Thus the microstructures of the porous AA ceramics can be controlled over a wide range by the sintering conditions of the AA nano-sheets. Microstructure of AA ceramics synthesized from equiaxed AA powders is shown for comparison in FIGS. 22A-22C.

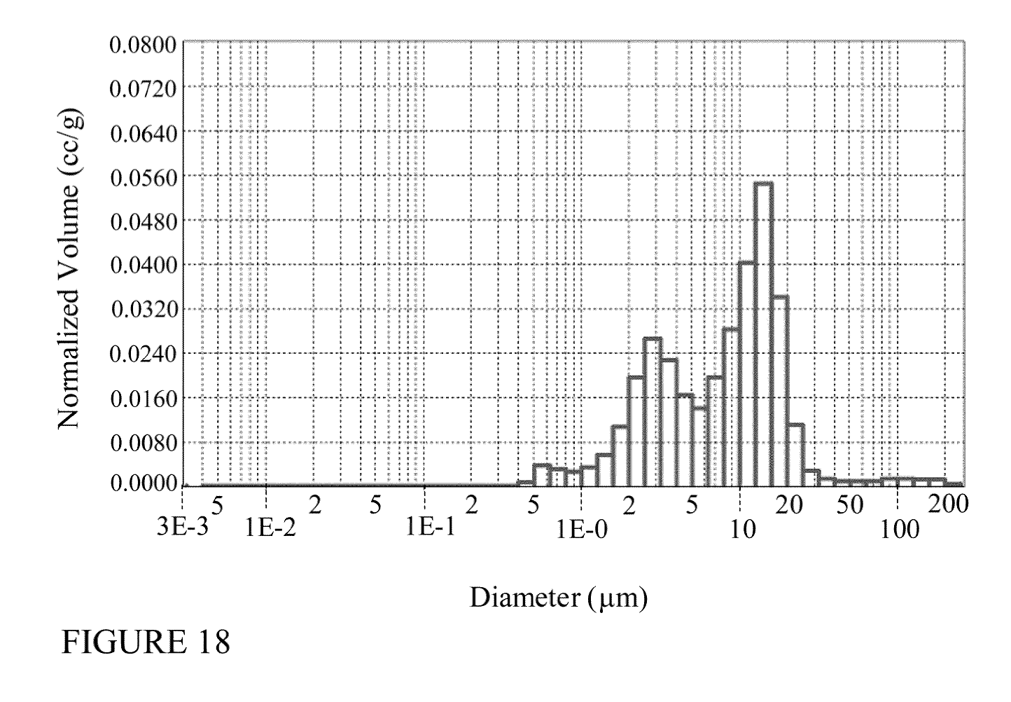

As shown in FIGS. 17A-17F, the pore size distributions are multi-modal in the case of the ceramics made from the AA nano-sheets, with modes around 30 nm, 100-600 nm, and 10 μm. In most cases every pore size had a large pore volume of up to 0.50 cm³/g, as shown in FIGS. 19A-19F. Conversely, pore size distributions in the porous AA ceramics made from equiaxed AA powders, are bi-modal, with modes located around 3 μm and 14 μm (FIG. 18). Clearly, the use of various AA nano-sheets allowed controlling the pore size distributions in a very wide range. Moreover, use of AA nano-sheets resulted in unique pore geometries in the sintered AA ceramics (FIGS. 20A-20F and 21A-21E), which may be utilized in various applications, such as catalysis etc. Presence of stable micropores and mesopores in the porous AA ceramics from the AA nano-sheets could be used in a variety of applications, such as catalysis, filtration, etc.

Purity of the sintered AA ceramics was checked by XPS. No major impurities except for silicon (Si) derived from the AA nano-sheets were observed. In the hydrothermal synthesis of the AA nano-sheets, the SiO₂ was used as morphology modifying agent and was adsorbed on the surface of the AA nano-sheets. Traces of sodium and titanium, which probably diffused to the surface during sintering, were also observed.

In an example embodiment in accordance an aspect of the present invention, combination of the properties described above such as high porosity (75-80%), pore volume (0.75-1.0 cm³/g), high BET surface area (up to 20 m²/g) and high thermal stability, in addition to high phase purity (100% of the AA phase in all cases) and high chemical purity, is favorable for a variety of applications of the porous AA ceramics made from the AA nano-sheets. It is particularly favorable for applications as catalytic supports, filters, thermal insulation, etc.

Effects of the Sintering Conditions

Increasing the sintering time and/or increasing the sintering temperature in the investigated 1,000-1,600° C. (12-24 hrs) range, results in significant increase of strength accompanied by reductions of porosity, pore volume, and specific surface area. Pore size distribution changes are not dramatic, and are more strongly pronounced for the micropores and mesopores (FIGS. 17A-17F). Thus the mechanical properties and microstructural features of the porous AA ceramics can be controlled in a wide range by sintering conditions, which can be used in a variety of applications.

Other Porous AA Ceramics from Hydrothermally Synthesized AA Nano-Sheets

In addition to using various types of AA nano-sheets, other compositions can be used as well. For example, combination of hydrothermally synthesized boehmite with AA nano-sheets (Type IV AA nano-sheets) or AA nano-sheets/equiaxed AA mixtures, AA nano-sheets mixtures with various sizes of equiaxed AA crystallites, sintering additives, such as Cs salts, TiO₂, ZrO₂, SiO₂, Mg Silicate, CaSilicate, etc. can be used in order to enhance formation of porous AA ceramics, which can be used for a variety of applications. Also, doped AA nano-sheets with various dopants can be used to fabricate porous AA ceramics.

In order to modify pore size distributions, the AA nano-sheets can be compacted under pressure and sintered, which could eliminate the large pores between round agglomerates of the AA nano-sheets (FIGS. 20A-20B, 21A-21B). Such processing, instead of extrusion, could reduce the total porosity but increase the strength and produce very fine, uniformly distributed porosity.

### EXAMPLES

### Example 1

### Hydrothermal Synthesis of Type I AA Nano-Sheets Using 1 wt % SiO₂ Morphology Modifier

Hydrothermal synthesis of about 200 g of AA nano-sheets was performed as follows: One 1 L titanium container was cleaned and 320 g of DI water was added to it. Then, 0.93 g of 96.6% H₂SO₄ was added to the container and its content was stirred. Subsequently, 203 g of boehmite powder Precursor Type A was added to the containers and stirred to obtain uniform slurry. 20 g (i.e. 10 wt %) of commercial corundum seeds, with particle size of 1 μm, were added to the container and the slurry was vigorously stirred again for about 3 minutes. Then, 4.8 g of nano-sized colloidal silica aqueous dispersion (40% SiO₂, AS-40, Ludox) as morphology modifier was added to the container and its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 1,500-1,700 psi. During heating, the pressure was relieved via the attached high-temperature valve, water-cooled heat exchanger and pressure relief valve set at 1,500 psi cracking pressure. The autoclave was vented after completing the heating cycle, at the temperature of about 400° C. After unloading, the powders were inspected by XRD and SEM and it was found that they consisted of randomly agglomerated 100% phase-pure AA nano-sheets, with diameters, thickness, and aspect ratios of 0.5-3.0 μm, 30-75 nm, and 7-100, respectively. No equiaxed crystals were observed. Morphology of the as-synthesized AA nano-sheets is shown in FIG. 3B, XRD pattern in FIG. 5.

### Example 2

### Hydrothermal Synthesis of Type II AA Nano-Sheets Using 3-5 wt % SiO₂ Morphology Modifier

Hydrothermal synthesis of about 200 g of AA nano-sheets was performed as follows: One 1 L titanium container was cleaned and 320 g of DI water was added to it. Then, 0.93 g of 96.6% H₂SO₄ was added to the container and its content was stirred. Subsequently, 203 g of boehmite powder Precursor Type A was added to the containers and stirred to obtain uniform slurry. 20 g (i.e. 10 wt %) of commercial corundum seeds, with particle size of 1 μm, were added to the container and the slurry was vigorously stirred again for about 3 minutes. Then, 14.3-23.8 g of nano-sized colloidal silica aqueous dispersion (40% SiO₂, AS-40, Ludox) as morphology modifier was added to the container and its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 1,500-1,700 psi. During heating, the pressure was relieved via the attached high-temperature valve, water-cooled heat exchanger and pressure relief valve set at 1,500 psi cracking pressure. The autoclave was vented after completing the heating cycle, at the temperature of about 400° C. After unloading, the powders were inspected by XRD and SEM and it was found that they consisted of randomly agglomerated 100% phase-pure AA nano-sheets, with diameters, thickness, and aspect ratios of 0.5-2.0 μm, 10-35 nm, and 15-200, respectively. No equiaxed crystals were observed. Morphology of the as-synthesized AA nano-sheets is shown in FIG. 3C-3D, and the XRD pattern is shown in FIG. 5. BET surface area of the as-synthesized AA nano-sheets was 19.1 m²/g. After calcination in air at 1,000° C. for 12 hours, the BET surface area was 21.4 m²/g, confirming high thermal stability of the undoped AA nano-sheets. XPS analysis on the surface and in the bulk revealed the presence of silica-derived Si and lack of any other impurities, except for traces of sulfur on the surface.

### Example 3

### Hydrothermal Synthesis of Type III AA Nano-Sheets Using 5 wt % SiO₂ Morphology Modifier

Hydrothermal synthesis of about 200 g of AA nano-sheets was performed as follows: One 1 L titanium container was cleaned and 240 g of DI water was added to it. Then, 0.93 g of 96.6% H₂SO₄ was added to the container and its content was stirred. Subsequently, 203 g of boehmite powder Precursor Type A was added to the containers and stirred to obtain uniform slurry. 10 g (i.e. 5 wt %) of commercial nano-sized corundum seeds were added to the container and the slurry was vigorously stirred again for about 3 minutes. Then, 23.8 g of nano-sized colloidal silica aqueous dispersion (40% SiO₂, AS-40, Ludox) as morphology modifier was added to the container and its content was stirred again for 3 minutes. The 1 L container was then placed in a special 12″ diameter Titanium container, which was covered with a lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 430° C. with a heating rate of 9.0° C./hr, followed by holding at 430° C. for 10 days, with temperature stability of a few ° C., with pressure about 1,500 psi. During heating, the pressure was relieved via the attached high-temperature valve, water-cooled heat exchanger and pressure relief valve set at 1,500 psi cracking pressure. The autoclave was vented after completing the heating cycle, at the temperature of about 400° C. After unloading, the powders were inspected by XRD and SEM and it was found that they consisted of randomly agglomerated AA nano-sheets, with diameters, thickness, and aspect ratios of 0.5-2.0 μm, 10-20 nm, and 50-200, respectively, mixed with boehmite. Measured BET surface area was 31 m²/g. No equiaxed crystals were observed.

### Example 4

### Hydrothermal Synthesis of Type IV AA Nano-Sheets Using 10 wt % SiO₂ Morphology Modifier

Hydrothermal synthesis of about 200 g of AA nano-sheets was performed as follows: One 1 L titanium container was cleaned and 240 g of DI water was added to it. Then, 0.93 g of 96.6% H₂SO₄ was added to the container and its content was stirred. Subsequently, 203 g of boehmite powder Precursor Type A was added to the containers and stirred to obtain uniform slurry. 20 g (i.e. 10 wt %) of commercial corundum seeds, with particle size of 1 μm, were added to the container and the slurry was vigorously stirred again for about 3 minutes. Then, 47.6 g of nano-sized colloidal silica aqueous dispersion (40% SiO₂, AS-40, Ludox) as morphology modifier was added to the container and its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 1,500-1,700 psi. During heating, the pressure was relieved via the attached high-temperature valve, water-cooled heat exchanger and pressure relief valve set at 1,500 psi cracking pressure. The autoclave was vented after completing the heating cycle, at the temperature of about 400° C. After unloading, the powders were inspected by XRD and SEM and it was found that they consisted of randomly agglomerated AA nano-sheets, with diameters, thickness, and aspect ratios of 0.5-2.0 μm, 10 nm, and 50-200, respectively, mixed with nano-sized boehmite particles. Morphology of the as-synthesized AA nano-sheets is shown in FIG. 3E, XRD pattern in FIG. 5. BET surface area of the as-synthesized AAnano-sheets was 37-43 m²/g. After calcination in air at 1,000° C. for 12 hours, the BET surface area was ˜41 m²/g, confirming high thermal stability of the undoped AA nano-sheets.

### Example 5

### Hydrothermal Synthesis of AA Nano-Fibers Using 10 wt % H₃BO₃ Morphology Modifier

Hydrothermal synthesis of about 200 g of AA nano-fibers was performed as follows: One 1 L titanium container was cleaned and 240 g of DI water was added to it. Then, 0.93 g of 96.6% H₂SO₄ was added to the container and its content was stirred. Subsequently, 203 g of boehmite powder Precursor Type A was added to the containers and stirred to obtain uniform slurry. 10 g (i.e. 5 wt %) of commercial nano-sized corundum seeds, were added to the container and the slurry was vigorously stirred again for about 3 minutes. Then, 19.0 g of boric acid (H₃BO₃, ACS grade, 99.5%+) dissolved in 230 mL of hot DI water was added to the container as morphology modifier and its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 1,500-1,700 psi. During heating, the pressure was relieved via the attached high-temperature valve, water-cooled heat exchanger and pressure relief valve set at 1,500 psi cracking pressure. The autoclave was vented after completing the heating cycle, at the temperature of about 400° C. After unloading, the powders were inspected by XRD and SEM and it was found that they consisted of preferentially agglomerated AA nano-fibers, with lengths, diameters, and aspect ratios of 0.2-1.0 μm, 35-100 nm, and 2-10, respectively. Morphology of the as-synthesized AA nano-fibers is shown in FIGS. 10A-10C.

With regard to examples 1 through 5, the instances of AA nano-sheets and nano-fibers presented in Examples 1-5 serve only to demonstrate the idea and methodology of using morphology modifiers during the hydrothermal synthesis of AA nano-materials. Other morphology modifiers, selected from various elements, ions, organic or inorganic compounds, which can adsorb on the AA crystal facets, or their mixtures, within a wide range of concentrations could be applied using the same methodology as described in Examples 1-5. Nano-materials prepared with such morphology modifiers could exhibit a variety of morphologies, aspect ratios, diameters, aggregation levels, etc.

### Example 6

### Hydrothermal Synthesis of Zr-Doped AA Nano-Sheets

Hydrothermal synthesis of about 200 g of zirconium-doped AA nano-sheets was performed as follows: One 1 L titanium container was cleaned and 387 g of DI water was added to it. Then, 1.06 g of 96.6% H₂SO₄ was added to the container and its content was stirred. Then, 6.93 g of ZrOCl₂.8H₂O as a source of the Zr dopant was added and stirred until dissolved. Subsequently, 231 g of boehmite powder Precursor Type A was added to the containers and stirred to obtain uniform slurry. 23.1 g (i.e. 10 wt %) of commercial corundum seeds, with particle size of 1 μm, were added to the container and the slurry was vigorously stirred again for about 3 minutes. Then, 28.9 g of nano-sized colloidal silica aqueous dispersion (40% SiO₂, AS-40, Ludox) as morphology modifier was added to the container and its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 2,000 psi. During heating, the pressure was relieved via the attached high-temperature valve, water-cooled heat exchanger and pressure relief valve set at 2,000 psi cracking pressure. The autoclave was vented after completing the heating cycle, at the temperature of about 400° C. After unloading, the powders were inspected by XRD (FIG. 12A) and SEM and it was found that they consisted of randomly agglomerated 100% phase-pure AA nano-sheets, with BET surface area of 28.4 m²/g. After calcination in air at 1,200° C. for 24 hours, the BET surface area was 21.2 m²/g, confirming rather high thermal stability of the Zr-doped AA nano-sheets. XPS analysis on the surface and in the bulk revealed the presence of 0.40 atom % Zr. Concentration of the dopant (Zr) was the same both on the surface and in the bulk of the nano-sheets (FIGS. 8C and 8D), strongly indicating lattice incorporation of the dopant.

### Example 7

### Hydrothermal Synthesis of Cr-Doped AA Nano-Sheets

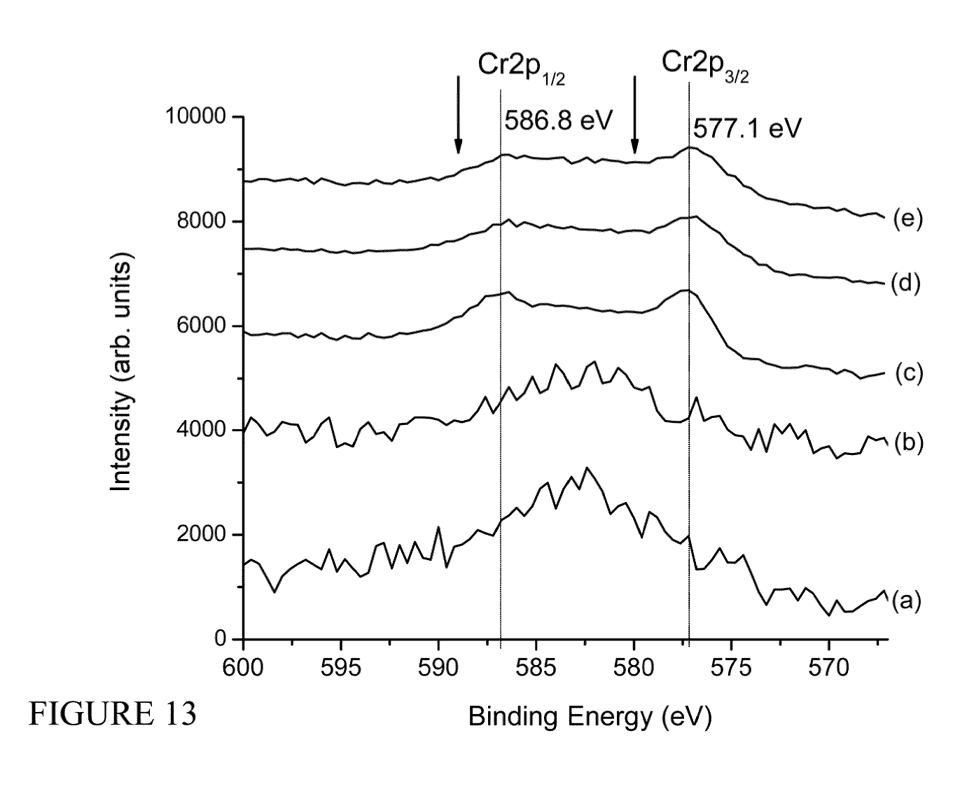

Hydrothermal synthesis of about 200 g of chromium (3+)-doped AA nano-sheets was performed as follows: One 1 L titanium container was cleaned and 387 g of DI water was added to it. Then, 1.06 g of 96.6% H₂SO₄ was added to the container and its content was stirred. Then, 6.94 g of CrCl₃.6H₂O as a source of the Cr(3+) dopant was added and stirred until dissolved: Subsequently, 231 g of boehmite powder Precursor Type A was added to the containers and stirred to obtain uniform slurry. 23.1 g (i.e. 10 wt %) of commercial corundum seeds, with particle size of 1 μm, were added to the container and the slurry was vigorously stirred again for about 3 minutes. Then, 28.9 g of nano-sized colloidal silica aqueous dispersion (40% SiO₂, AS-40, Ludox) as morphology modifier was added to the container and its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 2,000 psi. During heating, the pressure was relieved via the attached high-temperature valve, water-cooled heat exchanger and pressure relief valve set at 2,000 psi cracking pressure. The autoclave was vented after completing the heating cycle, at the temperature of about 400° C. After unloading, the powders were inspected by XRD (FIG. 12A) and SEM and it was found that they consisted of randomly agglomerated 100% phase-pure AA nano-sheets, with BET surface area of 23.1 m²/g. After calcination in air at 1,200° C. for 24 hours, the BET surface area was 19.3 m²/g, confirming rather high thermal stability of the Cr-doped AA nano-sheets. Macroscopic appearance of the nano-sheets was as pink powder. XPS analysis on the surface and in the bulk revealed the presence of 0.27 atom % Cr. Concentration of the dopant (Cr) was the same both on the surface and in the bulk of the nano-sheets (FIG. 13), strongly indicating lattice incorporation of the dopant. Position of the Cr2p bands is characteristic for Cr(3+) in oxide form; no evidences of Cr(6+) were found (FIG. 13).

### Example 8

### Hydrothermal Synthesis of Ti-Doped AA Nano-Sheets

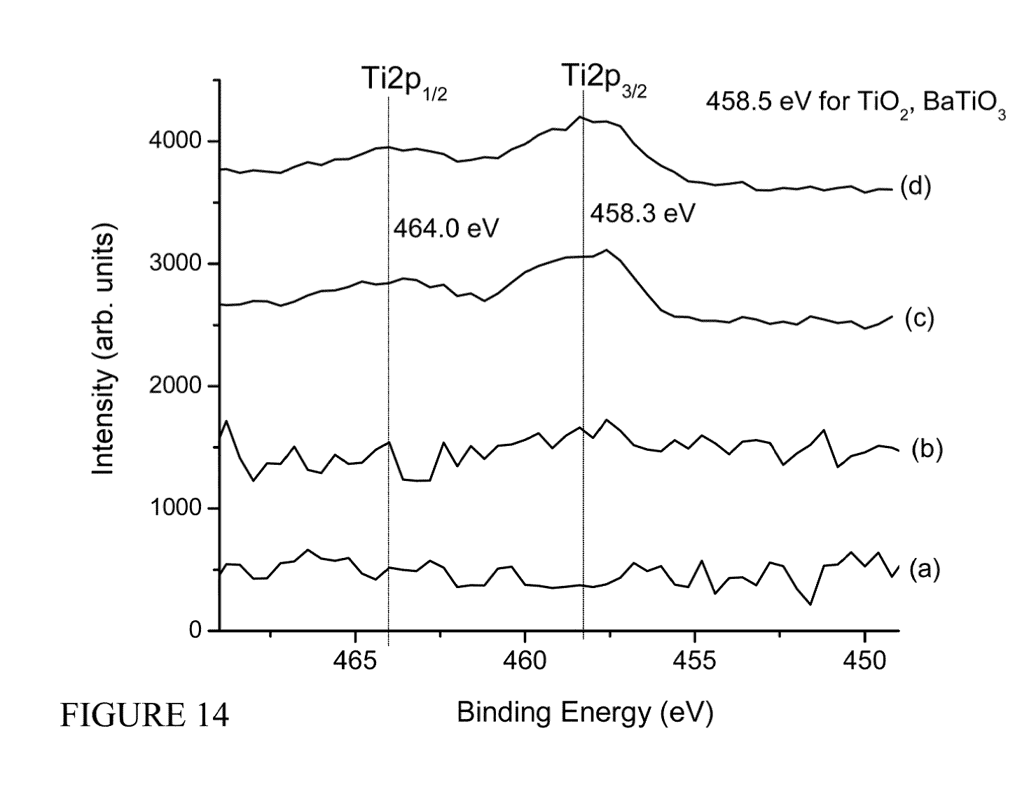

Hydrothermal synthesis of about 200 g of titanium-doped AA nano-sheets was performed as follows: One 1 L titanium container was cleaned and 387 g of DI water was added to it. Then, 1.06 g of 96.6% H₂SO₄ was added to the container and its content was stirred. Then, 34.65 g of 20% Ti₂(SO₄)₃ (aq) as a source of the Ti dopant was added and stirred. Subsequently, 231 g of boehmite powder Precursor Type A was added to the containers and stirred to obtain uniform slurry. 23.1 g (i.e. 10 wt %) of commercial corundum seeds, with particle size of 1 μm, were added to the container and the slurry was vigorously stirred again for about 3 minutes. Then, 28.9 g of nano-sized colloidal silica aqueous dispersion (40% SiO₂, AS-40, Ludox) as morphology modifier was added to the container and, its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 2,000 psi. During heating, the pressure was relieved via the attached high-temperature valve, water-cooled heat exchanger and pressure relief valve set at 2,000 psi cracking pressure. The autoclave was vented after completing the heating cycle, at the temperature of about 400° C. After unloading, the powders Were inspected by XRD (FIG. 12B) and SEM and it was found that they consisted of randomly agglomerated AA nano-sheets mixed with a small amount of boehmite, with BET surface area of 26.7 m²/g. XPS analysis on the surface and in the bulk revealed the presence of 0.34 atom % Ti. Concentration of the dopant (Ti) was the same both on the surface and in the bulk of the nano-sheets (FIG. 14), strongly indicating lattice incorporation of the dopant. Position of the Ti2p bands is characteristic for Ti(4+) in oxide form.

### Example 9

### Hydrothermal Synthesis of Mg-Doped AA Nano-Sheets

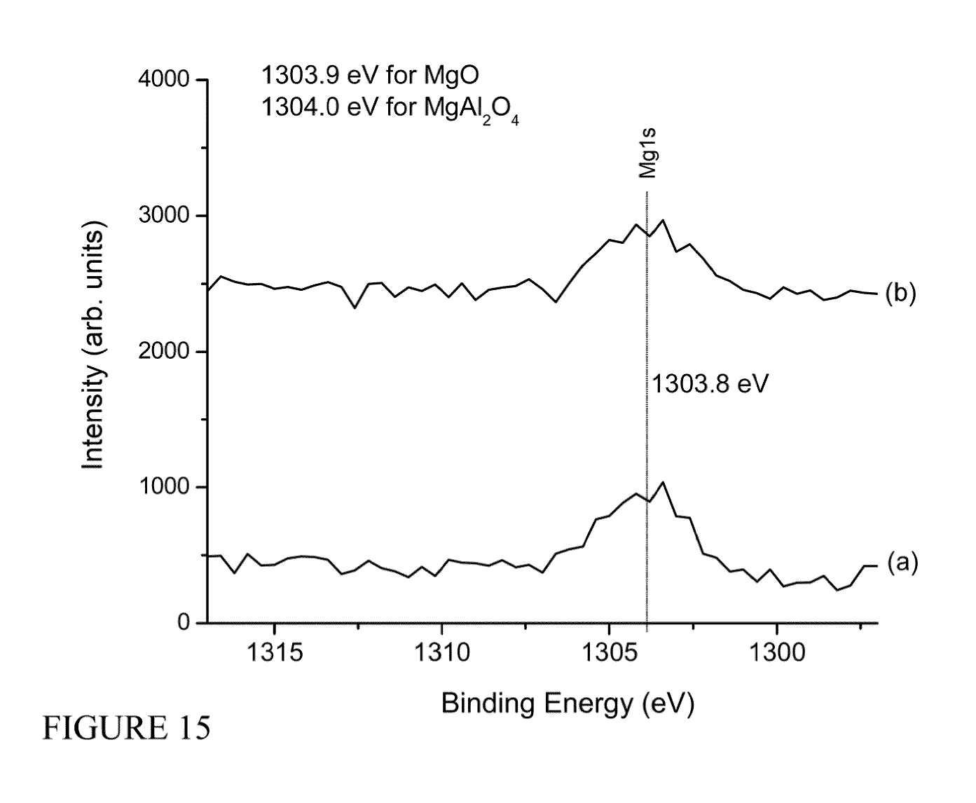

Hydrothermal synthesis of about 200 g of magnesium-doped AA nano-sheets was performed as follows: One 1 L titanium container was cleaned and 387 g of DI water was added to it. Then, 1.06 g of 96.6% H₂SO₄ was added to the container and its content was stirred. Then, 6.96 g of MgCl₂.6H₂O as a source of the Mg dopant was added and stirred until dissolved. Subsequently, 231 g of boehmite powder Precursor Type A was added to the containers and stirred to obtain uniform slurry. 23.1 g (i.e. 10 wt %) of commercial corundum seeds, with particle size of 1 were added to the container and the slurry was vigorously stirred again for about 3 minutes. Then, 28.9 g of nano-sized colloidal silica aqueous dispersion (40% SiO₂, AS-40, Ludox) as morphology modifier was added to the container and its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 2,000 psi. During heating, the pressure was relieved via the attached high-temperature valve, water-cooled heat exchanger and pressure relief valve set at 2,000 psi cracking pressure. The autoclave was vented after completing the heating cycle, at the temperature of about 400° C. After unloading, the powders were inspected by XRD (FIG. 12A) and SEM (FIG. 11D) and it was found that they consisted of randomly agglomerated 100% phase-pure AA nano-sheets, with BET surface area of 15.7 m²/g. XPS analysis on the surface and in the bulk revealed the presence of 0.49 atom % Mg and 0.38 atom % Mg, respectively. Concentration of the dopant (Mg) was higher on the surface than in the bulk of the nano-sheets, but without excessive surface accumulation (FIG. 15), indicating lattice incorporation of the dopant with a concentration gradient.

### Example 10

### Hydrothermal Synthesis of Fe-Doped AA Nano-Sheets

Hydrothermal synthesis of about 200 g of iron-doped AA nano-sheets was performed as follows: One 1 L titanium container was cleaned and 387 g of DI water was added to it. Then, 1.06 g of 96.6% H₂SO₄ was, added to the container and its content was stirred. Then, 6.93 g of FeCl₃.6H₂O as a source of the Fe dopant was added and stirred until dissolved. Subsequently, 231 g of boehmite powder Precursor Type A was added to the containers and stirred to obtain uniform slurry. 23.1 g (i.e. 10 wt %) of commercial corundum seeds, with particle size of 1 μm, were added to the container and the slurry was vigorously stirred again for about 3 minutes. Then, 28.9 g of nano-sized colloidal silica aqueous dispersion (40% SiO₂, AS-40, Ludox) as morphology modifier was added to the container and its content was stirred again for 3 minutes. The 1 L container was then placed in a special 12″ diameter Titanium container, which was covered with lid, and subsequently placed in a steel holder (5 containers per holder), and put into cleaned autoclave (13″Dia×120″H) together with 9 other containers with loads targeting different types of AA nano-sheets. 1.9 L of DI water were placed in the bottom of the autoclave. Total water content in the autoclave, including water from precursor decomposition was 22 L. The autoclave was then sealed using modified Bridgman-type plug and covered with insulation. Calibrated pressure gauge and two J-type thermocouples were attached. Several hours after loading the containers, the heating cycle of the autoclave was initiated as follows: from room temperature to 450° C. with a heating rate of 9.0° C./hr, followed by holding at 450° C. for 10 days, with temperature stability of a few ° C., with pressure about 2,000 psi. During heating, the pressure was relieved via the attached high-temperature valve, water-cooled heat exchanger and pressure relief valve set at 2,000 psi cracking pressure. The autoclave was vented after completing the heating cycle, at the temperature of about 400° C. After unloading, the powders were inspected by XRD (FIG. 12A) and SEM and it was found that they consisted of randomly agglomerated 100% phase-pure AA nano-sheets, with BET surface area of 22.6 m²/g. After calcination in air at 1,200° C. for 24 hours, the BET surface area was 21.2 m²/g, confirming very high thermal stability of the Fe-doped AA nano-sheets. XPS analysis on the surface and in the bulk revealed the presence of 0.10 atom % Fe. Concentration of the dopant (Fe) was the same both on the surface and in the bulk of the nano-sheets, strongly indicating lattice incorporation of the dopant.

### Examples 11-34

Following the same general synthesis and characterization routes of Examples 6-10, other dopants were introduced into the AA nano-sheets. All of these examples 11-34 are summarized in Table III.

### Comment for Examples 6-34

For a complete list of examples of doped AA nano-sheets, see Table III. The instances of the doped AA nano-sheets presented in Examples 6-34 serve only to demonstrate the idea and methodology of using dopants and morphology modifiers during the hydrothermal synthesis of the AA nano-sheets. Other dopants and/or other morphology modifiers, selected from various elements, ions, organic or inorganic compounds, which can adsorb on the AA crystal facets, or their mixtures, within a wide range of concentrations could be applied using the same methodology as described in Examples 6-34. Materials prepared with such morphology modifiers could exhibit a variety of morphologies, aspect ratios, diameters, aggregation levels, etc.

### Example 35

### Fabrication of Type A Porous AA Ceramics from Hydrothermally Synthesized AA Nano-Sheets (Type II)

Hydrothermally synthesized AA nano-sheets (Type II) with thickness, width, and aspect ratio of 10-35 nm, 0.5-2.0 μm, and 15-200, respectively, are used as starting material in the preparation of thermally stable, high surface area porous AA ceramics. In order to prepare extruding pastes, the AA nano-sheets are mixed with DI water, nano-sized boehmite powder, and petroleum jelly using low stirring speed stainless steel blender. First, 5.2 g of 70% HNO₃ are added to the DI water prior to adding the boehmite powder, in order to obtain a good dispersion of the boehmite particles. Then, 90 g of nano-sized boehmite powder (Disperal, Nyacol Nanotechnologies, Ashland, Mass.) are added to 248 g of DI water and stirred vigorously for 40 min. Subsequently, 420 g of the AA nano-sheets (Type II) are added to the boehmite dispersion. The AA nano-sheets are added in 2 steps: first 345 g are added under vigorous blending, then 229 g of pure petroleum jelly is added, and finally the remainder of the AA nano-sheets is added under vigorous blending. The extruding paste is then transferred into 2″ diameter, 5: hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at 1,200° C. for 24 hours. The heating rate is 2.0° C./min; the furnace is cooled down to the room temperature in an uncontrolled manner. Porosities and pore volumes of the obtained porous AA ceramics are 80.4% and 0.97-1.03 cm³/g, respectively (Table IV). The pore size distributions are bi-modal, with the maxima at 100 nm and 10 μm (FIG. 17C). BET surface area is 14.6 m²/g (Table IV). The average and minimum crush strengths are 2.2 pounds and 1.6 pounds, respectively, as shown in Table IV. XRD analysis showed only the presence of the corundum phase in the sintered samples (FIG. 16). SEM analysis of the microstructure revealed the presence of the AA nano-sheets in the sintered porous AA ceramics.

### Example 36

### Fabrication of Type B Porous AA Ceramics from Hydrothermally Synthesized AA Nano-Sheets (Type II)

Hydrothermally synthesized AA nano-sheets (Type II) with thickness, width, and aspect ratio of 10-35 nm, 0.5-2.0 μm, and 15-200, respectively, are used as starting material in the preparation of thermally stable, high surface area porous AA ceramics. In order to prepare extruding pastes, the AA nano-sheets are mixed with DI water, nano-sized boehmite powder, and petroleum jelly using low stirring speed stainless steel blender. First, 5.2 g of 70% HNO₃ are added to the DI water prior to adding the boehmite powder, in order to obtain a good dispersion of the boehmite particles. Then, 90 g of nano-sized boehmite powder (Disperal, Nyacol Nanotechnologies, Ashland, Mass.) are added to 248 g of DI water and stirred vigorously for 40 min. Subsequently, 420 g of the AA nano-sheets (Type II) are added to the boehmite dispersion. The AA nano-sheets are added in 2 steps: first 345 g are added under vigorous blending, then 229 g of pure petroleum jelly is added, and finally the remainder of the AA nano-sheets is added under vigorous blending. The extruding paste is then transferred into 2″ diameter, 5 hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at 1,400° C. for 12 hours. The heating rate is 2.0° C./min; the furnace is cooled down to the room temperature in an uncontrolled manner. Porosities and pore volumes of the obtained porous AA ceramics are 75% and 0.71-0.75 cm³/g, respectively (Table IV). The pore size distributions are bi-modal, with the maxima at 600 nm and 10 μm (FIG. 17E). BET surface area is 5.1 m²/g (Table IV). The average and minimum crush strengths are 6.9 pounds and 5.5 pounds, respectively, as shown in Table IV. XRD analysis showed only the presence of the corundum phase in the sintered samples (FIG. 16). XPS analysis confirmed very high chemical purity of the porous AA ceramics with essentially no evident impurities, except for silicon. SEM analysis of the microstructure revealed the presence of the AA nano-sheets in the sintered porous AA ceramics.

### Example 37

### Fabrication of Porous AA Ceramics from Hydrothermally Synthesized Equiaxed AA Particles (Comparative Example)

Hydrothermally synthesized equiaxed AA particles with median diameter of about 3 μm, are used as starting material in the preparation of high-strength, high-porosity AA ceramics. The particles are applied in a form of unmilled, i.e. as-synthesized agglomerated powder. In order to prepare extruding pastes, the equiaxed AA particles are mixed with DI water, nano-sized boehmite powder, and petroleum jelly using low stirring speed stainless steel blender. First, 5.2 g of 70% HNO₃ are added to the DI water prior to adding the boehmite powder, in order to obtain a good dispersion of the boehmite particles. Then, 90 g of nano-sized boehmite powder (Disperal, Nyacol Nanotechnologies, Ashland, Mass.) are added to 248 g of DI water and stirred vigorously for 40 min. Subsequently, 965 g of the equiaxed AA particles are added to the boehmite dispersion. The equiaxed AA particles are added in 2 steps: first 570 g are added under vigorous blending, then 229 g of pure petroleum jelly is added, and finally the remainder of the equiaxed AA particles is added under vigorous blending. The extruding paste is then transferred into 2″ diameter, 5 hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at temperatures between 1,400-1,450° C. for 8-24 hours. The heating rate is 2.0° C./min in all cases; the furnace is cooled down to the room temperature in an uncontrolled manner. Porosities and pore volumes of the obtained porous AA ceramics are in the range of 66-67% and 0.48-0.50 cm³/g, respectively (Table IV). The pore size distributions are bi-modal, with the maxima at 3 μm, and 14 μm (FIG. 18). BET surface areas are around 0.7 m²/g, with the micropore surface area of about 0.22 m²/g (Table IV). The average and minimum crush strengths are 9.5-12.4 pounds and 8.9-11.7 pounds, respectively, as shown in Table IV. XRD analysis showed only the presence of the corundum phase in all sintered samples. Chemical analysis and XPS analysis confirmed very high chemical purity of the porous AA ceramics with essentially no evident impurities. SEM analysis of the microstructure revealed the presence of equiaxed AA grains in the sintered porous AA ceramics (FIG. 22).

### Comment to the Examples 35-37

The presented above instances of AA nano-sheets serve only to demonstrate the possibility and methodology of using other types of AA nano-sheets to make porous AA ceramics. For example, AA nano-sheets, which contain boehmite (i.e. Type IV nano-sheets), can be used as starting materials to obtain porous AA ceramics with unique properties using methodology described above. Moreover, variety of dopants, such as Mg, Si, Ca, B, Y, Cs, Ti, Zr, Ba, Eu, Zn, Ga, La, etc. could be applied to the AA nano-sheets using the same methodology. Porous AA ceramics with such dopants could be useful for a variety of applications.

Several aspects in accordance with the present invention are presented below. such several aspects are not all-inclusive of the present invention and many other aspects of the present invention are to be appreciated from the presented descriptions and drawings.

In accordance with one aspect, the present invention provides a hydrothermal process for making Alpha Alumina (α-Al₂O₃) crystalline nano-sized powders in the form of at least one of nano-sheets and nano-fibers, the process includes making the Alpha Alumina with an aspect ratio of diameter to thickness ratio of at least two, and with at least one dimension of diameter or thickness being less than 100 nm.

The process may include making the Alpha Alumina with surface adhesions of boehmite particles. The process may include making the Alpha Alumina without surface adhesions of boehmite particles. The process may include making the Alpha Alumina as a mixture that includes at least some Alpha Alumina equiaxed crystals. The process may include making the Alpha Alumina to have at least one of different sizes or different particle size distributions. The process may include making the Alpha Alumina to have a BET surface area of at least 10 m²/g. The process may include making the Alpha Alumina to have a BET surface area of at least 40 m²/g. The process may include making the Alpha Alumina as nano-sheets having a diameter within the range of magnitude of approximately 0.1 micron to approximately 10 microns and a thickness of less than about 100 nm. The process may include making the Alpha Alumina with a thickness of less than about 10 nm. The process may include making the Alpha Alumina as nano-fibers having lengths within the range of about 10 nm to about 10 microns and thickness of less than about 100 nm. The process may include making the Alpha Alumina with a thickness of less than about 10 nm.

The process may include the at least one of nano-sheets and nano-fibers being treated with at least one of an acidic solution and a basic solution to perform at least one of the functions of removing surface impurities and modifying surface roughness. The process may be part of a process to a make porous ceramic that includes at least a portion of interconnection between the at least one of nano-sheets and nano-fibers. The porous ceramic may have a pore volume of at least 0.2 cm³/g. Silica (SiO₂) may used in the process as a morphology modifier to yield flat nano-sheets, with a concentration of at least 10 ppm of Si atoms with respect to Al atoms. The process may include at least one component being used adsorb on crystal facets in order to obtain flat nano-sheets. The process may include a temperature cycle that includes elevating to at least about 380° C. for at least about several hours is utilized. The process may include boric acid being used as a morphology modifier to yield elongated nano-crystals, and with concentration of at least 10 ppm of boron atoms with respect to Al atoms. The process may include making the Alpha Alumina as doped Alpha Alumina. The process may include use of at least one doping component that includes at least one of Y, Zr, Zn, La, Cu, Co, Ni, Cr, Fe, Sn, Ti, Bi, Nb, Ta, V, Ce, Mn, Mo, Sb, Mg, Li, Cs, Na, K, Ba, Sr, Ca, and Ag. The process may include use of at least one doping component that includes at least one Noble metal. The process may include using any element as the dopant. The process may include use of at least one doping component that is in the form of a salt. The process may include use of a dopant in a concentration approximately at least 1 ppm.

In accordance with another aspect of the present invention, the process may include any combination of the above, mentioned aspects.

In accordance with another aspect, the present invention provides a composition of Alpha Alumina (α-Al₂O₃) crystalline nano-sized powders in the form of at least one of nano-sheets and nano-fibers, wherein an aspect ratio of diameter to thickness ratio of at least two, and with at least one dimension of diameter or thickness being less than 100 nm.

The Alpha Alumina may have surface adhesions of boehmite particles. The Alpha Alumina may not have surface adhesions of boehmite particles. The Alpha Alumina may have a BET surface area of at least 10 m²/g. The Alpha Alumina may have a BET surface area of at least 40 m²/g. The Alpha Alumina may be in the form of nano-sheets having a diameter within the range of magnitude of approximately 0.1 micron to approximately 10 microns and a thickness of less than about 100 nm. The Alpha Alumina may be the form of nano-sheets that have a thickness of less than about 10 nm. The Alpha Alumina may be in the form of nano-fibers having lengths within the range of about 10 nm to about 10 microns and thickness of less than about 100 nm. The Alpha Alumina may be the form of nano-fibers that have a thickness of less than about 10 nm. The Alpha Alumina may have been formed utilizing a morphology modifier. The morphology modifier may be silica (SiO₂), with a concentration of at least 10 ppm of Si atoms with respect to Al atoms. The morphology modifier may be boric acid, with a concentration of at least 10 ppm of boron atoms with respect to Al atoms. The Alpha Alumina may be doped Alpha Alumina. The dopant may include at least one of Y, Zr, Zn, La, Cu, Co, Ni, Cr, Fe, Sn, Ti, Bi, Nb, Ta, V, Ce, Mn, Mo, Sb, Mg, Li, Cs, Na, K, Ba, Sr, Ca, and Ag. The dopant may include at least one Noble metal. It is possible that the dopant may include using any element. The dopant may have a concentration of approximately at least 1 ppm. The composition may be at least part of a porous ceramic that includes at least a portion of interconnection between the at least one of nano-sheets and nano-fibers. The porous ceramic may have a pore volume of at least 0.2 cm³/g.

In accordance with another aspect of the present invention, the composition may include any combination of the above, mentioned aspects.

In accordance with another aspect, the present invention provides a porous ceramic that includes a composition of Alpha Alumina (α-Al₂O₃) crystalline nano-sized powders in the form of at least one of nano-sheets and nano-fibers, wherein an aspect ratio of diameter to thickness ratio of at least two, and with at least one dimension of diameter or thickness being less than 100 nm.

The Alpha Alumina may have surface adhesions of boehmite particles. The Alpha Alumina may not have surface adhesions of boehmite particles. The Alpha Alumina may have a BET surface area of at least 10 m²/g. The Alpha Alumina may be in the form of nano-sheets having a diameter within the range of magnitude of approximately 0.1 micron to approximately 10 microns and a thickness of less than about 100 nm. The Alpha Alumina may be in the form of nano-fibers having lengths within the range of about 10 nm to about 10 microns and thickness of less than about 100 nm. The Alpha Alumina may be formed utilizing a morphology modifier. The morphology modifier may be silica (SiO₂) with a concentration of at least 10 ppm of Si atoms with respect to Al atoms. The morphology modifier may be boric acid with a concentration of at least 10 ppm of boron atoms with respect to Al atoms. The Alpha Alumina may be doped Alpha Alumina. The dopant may include at least one of Y, Zr, Zn, La, Cu, Co, Ni, Cr, Fe, Sn, Ti, Bi, Nb, Ta, V, Ce, Mn, Mo, Sb, Mg, Li, Cs, Na, K, Ba, Sr, Ca, and Ag. The dopant may include at least one Noble metal. It is possible that the dopant may include using any element. The ceramic may have a pore volume of at least 0.2 cm³/g.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims

What is claimed:

1. A hydrothermal process for making Alpha Alumina (α-Al₂O₃) crystalline nano-sized powders in the form of at least one of nano-sheets and nano-fibers, the process includes making the Alpha Alumina with an aspect ratio of diameter to thickness ratio of at least two, and with at least one dimension of diameter or thickness being less than 100 nm.

2. A process as set forth in claim 1, wherein the process includes making the Alpha Alumina with surface adhesions of boehmite particles.

3. A process as set forth in claim 1, wherein the process includes making the Alpha Alumina without surface adhesions of boehmite particles.

4. A process as set forth in claim 1, wherein the process includes making the Alpha Alumina as a mixture that includes at least some Alpha Alumina equiaxed crystals.

5. A process as set forth in claim 1, wherein the process includes making the Alpha Alumina to have at least one of different sizes or different particle size distributions.

6. A process as set forth in claim 1, wherein the process includes making the Alpha Alumina to have a BET surface area of at least 10 m²/g.

7. A process as set forth in claim 6, wherein the process includes making the Alpha Alumina to have a BET surface area of at least 40 m²/g.

8. A process as set forth in claim 1, wherein the process includes making the Alpha Alumina as nano-sheets having a diameter within the range of magnitude of approximately 0.1 micron to approximately 10 microns and a thickness of less than about 100 nm.

9. A process as set forth in claim 8, wherein the process includes making the Alpha Alumina with a thickness of less than about 10 nm.

10. A process as set forth in claim 1, wherein the process includes making the Alpha Alumina as nano-fibers having lengths within the range of about 10 nm to about 10 microns and thickness of less than about 100 nm.

11. A process as set forth in claim 10, wherein the process includes making the Alpha Alumina with a thickness of less than about 10 nm.

12. A process as set forth in claim 1, wherein the at least one of nano-sheets and nano-fibers being treated with at least one of an acidic solution and a basic solution to perform at least one of the functions of removing surface impurities and modifying surface roughness.

13. A process as set forth in claim 1, wherein the process is part of a process to a make porous ceramic that includes at least a portion of interconnection between the at least one of nano-sheets and nano-fibers.

14. A process as set forth in claim 13, wherein porous ceramic has a pore volume of at least 0.2 cm³/g.

15. A process as set forth in claim 1, wherein silica (SiO₂) is used in the process as a morphology modifier to yield flat nano-sheets, and with a concentration of at least 10 ppm of Si atoms with respect to Al atoms.

16. A process as set forth in claim 1, wherein at least one component is used adsorb on crystal facets in order to obtain flat nano-sheets.

17. A process as set forth in claim 1, wherein a temperature cycle that includes elevating to at least about 380° C. for at least about several hours is utilized.

18. A process as set forth in claim 1, wherein boric acid is used in the process as a morphology modifier to yield elongated nano-crystals, and with concentration of at least 10 ppm of boron atoms with respect to Al atoms.

19. A process as set forth in claim 1, wherein the process includes making the Alpha Alumina as doped Alpha Alumina.

20. A process as set forth in claim 19, wherein the process includes use of at least one doping component that includes at least one of Y, Zr, Zn, La, Cu, Co, Ni, Cr, Fe, Sn, Ti, Bi, Nb, Ta, V, Ce, Mn, Mo, Sb, Mg, Li, Cs, Na, K, Ba, Sr, Ca, and Ag.

21. A process as set forth in claim 19, wherein the process includes use of at least one doping component that includes at least one Noble metal.

22. A process as set forth in claim 19, wherein the process includes use of at least one doping component that is in the form of a salt.

23. A process as set forth in claim 19, wherein the process includes use of a dopant in a concentration approximately at least 1 ppm.

24. A composition of Alpha Alumina (α-Al₂O₃) crystalline nano-sized powders in the form of at least one of nano-sheets and nano-fibers, wherein an aspect ratio of diameter to thickness ratio of at least two, and with at least one dimension of diameter or thickness being less than 100 nm.

25. A composition as set forth in claim 24, wherein the Alpha Alumina has surface adhesions of boehmite particles.

26. A composition as set forth in claim 24, wherein the Alpha Alumina does not have surface adhesions of boehmite particles.

27. A composition as set forth in claim 24, wherein the Alpha Alumina has a BET surface area of at least 10 m²/g.

28. A composition as set forth in claim 27, wherein the Alpha Alumina has a BET surface area of at least 40 m²/g.

29. A composition as set forth in claim 24, wherein the Alpha Alumina is in the form of nano-sheets having a diameter within the range of magnitude of approximately 0.1 micron to approximately 10 microns and a thickness of less than about 100 nm.

30. A composition as set forth in claim 29, wherein the Alpha Alumina in the form of nano-sheets has a thickness of less than about 10 nm.

31. A composition as set forth in claim 24, wherein the Alpha Alumina is in the form of nano-fibers having lengths within the range of about 10 nm to about 10 microns and thickness of less than about 100 nm.

32. A composition as set forth in claim 24, wherein the Alpha Alumina in the form of nano-fibers has a thickness of less than about 10 nm.

33. A composition as set forth in claim 24, wherein the Alpha Alumina has been formed utilizing a morphology modifier.

34. A composition as set forth in claim 33, wherein the morphology modifier is silica (SiO₂), with a concentration of at least 10 ppm of Si atoms with respect to Al atoms.

35. A composition as set forth in claim 33, wherein the morphology modifier is boric acid, with a concentration of at least 10 ppm of boron atoms with respect to Al atoms.

36. A composition as set forth in claim 24, wherein the Alpha Alumina is doped Alpha Alumina.

37. A composition as set forth in claim 36, wherein a dopant includes at least one of Y, Zr, Zn, La, Cu, Co, Ni, Cr, Fe, Sn, Ti, Bi, Nb, Ta, V, Ce, Mn, Mo, Sb, Mg, Li, Cs, Na, K, Ba, Sr, Ca, and Ag.

38. A composition as set forth in claim 36, wherein a dopant includes at least one Noble metal.

39. A composition as set forth in claim 36, wherein a dopant has a concentration of approximately at least 1 ppm.

40. A composition as set forth in claim 24, wherein the composition is at least part of a porous ceramic that includes at least a portion of interconnection between the at least one of nano-sheets and nano-fibers.

41. A composition as set forth in claim 24, wherein the porous ceramic has a pore volume of at least 0.2 cm³/g.

42. A porous ceramic that includes a composition of Alpha Alumina (α-Al₂O₃) crystalline nano-sized powders in the form of at least one of nano-sheets and nano-fibers, wherein an aspect ratio of diameter to thickness ratio of at least two, and with at least one dimension of diameter or thickness being less than 100 nm.

43. A ceramic as set forth in claim 42, wherein the Alpha Alumina has surface adhesions of boehmite particles.

44. A ceramic as set forth in claim 42, wherein the Alpha Alumina does not have surface adhesions of boehmite particles.

45. A ceramic as set forth in claim 42, wherein the Alpha Alumina has a BET surface area of at least 10 m²/g.

46. A ceramic as set forth in claim 42, wherein the Alpha Alumina is in the form of nano-sheets having a diameter within the range of magnitude of approximately 0.1 micron to approximately 10 microns and a thickness of less than about 100 nm.

47. A ceramic as set forth in claim 42, wherein the Alpha Alumina is in the form of nano-fibers having lengths within the range of about 10 nm to about 10 microns and thickness of less than about 100 nm.

48. A ceramic as set forth in claim 42, wherein the Alpha Alumina has been formed utilizing a morphology modifier.

49. A ceramic as set forth in claim 42, wherein the morphology modifier is silica (SiO₂), with a concentration of at least 10 ppm of Si atoms with respect to Al atoms.

50. A ceramic as set forth in claim 42, wherein the morphology modifier is boric acid, with a concentration of at least 10 ppm of boron atoms with respect to Al atoms.

51. A ceramic as set forth in claim 42, wherein the Alpha Alumina is doped Alpha Alumina.

52. A ceramic as set forth in claim 51, wherein a dopant includes at least one of Y, Zr, Zn, La, Cu, Co, Ni, Cr, Fe, Sn, Ti, Bi, Nb, Ta, V, Ce, Mn, Mo, Sb, Mg, Li, Cs, Na, K, Ba, Sr, Ca, and Ag.

53. A ceramic as set forth in claim 51, wherein a dopant includes at least one Noble metal.

54. A ceramic as set forth in claim 42, wherein the ceramic has a pore volume of at least 0.2 cm³/g.
